(19) United States
(12) Patent Application Publication
(10) Pub. No.: US 2026/0236147 A1
(43) Pub. Date: Aug. 13, 2026

(54) PRESENTATION PLATFORM

(71) Applicant: PGA TOUR Enterprises, LLC, Ponte Vedra Beach, FL (US)

(72) Inventor: Jonathan Rabhan, Ponte Vedra Beach, FL (US)

(73) Assignee: PGA TOUR Enterprises, LLC, Ponte Vedra Beach, FL (US)

(21) Appl. No.: 19/534,534

(22) Filed: Feb. 9, 2026

Related U.S. Application Data
(60) Provisional application No. 63/755,748, filed on Feb. 7, 2025.

(51) Int. Cl. G06F 3/0484; G06F 3/0481; G06F 3/0482; G06F 3/04845; G06F 16/438; G06Q 10/10

(52) U.S. Cl. CPC G06F 3/0484; G06F 3/0481; G06F 3/0482; G06F 3/04845; G06F 16/4393; G06Q 10/10

(57) ABSTRACT

A presentation system includes a presentation platform configured to deliver presentation instructions to scoreboard controllers for display on electronic displays. A presentation controller may execute scripts to control presentations. A data storage device may maintain a data model storing presentation data obtained from data sources. Slides may include slide frameworks configured for injection of content via script execution. The scripts may include slide scripts that control slide content and trigger scripts that monitor data sources and cause slide injection upon satisfaction of trigger conditions. Presentation control data may define slide groups such as ordered groups, unordered groups, and trigger groups, along with interrupt settings governing group interactions. A presentation algorithm may be employed to analyze the presentation control data to determine slide order satisfying frequency, duration, and interruption requirements.

### CROSS-REFERENCE TO RELATED APPLICATIONS

This application claims the benefit of and priority to U.S. Provisional Patent Application 63/755,748, filed Feb. 7, 2025, titled Presentation Platform, the contents of which are hereby incorporated herein by reference.

### TECHNOLOGY

The present disclosure relates generally to presentation management including automated and semi-automated content creation from dynamic event data.

### BACKGROUND

Sports and other live events often utilize scoreboard displays to present attendees information regarding events to improve the live event viewing experiences. Presentations drive audience engagement by providing context to the event, enabling spectators to be fully engrossed in the live action. Presentation content may include live video of the event to provide spectators a different perspective of the live action. In the context of events such as golf tournaments where spectators may be unable to view all the live action occurring at the event, scoreboard displays may be used to present spectators live action and replays of play occurring at other locations of the event venue. Presentation content may also include information about participants, live scoring, and preproduced video and animations. Presentations may also provide an essential platform for presenting revenue generating advertisements and sponsorship exposures.

Live events are often presented in series, at different locations, with different participants, and with different sponsors and advertisers. All of these factors may change the context of a presentation. Thus, in addition to actual live action at the different events changing presentation content between events, presentation producers are required to generate additional content specific to each live event based on specific event factors. This may limit their ability to reuse presentation content or easily modify previously generated presentation content for use at multiple events.

Presentations typically require a producer to actively direct presentation content based on action occurring at the event. This task is often made difficult when the producers must also account for meeting exposure requirements of advertisers and sponsors.

What is needed are more efficient systems and methods for producing and presenting live event presentations.

### BRIEF DESCRIPTION OF THE DRAWINGS

The novel features of the described embodiments are set forth with particularity in the appended claims. The described embodiments, however, both as to organization and manner of operation, may be best understood by reference to the following description, taken in conjunction with the accompanying drawings in which:

FIG. 1 schematically illustrates a presentation platform according to various embodiments described herein;

FIG. 2 is a schematic of various operations of a presentation according to various embodiments described herein;

FIG. 3 schematically illustrates features of a presentation platform according to various embodiments described herein;

FIG. 4A is an example event management interface configured to enable a user to select events to view and manage scoreboards according to various embodiments described herein;

FIG. 4B is an example event management interface of an event module configured to enable a user to perform scoreboard management operations with respect to scoreboards according to various embodiments described herein;

FIG. 4C is an example messaging manager interface of a messaging module configured to enable a user to perform message management operations with respect to scoreboards according to various embodiments described herein;

FIG. 4D is an example weather manager interface of a weather module configured to enable a user to perform weather management operations with respect to scoreboards according to various embodiments described herein;

FIG. 4E is an example slide menu interface of a slide generator including a slide editor according to various embodiments described herein;

FIG. 4F is an example slide editor of a slide generator according to various embodiments described herein;

FIG. 4G is an example presentation generator interface according to various embodiments described herein;

FIG. 4H is an example ordered group packaging interface according to various embodiments described herein;

FIG. 4I is an example unordered group packaging interface according to various embodiments described herein;

FIG. 4J is an example trigger group packaging interface according to various embodiments described herein;

FIG. 4K is an example administration management interface according to various embodiments described herein;

FIG. 4L is an example administration management interface configured to enable users to set API endpoints for use in scripting to trigger trigger groups according to various embodiments described herein;

FIG. 4M is an example administration management interface configured to enable users to set subscription to WebSockets for use in scripting to trigger trigger groups according to various embodiments described herein;

FIG. 4N is an example administration management interface for defining a data handler script for data transformation according to various embodiments described herein;

FIG. 4O is an example visual scoreboard history feature of the administration management interface that provides a visual history of a scoreboard's presentation history according to various embodiments described herein;

FIG. 5 schematically illustrates features of a presentation platform according to various embodiments described herein; and

FIG. 6 is a schematic of a machine in the form of a computer system within which a set of program instructions, when executed, may cause the machine to enable event broadcast production and distribution according to various embodiments described herein.

### DESCRIPTION

The present disclosure describes a presentation system comprising a presentation platform and methods of using the presentation system and components thereof.

The presentation platform may be configured to deliver event content to electronic displays, such as electronic displays at or around event venues. For brevity, the present description generally describes delivering golf tournament content to electronic displays comprising scoreboards, but it is to be understood that the various features and components of the presentation platform may be suitably applied to deliver other event content such as those relating to sporting events, concerts, fairs, spectator events, graduations, among others, and the content may be delivered to other electronic displays. The electronic displays will typically be large displays, such as 20 ft×6 ft or larger. However, those having skill in the art will appreciate upon reading the present disclosure that the presentation platform may be applied to any size display and be applied to any type of event or presentation.

The presentation platform may provide simplified standardization, repurposing, and sharing of resources. The presentation platform may be considered to support semi or fully automated presentations. For example, the presentation platform may be configured with unique functionalities geared toward scoreboards that can run unattended and without requiring manual production of the main content. The presentation platform may provide flexibility in real-time environments by utilizing ingested event data, which may include detected events occurring during the event, as triggers that the presentation platform uses to direct or modify the presentation. For example, analysis of event data may be used to control content of a presentation items, order or presentation of presentation items, and data sources utilized in the presentation. The presentation platform may be configured to dynamically integrate data into presentations from multiple data sources on an on-demand or as needed basis. For example, the presentation platform may be configured to control delivery of various types of event content into presentations such as real-time scoring, weather, alerts, messaging, live video, video highlights, pre-produced video, and advertising. The presentation platform may be configured to allow users to define presentation scheduling based on presentation control data settings such as grouping definitions, temporal exposure requirements, data source intervals, interruption settings, data source settings, or other defined presentation criteria that drives automated delivery of content. The presentation platform may track operation of the scoreboards in real-time and provide monitoring services for multiple scoreboards. The presentation platform may be configured to allow users to remotely schedule on/off cycles or times. The presentation platform may employ scripting to provide an infinitely customizable platform from which presentations may be served in real-time environments.

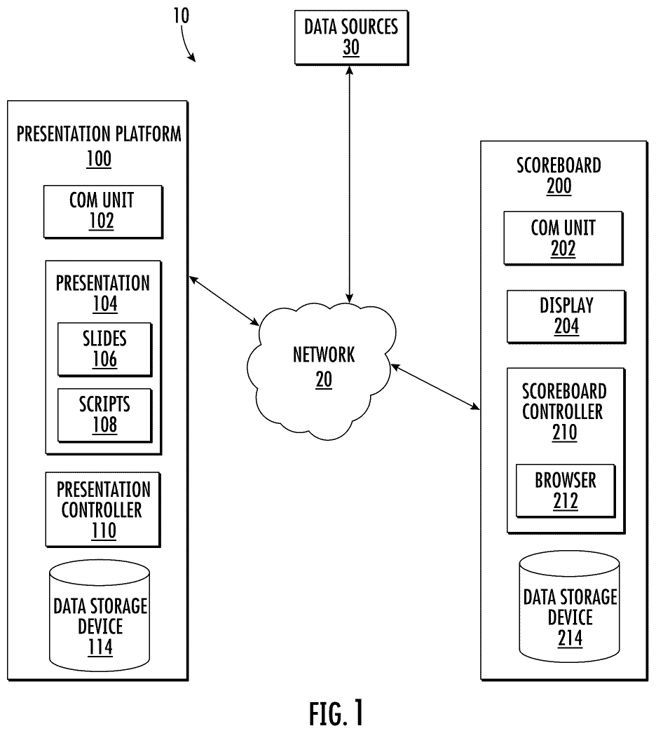

FIGS. 1-6 illustrate various embodiments of a presentation system 10 including a presentation platform 100 according to various embodiments described herein wherein like numbers identify like features.

With specific reference to FIG. 1, a presentation system 10 may include a presentation platform 100 configured to deliver presentation data comprising presentation instructions to a scoreboard 200 for presentation on a display 204.

The presentation platform 100 may include a presentation controller 110 configured to control presentation operations of the presentation platform 100. The presentation controller 110 may include a processor and memory storing program instructions that when executed by the processor perform operations of the presentation controller 110. In various embodiments, all or a portion of presentation processing operations may be distributed among components of the presentation system 10 utilizing server-side processing, cloud computing environments, client-side processing, on-board presentation platform processing, onboard scoreboard processing, among others. The memory may include a data storage device 114. The data storage device 114 may store presentation data used by the presentation platform 100 to perform presentation operations described herein. The data storage device 114 may comprise local data storage. The data storage device 114 may store presentation data used by the scoreboard controller 210 to perform presentation operations described herein. As described in more detail below, the data storage device 114 may comprise a data source 30, either of which may include a data model as described herein that the presentation controller 110 uses to control presentations via scripting operations, for example using slide scripting. The data model may be structured to receive presentation data and maintain the data for access in the presentation operations of the presentation controller 110. The data model may be fed presentation data from various data sources 30 prior to and during events. In one embodiment, the presentation system 10 or presentation platform 100 may be configured to execute scripting operations to build and update the data model with live event data. In some embodiments, the data model may be fed event information, scoreboard information, or both. In this or another embodiment, the data model may maintain historical event data or related data such as scoring data, shot data, player statistics, from tournaments, tours, seasons, all time, or otherwise that the presentation controller 110 may access for use in the presentation operations.

The presentation platform 100 may include a presentation 104 comprising presentation data including slides 106, which may include presentation instructions for rendering a display of a slide 106. Presentation instructions may include slide data including instructions for rending a slide 106, such as HTML, CSS, data files, data file locations, which may include slide assets. As understood in the art, document markup language refers to a machine-readable structured language for defining document content and structure, and presentation styling language refers to a machine-readable language for specifying visual presentation and formatting of such content.

The presentation 104 may also include presentation data comprising scripts 108 that the presentation controller 110 executes to control aspects of the presentation 104. For example, the presentation system 10 may employ scripting configured to automate aspects of presentations 104, which may include automation in a real-time event environment, application of a presentation 104 to multiple events wherein the presentation 104 uses data associated with the event to cause customization of the presentation 104 to the event, or both. Scripts 108 may be used to trigger changes in slide content or a presentation 104. For example, scripts 108 may include slide scripts to control slide content or slide skip functionalities. Slide scripts may be used to dynamically update slides 106. The presentation controller 110 may execute slide scripts paired with slides 106, generate HTML, and then transmit the HTML to the browser 212 for processing and rendering. The presentation instructions may also include associated markup, e.g., CSS styling, assets, or other data files for use in rendering the slide 106. In one embodiment, the presentation instructions transmitted to the browser 212 may specify data file locations for injection into the slide 106. The browser 212 may pull the data from presentation instructions transmitted to the browser 212 or fetch the data from the presentation controller 110 or a data source 30 identified in the presentation instructions. Additionally or alternatively, scripts 108 may include trigger scripts that run against a presentation 104 to control presentation 104 or injection of a slide 106 or group of slides 106 based on evaluation of presentation data. Trigger scripts may be used to control slide order. In some embodiments, scripting is used to build and update a data model used by the presentation controller 110 to control aspects of the presentation, which may be driven by execution of slide scripts that query the data model for content or evaluation of data for content or presentation determinations. While scripts 108 are generally described as being executed by the presentation controller 110, those having skill in the art will appreciate that one or more scripts 108 may be executed by the scoreboard controller 210.

The presentation controller 110 may utilize additional presentation data such as event information (e.g., event ID, event name, event date, event round) or scoreboard information (e.g., scoreboard ID, scoreboard location, scoreboard name) in connection with execution of scripts 108 to control aspects of the presentation 104, such as slide content or if a slide 106 is to be presented in the presentation 104.

Presentation data may include event data. Event data may include data related to an event. Examples of event data with respect to a golf tournament may include player information such as biographical information, headshots or other visual related media, past performances, statistics, season statistics, player standings, historical player data; media data captured at the event or elsewhere, which may include images, video, audio, animations, or the like such as player shots, ball traces, hole flyovers, or fan videos; sponsor information; cutlines; scoring data such as player positions, leaderboards, player scores, shot numbers, ball locations, shot distances, or the like. The event data may be used to provide or direct slide content and may include slide assets included or addressed in presentation instructions. For example, slide assets or other data injected into slides 106 may be or be derived from event data. Event data may be used in script execution for such content direction with respect to a slide 106 or presentation 104 of a slide 106 in a presentation 104. For instance, scripts 108 may direct query of event data, e.g., from a data source 30, which may include the data model, other data sources 30, or combination thereof, for evaluation to instruct one or more conditional aspects with respect to slide content, e.g., updating or modifying slide content, or determination if a slide 106 is to be included in a presentation 104. Event data may be stored by local or remote data sources 30. Data sources may include endpoints such as APIs. Endpoints may include REST APIs, WebSockets, or data structures, such as data buckets, which may include object-based storage. Endpoints may include web services. Endpoints may include spreadsheets populated with event data or other presentation data. Scripting may specify requests for or otherwise obtaining event data from one or more endpoints for purposes of injection in slides 106, modification or update of slide content, evaluation for conditional injection or skip presentation with respect to a slide 106, or other presentation control operation. In one embodiment, scripting includes fetch APIs.

Presentation data may also include presentation control data used by the presentation controller 110 to control various aspects of the presentation 104 such as slide inclusion, slide duration, slide order, slide frequency, or slide groups. Presentation control data may comprise presentation settings with respect to slides 106, presentations 104, or both. Slides 106 may be associated with presentation control data comprising a duration setting corresponding to the duration a slide 106 is to be displayed. The duration setting may specify a time or be set to a slide asset duration such as a video. In one configuration, duration may be conditioned on evaluation of event data such that a slide 106 may end upon the occurrence or the absence of an event. In one instance, duration may be variable based on evaluation of event information, scoreboard information, or combination thereof. Duration may be provided or otherwise specified in presentation instructions or the presentation controller 110 may make slide end determinations based on the presentation control data and transmit a next slide 106 or slide end instruction to the browser 212. Presentation control data may include frequency settings. For instance, a slide 106 may have a frequency setting with respect to the presentation 104 such that the slide 106 is to be displayed a specified number of times over a specified period of time. Presentation control data may be included in scripts 108 or otherwise associated with presentations 104 or slides 106 thereof. In some embodiments, presentation control data may include data source settings. As described in more detail below, data source settings may include identity and settings with respect to APIs, API endpoints, file folder search criteria, among others used in the presentation operations, e.g., to obtain presentation content or otherwise control aspects of the presentation 104. In one embodiment, data obtained from the data sources 30 is integrated into the data model for access during slide scripting operations.

In various embodiments, the presentation controller 110 may execute a presentation algorithm that analyzes presentation control data, e.g., one or more of duration, frequency, interruption, or group settings, to determine appropriate slide order, e.g., timing of slide or slide group presentation/injection, to satisfy requirements specified by the presentation control data. In some embodiments, the browser 212 is configured to transmit presentation metrics with respect to one or more of actual display duration or frequency in regard to slides 106 or slide groups that the presentation controller 110 utilizes to control the presentation 104, e.g., using the presentation algorithm. In some embodiments, the presentation controller 110 applies a presentation algorithm comprising a frequency algorithm with respect to a presentation 104 to control slide 106 order, which may include slide 106 injection, within a presentation 104 such that slide 106 frequency settings are met. The presentation control algorithm may also analyze other presentation data such as scoreboard information, event information, event data, or combination thereof to inform the slide 106 order. The presentation control algorithm may additionally or alternatively employ artificial intelligence with respect to determination of appropriate presentation order during the presentation 104.

The presentation controller 110 may be configured to control a plurality of presentations 104 on displays 204 of multiple scoreboards 200 wherein the presentations 104 may be different based, at least in part, on presentation data, such as event information, scoreboard information, or event data.

The scoreboard 200 includes a scoreboard controller 210 configured to control operations of the scoreboard 200. The scoreboard 200 or scoreboard controller 210 comprises a processor and memory storing program instructions that when executed by the processor perform operations of the scoreboard controller 210. The memory may comprise a data storage device 214. In some embodiments, the data storage device 214 comprises memory including cache or browser cache used to store presentation instructions during presentation operations. In this or other embodiments, the data storage device 214 includes memory for holding presentation instructions comprising on/off times, offline presentation instructions, offline slides, or combination thereof. Such offline content may be presented during times the scoreboard 200 is running the presentation 104 but is not running grouped content or being fed slides 106 or online presentation content. The offline content may provide a default aspect of a presentation 104 or the presentation instructions may direct the scoreboard controller 210 to display the offline content before, after, or between scheduled presentations 104. Offline content may include tournament logos, leaderboards, testing content, weather loops, messages, sponsors, or any other slide content desired. The scoreboard 200 also includes a display 204 controllable by the scoreboard controller 210. For example, the scoreboard controller 210 is configured to be in data communication with the display 204 to provide presentation data for visual output on the display 204. The scoreboard controller 210 may be operable to turn the scoreboard display 204 on and off, provide display signals with respect to what to display, connect the scoreboard 200 to the presentation platform 100, and the like. The scoreboard controller 210 or one or more elements thereof may be local or remote with respect to the scoreboard display 204. In some embodiments, a scoreboard controller 210 is configured to control operations of multiple scoreboard displays 204.

In various embodiments, the scoreboard controller 210 may maintain a local cache, e.g., in the data storage device 214, comprising a manifest of slide packages, which may include one or more of HTML, CSS, resolved asset references, integrity hashes or versions, or other related data, for offline or degraded-network operation. The presentation controller 110 may provide a manifest with versions for each slide package. Upon update, browser 212 may fetch only changed assets and validate integrity before activation. Assets may carry time-to-live values to govern refresh, and if an update fetch fails or integrity validation does not pass, browser 212 may serve the last known good package from cache and retry, e.g., according to a backoff policy. If the scoreboard 200 is online but no grouped content is available or a fetch fails mid-presentation, the presentation controller 110 may be configured to direct display of the designated offline content until a subsequent successful health check and content update.

The presentation platform 100 includes a communication unit 102 for performing data communication operations with the scoreboard 200 and one or more data sources 30 via a network 20. Data sources 30 may comprise a database, which may include a storage service. These or other data sources 30 may comprise API endpoints. The scoreboard 200 may similarly include a communication unit 202. Communication units 102, 202 may be configured to provide data communication operations. For example, network 20 may include a local network, wide area network, or any other network, or combination thereof. Communication operations may include networking tasks such as establishing data communication between the presentation controller 110 and scoreboard controller 210. Communication operations may include accessing data sources 30 to request and retrieve data, e.g., fetch data, which may include listening for available data, querying data sources 30 for data, or otherwise. Communication operations may include querying data sources, making API calls, listening operations such as listing to data feeds, such as WebSocket subscriptions or pushed data. Various communication operations may be under control of scripts 108. For example, scripts 108 may cause a processor to initialize local or remote data source queries, e.g., make API calls, or modify communication operations such as create or modify API subscriptions, which may include changing an API endpoint.

In some embodiments, the scoreboard 200 or scoreboard controller 210 comprises a rendering application, such as a browser 212, configured to receive and process presentation instructions for display rendering. For example, the scoreboard controller 210 may be configured with or configured to execute a browser application or other rendering application capable of interpreting document markup language and presentation styling language to render slides for display. While the present disclosure generally refers to the rendering application as a browser 212, it is to be appreciated that such references and accompanying descriptions are equally applicable to other rendering applications capable of interpreting document markup language and presentation styling language to render slides for display. Thus, the present disclosure is not limited to browser embodiments, and references to the browser 212 should be understood to encompass any suitable rendering application unless the context clearly indicates otherwise. In various embodiments, the scoreboard controller 210 may connect to the presentation controller 110 via the browser 212 utilizing the communication unit 202. For example, the presentation controller 110 may comprise a webserver or similar hardware or software configuration addressable by the browser 212. The presentation controller 110 may, for instance, be addressable via a URL. Those having skill in the art will appreciate that respective communication units 102, 202 may be employed for data communication. For brevity and ease of understanding, data communications among the presentation platform 100 or presentation controller 110, scoreboard 200 or scoreboard controller 210, data sources, or other hardware or software configurations may be described without specification of details regarding the communication units 102, 202.

The scoreboard 200 includes an electronic display 204. While the term display 204 is used herein in reference to scoreboard 200, the term is intended to include videowalls, and other electronic displays. Indeed, the present description is not limited to scoreboards 200 as the methodologies described here may be applied to any electronic display. The scoreboard controller 210 may be local or remote with respect to the display 204. Various display technologies may be utilized, such as liquid crystal displays (LCD), light emitting diode displays (LED), projection display technologies, or laser displays. The presentation platform 100 may be particularly suited for use with displays comprising LED scoreboards, LED videowalls, and other LED based electronic displays.

Slides 106 may form presentation units of presentation content. For instance, slides 106 may include presentation data that may be rendered for display of text, tables, images, video, or other visual media. In some embodiments, slides 106 may include presentation data comprises audio, which may be output by speakers under control of the scoreboard controller 210. As described in more detail below, slides 106 may be static or dynamic. Slides 106 may be configured for injection of slide content. For example, slides 106 may comprise frameworks for injection of presentation data such as text, images, video. Presentation content may be built via creation of slides 106, which may also include creation of scripts 108 that provide presentation control operations such as injecting slide content, updating slide content, slide asset integration, or dynamically controlling slide presentation based on events or ingested data. Slides 106, scripts 108, or both may be integrated into the presentation platform 100 prior to play or on the fly. Slides 106 may be built with any suitable programming language for handling the desired slide content and presentation of such content. For instance, slides 106 may be built to be responsive with document markup and presentation styling languages to provide presentation flexibility. In one example, slides do not need to be generated in different presentation sizes to fit different size display screens, e.g., only one slide 106 is needed for various scoreboard pixel sizes. Slides 106 may be configured in a webpage or other digital document format that a rendering application can process and render. In one example, slides 106 are built to be responsive with HTML and CSS, though other document markup languages and presentation styling languages may be used. Slides 106 may include various slide 106 components. Slides 106 may include static or dynamic components. Slide components may include tables, graphics, animations, fields, such as text fields, embedded video fields, sponsor fields, or the like. Slides 106 may include slide frameworks, which may include data fields, media windows, tables, graphics, images, or the like, any of which may include input elements into which customized, e.g., modified, updated, real-time, or event specific, data is injected.

In some embodiments, the presentation controller 110 may be configured to evaluate event information to make one or more presentation 104 determinations prior to transmitting the presentation instructions to the browser 212 such that the scoreboard controller 210 is not required to make one or more conditional determinations with respect to the presentation 104. The presentation instructions may direct slide structure, content, processing, rendering, or the like. In one example, the presentation instructions do not include any scripting. In some embodiments, slides 106 are paired with slide scripts providing conditional instructions and are handled by the presentation controller 110, e.g., server-side. The rendering application, e.g., browser 212, may receive presentation data comprising document markup language, presentation styling language, and data files generated or otherwise served to the rendering application by the presentation controller 110 after execution one or more scripts 108 wherein the scoreboard controller 210 processes the document markup and styling, injects slide content in the data files or otherwise referenced in the presentation instructions, and renders the slide 106. In one example, the document markup language comprises HTML and the presentation styling language comprises CSS. In one embodiment, the presentation controller 110 may execute slide scripts, process event data returned from slides scripts, generate HTML incorporating the processed event data, and transmit the HTML to the scoreboard controller 210 along with slide content data files coded in the HTML. In some embodiments, the presentation controller 110 and scoreboard controller 210 operate in a client-server relationship. For example, the scoreboard controller 210 may connect with the presentation controller 110 via the browser 212. The presentation controller 110 may transmit presentation instructions to the scoreboard controller 210 that the scoreboard controller 210 executes utilizing browser 212 to process and render slides 106. For example, the presentation instructions may include data files, file locations, data source addresses, identification of slide assets, or combination thereof. The presentation instructions may include markup language, style language, or both, such as HTML and CSS or similar. In one example, the presentation controller 110 comprises a server, e.g., a webserver, addressed by one or more URLs to which the browser 212 connects

Slides 106 may be paired with scripts 108 to code for injection of specific custom presentation data content. For instance, an event sponsor slide framework may be paired with a script that when run against the slide 106 codes for injection of an event sponsor graphic for the particular event based on particular event data specified and evaluated by the slide script, such as event name, event date, or event code. The presentation platform 100 may include presentation data comprising a sponsor designation for events or a slide script may specify a query of a data source 30 in which sponsor information for an event is specified. The sponsor designation or data source 30 may also include an associated sponsor graphic or the slide script may be coded to retrieve a specified sponsor graphic locally or remotely from a data source 30. Thus, pairing slides 106 with scripts 108 may be used to automatically customize slides 106 for use in multiple events or presentations 104. When a paired slide script is executed, the presentation controller 110 may automatically update content of the slide 106 to include the identified event sponsor or other event data, such as current leaderboard, past tournament results, cutlines, or the like. In this way, slides 106 may be used as presentation framework units in presentations 104 that automatically customize or otherwise update with respect to the event.

As introduced above, the presentation platform 100 may employ scripting. The scripting may be used to trigger change in slides 106 or presentation 104. Scripts 108 may be written in any suitable scripting language. For example, slide scripts may be written in Python and run against slides 106. Trigger scripts may, for example, be written in Python. In one embodiment, scripts 108 may include Java Script. In another example, slide scripts, trigger scripts, or both do not include Java Script. In some configurations, multiple slide scripts may be used against a single slide 106, e.g., slides 106 including a same core image or other component. For instance, a sponsor image may comprise an image type, which may be an image, video, or animate, that may be injected into the same slide 106. In some instances, a same slide script may be run against multiple slides 106. For instance, a slide script may condition display of a slide 106 on evaluation of event information such that a slide 106 will not be displayed in a presentation 104 if the event information is false for a conditional parameter specified in the slide script.

In various embodiments, a slide 106 or presentation 104 may include designations with respect to times, days, locations, or events the slide or particular slides in the presentation, which may include a group of slides, are to be included. This functionality may be managed by scripting to automate a presentation 104 assigned to a scoreboard. For example, scripting may be used to customize slides 106 or slide content to an event, hole location, hole locations, or other event information, scoreboard information, or event data specified by a script parameter. When a presentation 104 including the slide 106 is assigned to a scoreboard, the presentation platform 100 may evaluate values specified by the script parameter to determine if script conditions are met for an action specified by the script, which may include, for example, if certain content is to be included in the slide 106, if slide content is to be modified or updated, if the slide 106 is to be presented, or other conditional action. A script condition may include a parameter that specifies a value associated with scoreboard information, such as hole ID, hole number, or hole location. A script condition may include a parameter that specifies a value associated with event information, such as event ID, event date, event name, or event round. In one example, scripting is used to provide skip slide functionality to cause specific slides 106, slide scripts, or slide and slide script combinations to be skipped or inserted at particular times, days, events, or course locations. For example, a skip slide functionality may be used to code, e.g., using Python, when specific slide/slide script combos appear or not on particular scoreboards 200, within an assigned presentation 104, or both.

Scripts 108 may invoke a data source query for presentation data to update slides 106. Scripts 108 may invoke a data source query to trigger presentation of a slide 106 or slide groups, which may be referred to herein as a trigger group. For example, trigger script may cause presentation data to be ingested from a data source 30 wherein the ingested data is used to trigger modification of a presentation 104 comprising injection of a slide 106 or trigger group into the presentation 104. As a further example, slide script may include a script condition that triggers modification of slide content or a skip functionality. For instance, slide scripts may invoke data source queries, such as data model queries, and evaluation of the returned data may trigger a change to slide content, e.g., update dynamic component in the slide 106, such as scores, event leaders, locations of players or other content. Script may query a data source 30 for video wherein if the video is available, the video may be integrated into a video frame of a slide 106 or trigger a change to another slide 106 in which the video is integrated. As described in more detail below, scripts 108 may invoke import or export of slides 106 into a presentation, import or export of scripts 108 into presentations 104, or both.

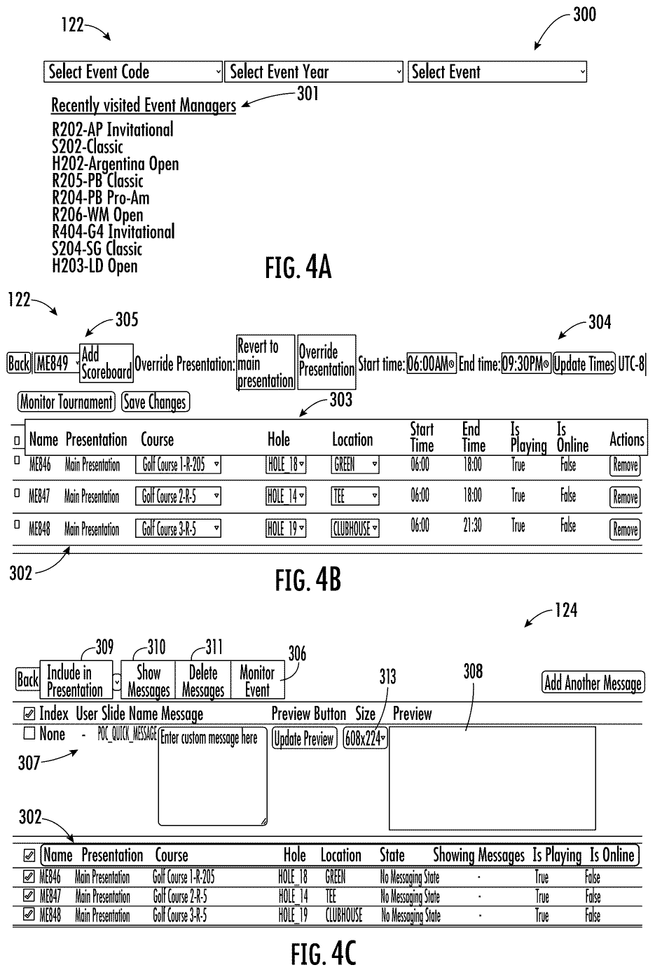

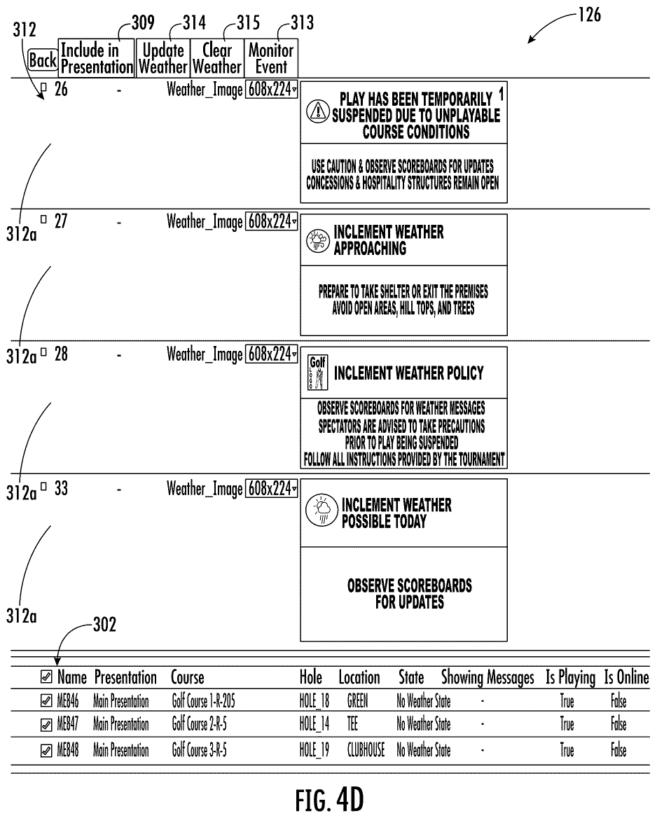

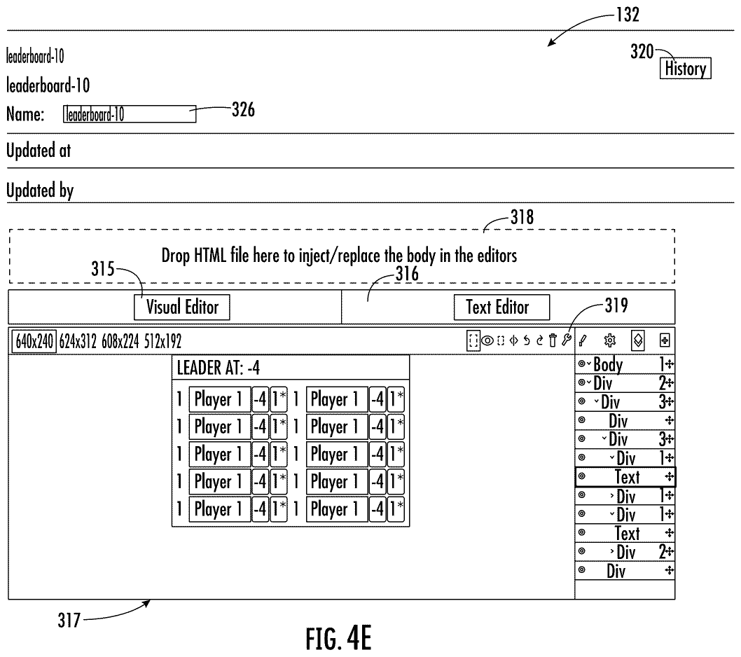

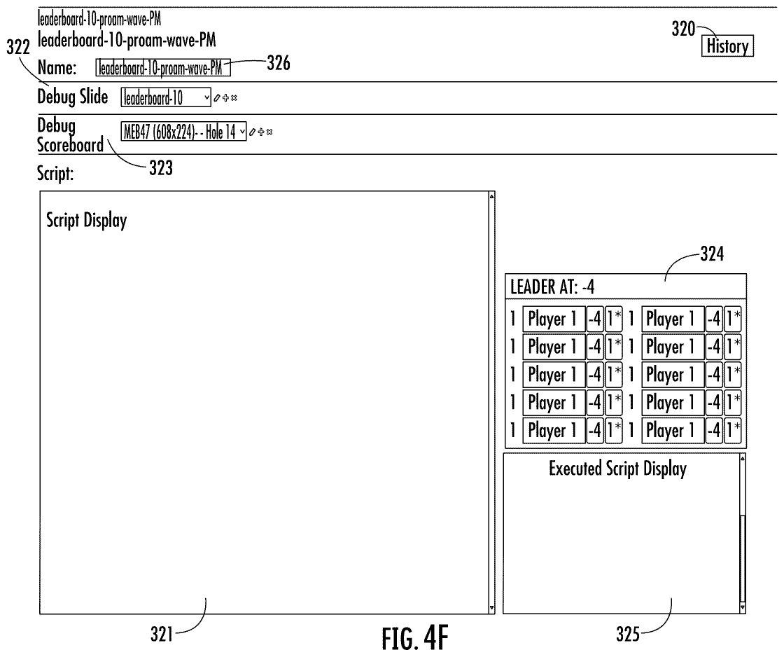

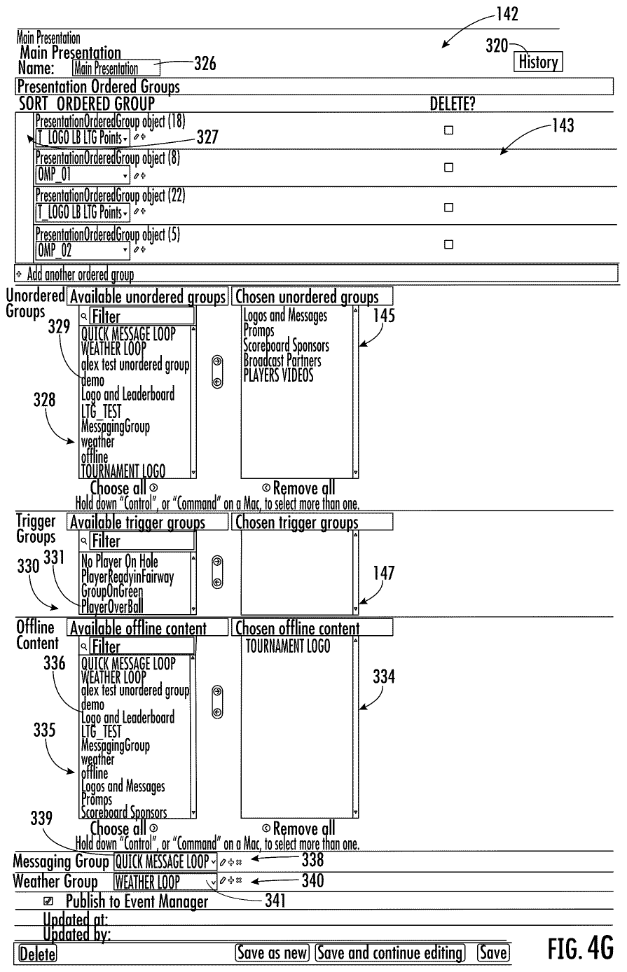

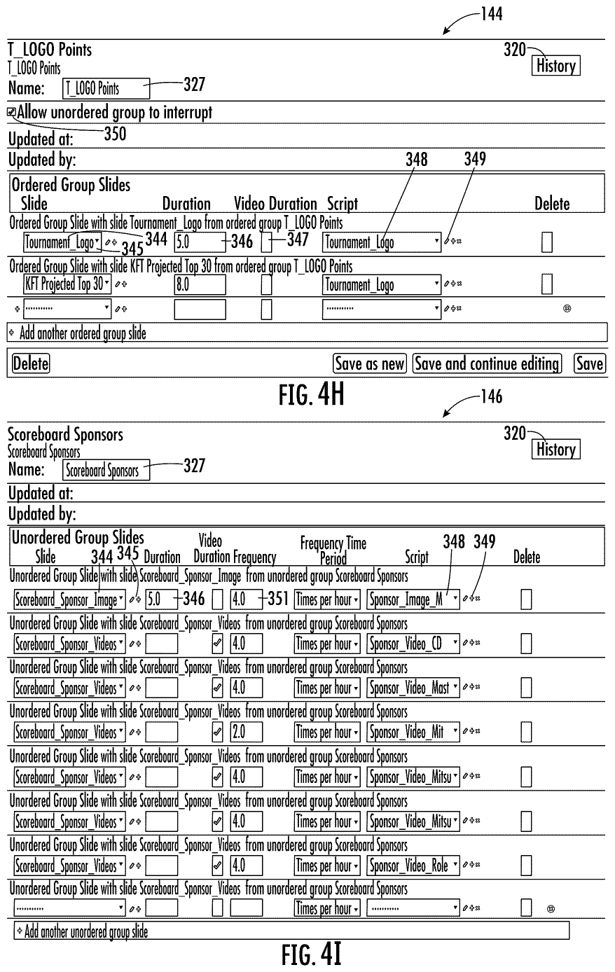

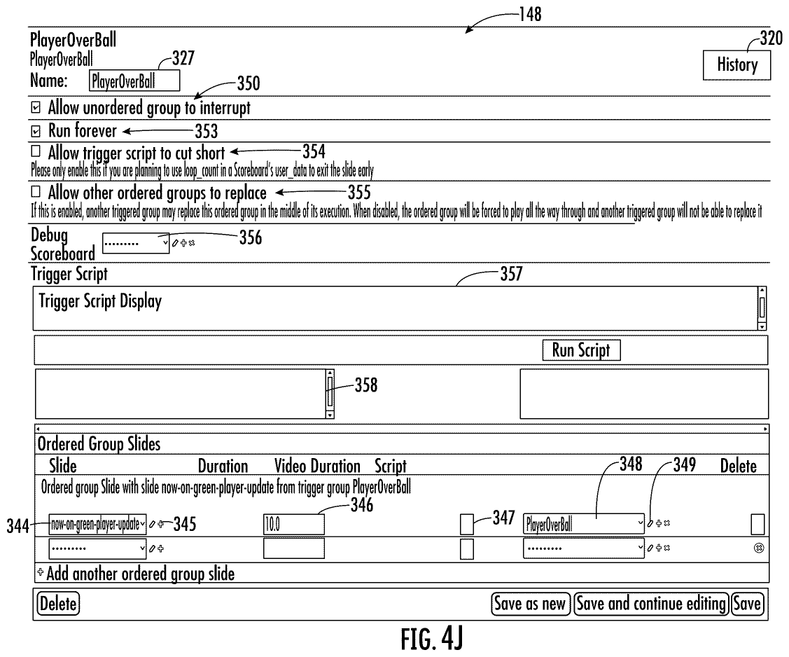

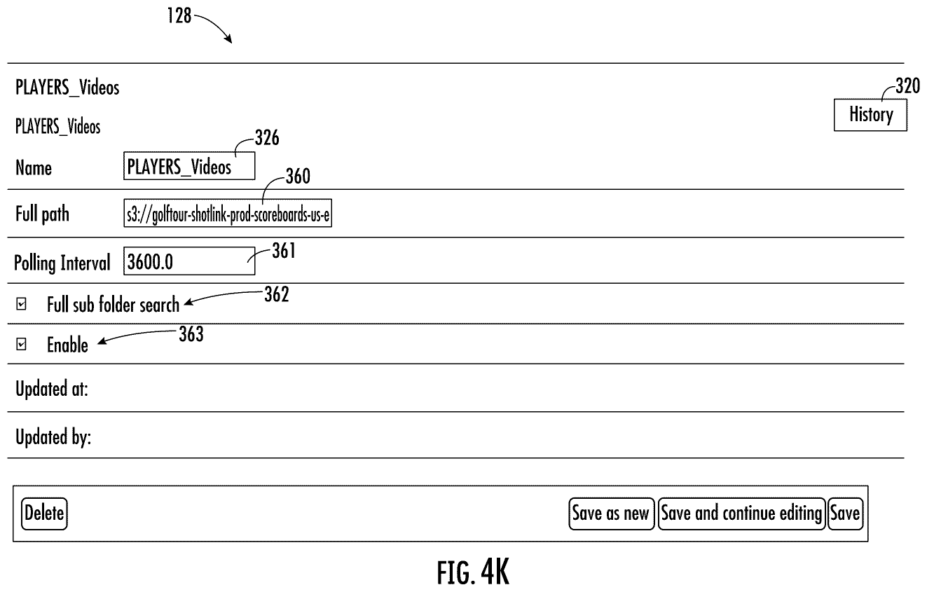

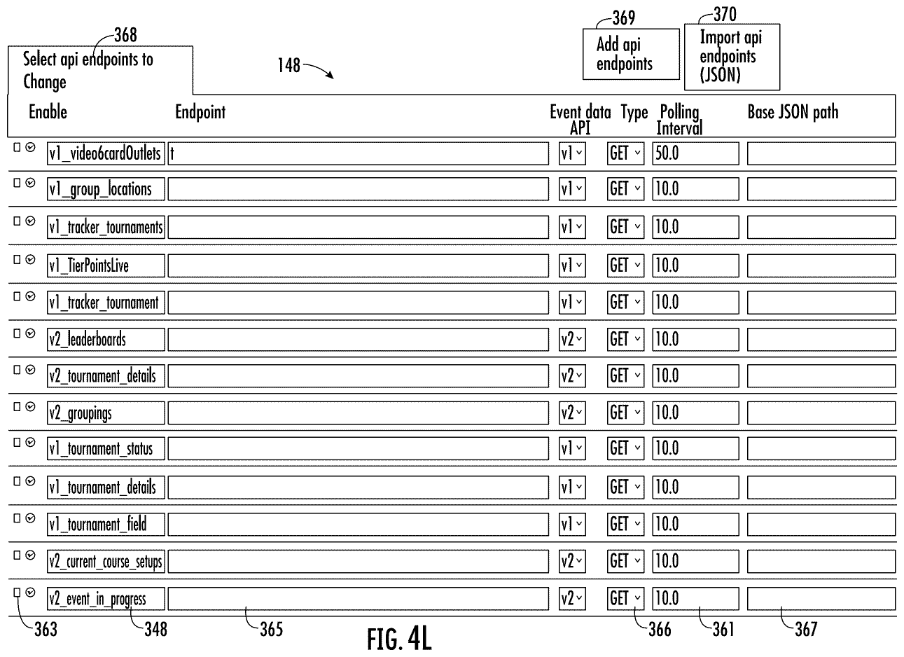

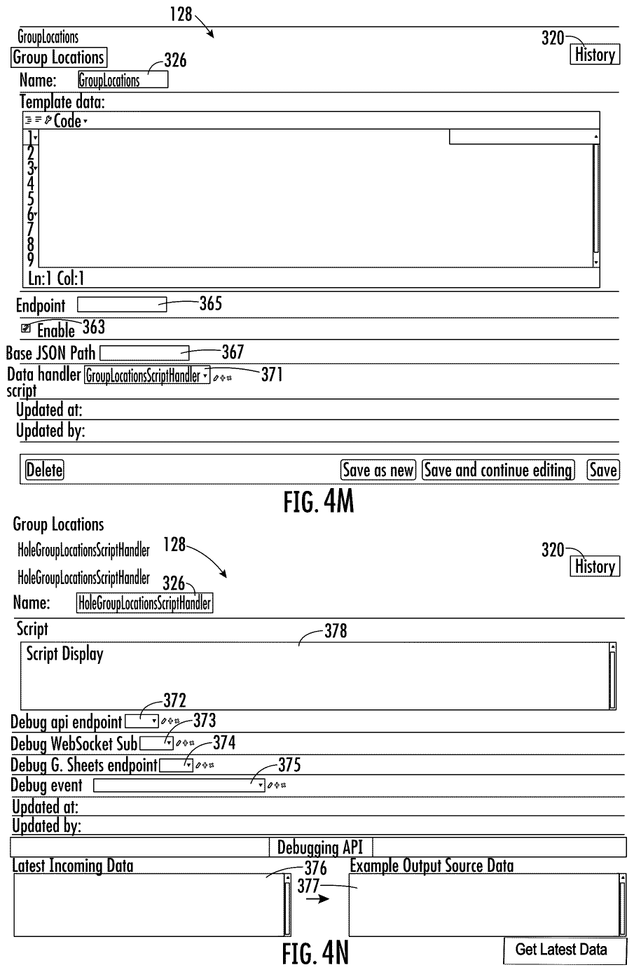

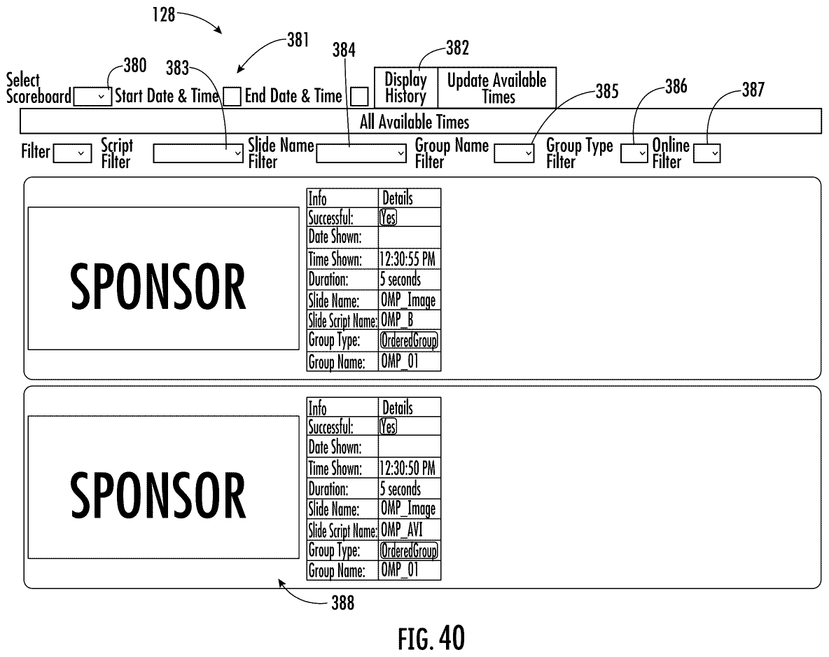

As introduced above, the data storage device 114 may maintain a data model including presentation data such as event data, scoreboard information, event information, or combination thereof. The presentation controller 110 or another processing unit of the presentation platform 100 or presentation system 10 may be configured to maintain the data model according to defined structures, relationships, or business rules of the data model. The data model may maintain the presentation data in a structure corresponding to scripting used by slide scripts to enable accurate data retrieval and that remains updatable and relevant to slide script operations across multiple events over time. The data model may include various types of event data with respect to one or more tournaments that the presentation controller 110 may access to control presentations. For example, slide script may be used to access the data model to obtain slide content or for evaluation with respect to triggering a change to a presentation, e.g., determine which content to include in a slide, make determinations regarding whether a slide is to be presented, among others. For instance, the data model may be fed event data obtained through scripting operations that run prior to or during events, e.g., API calls, data feed pushes, bucket queries, which may be driven by the settings described with respect to FIGS. 4K-4N or elsewhere herein. The data model may include event data such as current or past participants, player groups, tee times, player bios, player headshots, current or past event sponsorships for specific tournaments. The data model may include information about course venues, historical information regarding tournaments, courses, players, play scoring statistics (which may include shot statistics), live or pre-produced video or animations, sponsor logos, among others. For example, the data model may include event information such as information about particular tournaments, which may include venue, dates with respect to the tournament or rounds thereof, courses with respect to rounds, sponsors, among others. In some embodiments, the data model may maintain historical event information with respect to various tournaments available for use in the presentation operations. Thus, in various embodiments, the data model may maintain a data structure of presentation data for multiple events that can be continuously built upon to provide access to data with respect to specific tournaments as well as compiled data related to multiple tournaments, tours, seasons, time periods, or other configuration for access and use in presentation operations. In some embodiments, the data model may include references to one or more of the above data elements that the presentation processor 110 uses to direct presentation operations, such as obtaining slide assets. In one embodiment, the data model may include or provide file location of a sponsor, venue/course, or tournament logo applicable to a tournament that may be pulled by the presentation controller 110 for injection into a slide.

To facilitate repeatable scripting across events, in various embodiments, the data model maintained in the data storage device 114 may define canonical fields for core entities used by slide scripts and trigger scripts. By way of example and without limitation, event records may include fields such as event_id, name, start_time, end_time, course_ids[ ], sponsor_ids[ ], timezone, as examples; scoreboard records may include scoreboard_id, event_id, course_id, hole_no, location, assigned_presentation_id, online_state, as examples; slide records may include slide_id, type, asset_refs[ ], parameters, as examples; group records may include group_id, group_type (ordered, unordered, or trigger), member_slide_ids[ ], rules (including interruptibility and run-to-completion), as examples; metrics records may include scoreboard_id, group_id, slide_id, start_time, end_time, status, last_shown_at, as examples. In operation, a representative slide script for a leaderboard may read a current Event by event_id, identify the associated scoreboard context (e.g., hole_no and location), and query the latest scoring subset for the event and course_id to populate the table placeholders (e.g., player name, current score, and position) before the presentation controller 110 renders and transmits updated HTML/CSS to the browser 212.

Triggering a change to a presentation 104 may include triggering a change from one slide 106 in the presentation 104 to another slide 106. For example, the presentation system 10 may employ scripts 108 to ingest data from a data source 30 that tracks shot data with respect to the event. If evaluation of the shot data indicates that the last player in a player group playing the hole the scoreboard 200 is located, e.g., as specified in the associated scoreboard information, has holed out, this may trigger a change to a next slide 106 in the presentation 104 comprising a leaderboard. A slide script may also be run against the leaderboard slide 106 that drives ingestion of shot data from the same or another data source 30 comprising shot tracking data, and if the ingested data indicates a change in leaderboard data, the slide script may cause the leaderboard slide content to update with the updated data. In one example, triggering a change to a presentation 104 may include interrupting a presentation 104 with messaging or another slide 106. For example, trigger script may listen, which may include poll, a data source 30, e.g., listen to APIs, bucket queries, data feed pushes (such as WebSockets), comprising weather data that includes or accesses a lightning detection system and if evaluation of the weather data indicates a lightning strike within a specified distance from the course, the trigger script may trigger presentation 104 of a weather alert slide 106, weather alert slide 106 group, or a weather alert message to integrate into presented slides 106, which may include interruption of a current presentation 104 or slide group in the presentation 104 and display of the weather alert message, slide 106, or group. In one embodiment, weather slides may be assigned to the presentation and coded with slide script that queries a data source 30 that maintains real-time course weather conditions. Prior to presentation of the weather slide, the data source 30 is queried for current weather conditions. The weather slide is further coded for injection of the received current weather conditions into the weather slide to update the slide prior to display.

The presentation system 10 may be configured for integration of assets or other presentation data from other systems, e.g., retrieved from data sources 30. For instance, scripting may drive data retrieval from data sources 30 and the data may be ingested and injected into slides 106. In one example, ingested data comprises video, such as live video, which is integrated into the slides 106. Integrations may include video files or content streamed to the browser 212 for presentation within a slide component. In one embodiment, integrations comprise ball tracing. Ball tracking may include videos or images incorporating ball tracers. In some embodiments, integrations comprise ball traces for embedding or layer onto video or images. In one example, the ball tracers are mapped to video or images and the processor is configured to embed or layer the ball tracers onto video or images according to the mapping. Another example of integrations may also include weather radars. For example, a weather alert slide 106 may include a framework comprising a video frame component wherein scripting is run to call a dynamic weather radar graphic for the event area and integrate the weather radar graphic into the video frame of the slide 106 framework.

In one embodiment, time alignment and spatial mapping are used to integrate ball tracers with video or images. The presentation controller 110 may maintain a time synchronization policy between tracer timestamps and video frames using timecodes or clock synchronization. A maximum skew threshold may be enforced, beyond which the overlay may be suppressed or delayed. For spatial alignment, a 2D homography may be computed between the broadcast frame and a course reference image, or a camera pose solution using known fiducials or calibration points may be used to project tracer coordinates to frame pixels. In one embodiment, rendering may include application of an ordered overlay pass with alpha blending and a frame-drop policy if tracer latency exceeds a predefined threshold. In one embodiment, if mapping confidence falls below a predefined threshold or the video is unavailable, the system may be configured to display a fallback (e.g., a static course graphic or a slide without the tracer layer) to maintain presentation continuity.

In some embodiments, the scripts 108 may call for import of other scripts based on event information, scoreboard information, or event data specified in the script 108. Thus, a script 108 may specify that if information or an event is true or false, the presentation controller 110 is to import a script 108, for example, from a script library 160, another application, system, or from a data source 30.

As introduced above, scripting may additionally or alternatively include trigger scripts that run behind a presentation 104. Similar to slide scripts, trigger scripts may invoke queries of local or remote data sources 30 for presentation data, e.g., event data, for evaluation to determine if a particular slide 106 or trigger group is to be injected into the presentation 104. For instance, trigger scripts may be used to control when or if a slide 106 or trigger group is displayed in a presentation 104.

Trigger scripts may generally invoke queries of data sources 30 for evaluation of presentation data with respect to parameters of the specified trigger. The data evaluated may correspond to the event data. For example, live event data such as scores, player locations, shot tracking, weather, or other event related data may be used to direct a trigger presentations. In various embodiments, trigger scripts may be used to drive any state change in the operations of the presentation platform 100. Thus, slide scripts and trigger scripts may be used by the presentation system 10 for automating aspects of presentations 104 based on event data, which may include player tracking, play stoppage, or shot data such as scoring. In some embodiments, other presentation data may be used in connection with trigger scripting operations. The trigger scripts may include evaluation of event data obtained from one or more data sources 30. Trigger scripts may be configured to invoke API queries, e.g., calls or other data request or listening activities. Trigger scripts may include listeners, monitors, or otherwise be configured to monitor a data source 30 for presence of parameter values corresponding to triggers. For example, execution of a trigger script may invoke an API call to fetch data or listen to a data feed subscription, e.g., a WebSocket. trigger scripts may run behind a presentation 104 such that API calls, bucket queries, WebSocket listening, or the like runs continuously during a presentation 104. Presentations 104 may include presentation control data such as various settings. For example, settings may include interval settings with respect to trigger scripts. For instance, trigger script may include or the presentation controller 110 may be configured to execute calls or queries according to an interval setting with respect to the trigger script or to all or a specified portion of trigger scripts assigned to a presentation 104. The presentation settings may be set prior to the event. The presentation settings may be static for the presentation 104 for use over multiple events. In some embodiments, the settings may be subject to dynamic manipulation specified in the same or a different trigger script. For example, the presence or absence of a script condition with respect to event information, e.g., particular round, point in a round (such as post-cut or playoff), date, scoreboard information, or event data, may trigger an interval change, which may be automatic and coded in the trigger script. In this or another configuration, a script condition may similarly result in a dynamic change in a data source 30 or endpoint of a data source 30 or script parameter or value thereof associated with a condition triggering an action with respect to a slide 106 or presentation 104. In one instance, the presence or absence of a particular script condition may code for importation of a script 108 that replaces the script 108 or another script 108 associated with slides 106 or the presentation 104.

The presentation controller 110 may automatically assign or be used to assign presentations 104 to scoreboards 200 used for one or more events. The presentations 104 may be available for assignment to a scoreboard 200, groups of scoreboards 200, or all scoreboards 200 of an event or multiple events. For example, a first presentation 104 may be assigned to all scoreboards 200 positioned on holes (e.g., par 3s, par 5s, odd holes, front 9, subset of holes) or at particular hole locations (e.g., green side, tee side) and a second presentation 104 may be assigned to other scoreboards 200. As noted above, presentations 104 may include slides 106 coded with scripts 108 to automatically customize the slide 106 based on presentation data, e.g., event, hole of scoreboard 200, hole location of scoreboard 200, event day, time of day, or other information. For example, slide components such as sponsor graphics/logos, hole number, or video integrations (e.g., video of a shot taken on the hole) may automatically customize to the event or hole based on the scoreboard information associated with the particular scoreboard. Thus, the same presentation 104 may be assigned to different scoreboards 200 but each scoreboard 200 may display slides in different orders, with different content, and a different times due to scripting that customizes the slides. As another example, slides 106 may automatically skip or be excluded from the presentation 104 based on presentation data. For example, slide script may cause a slide 106 to be skipped or included only on scoreboards 200 having a greenside hole location. In some embodiments, other information such as occurrence of events may be coded to automatically customize a slide 106 or the presentation 104. For instance, a slide 106 that displays a projected cut may skip on particular days or after the cut. Thus, a script 108 may cause the slide 106 to be skipped on post-cut days or script 108 may query a data source 30 that provides information regarding whether the presentation 104 is being executed post-cut. In some embodiments, the occurrence of events or other information may automatically cause an alternate presentation 104 to be executed. In one example, this automatic switching of presentations 104 may be initiated by script 108 in response to the presence of a trigger, which may be similar to triggering presentation 104 of a trigger group described in more detail below and elsewhere herein.

Presentations 104 may implement a presentation concept proving high-level grouping of slide content. Thus, a presentation 104 may be assigned to a scoreboard 200 for display and include specified groupings of one or more slides 106. The slide group concept may be implemented to provide a presentation framework geared toward automated or minimal user interaction for execution of presentations 104 during or between events. The slide groups may include one or more of ordered groups, unordered groups, trigger groups, or combination thereof. The slide groups may be defined in presentation control data. A single presentation 104 may include one or more slide groups. Some presentations 104 may include multiple groups of slides 106 within one or more slide 106 groupings. For instance, multiple trigger groups or trigger group slides 106 may be included in a single presentation 104.

Ordered groups encompass content that is presented in a specific order. For instance, ordered groups may be used to create buckets of content that play in a specific order.

Unordered groups do not need to be presented in a specific order. Slides 106 in ordered groups may include, for example, slides 106 identifying event or tournament sponsors paired with slides 106 including sponsored aspects of the event. Unordered groups may be injected into presentations 104 based on defined criteria, such as number of frequency per period of time. For example, unordered groups may be used for setting content that requires a specific frequency per hour or per day rather than just running in order. Slides 106 in an unordered group may include sponsor logos, videos, advertisements, or any other slide content that is suitable for presentation 104 without an order of presentation 104 with another slide 106.

The presentation system 10 may employ triggers using trigger scripts to trigger scoreboards 200 to display specific content at specific time based on evaluating scoring data in real-time. Trigger groups may include a group of slides 106 and operate as an ordered group trigged by trigger script. Trigger groups may be driven by trigger scripts, such as Python scripting, to trigger specific content at a specific time based on data evaluation. Any number of slides 106 may be included in a trigger group. In various embodiments, trigger groups may include live video integration into slides 106 triggered by evaluation of live event data obtained from data sources 30.

Presentation control data may include interrupt setting with respect to groups. For instance, an interrupt setting with respect to an unordered group may specify whether the unordered groups can interrupt ordered groups in a presentation 104. An interrupt setting with respect to an ordered group may specify whether the ordered group may be interrupted by an unordered group or particular categories of unordered groups. Interrupt settings with respect to a trigger group may specify if the trigger group can interrupt an ordered group, unordered group, or one or more categories thereof. Trigger group interrupt settings may include whether the trigger group may be interrupted by ordered or unordered groups. Trigger group settings may include whether the trigger group will continue until interrupted or end. Ending of a trigger group may be automatic based on completion of display of the group, occurrence of an event based on evaluation of event data or other presentation data.

Trigger groups may be triggered utilizing trigger scripts that include APIs calls, listening to WebSockets, bucket queries, or combination. Trigger scripts may listen to data source data from API calls, WebSockets, bucket queries, or combination thereof controlled by the presentation controller 110, the incoming data may also be used in data model building. The presentation controller 110 may execute trigger scripts behind the presentation 104 for detection of triggers for trigger groups assigned to the presentation 104. As noted above, the trigger groups may be associated with presentation control data comprising settings such as API querying intervals and interrupt settings that specify if the trigger group may be interrupted by an unordered group, if the trigger group is to continue running after the slides 106 have been presented or exit back to the presentation content prior to the trigger, if the trigger script may be cut short, or if the trigger group can be interrupted by another trigger group. In one example, trigger script with respect to a trigger group evaluates API data relative to the trigger specified in the trigger script. If the evaluation returns true, then the trigger group is executed. In various embodiments, trigger scripts may be used for any state change in the presentation 104. For example, if trigger script for a final score slide 106 evaluates event data and returns true for last player holed out or otherwise play has concluded on the final hole of the group, the final score slide 106 is triggered for presentation 104. The final score slide 106 may also include script 108 for dynamically updating final scores presented in the slide 106.

Trigger scripts may trigger a change to a presentation 104 that includes injection of slides 106, which may include unordered or ordered slides 106, into the current presentation schedule. For example, if data ingested from a data source 30 that maintains player tracking data indicates that a player group is approaching a tee box on the hole a scoreboard 200 is located, a trigger script may trigger injection of a trigger group comprising one or more slides 106. In one embodiment, trigger script may inject an unordered or ordered slide or slide group into the presentation 104. As noted herein, the presentation platform 100 may include slide group packaging options to enable a user to set whether ordered slides 106 may be interrupted by ordered or unordered slides 106 or slide groups. The slide 106 or slide group may be injected between ordered groups or between slides 106 in an ordered group. For example, if data ingested from a data source 30 that maintains real-time player tracking data with respect to locations of players, which may also include shot tracking data maintained by the same or different data source 30, during the event indicates a player group is walking to their balls following their tee shots on the hole the scoreboard 200 is located, trigger script may trigger injection of an unordered slide 106 within an ordered group that runs with respect to a player group as the players approach the tee box through hole completion, which itself may comprise a trigger group including one or more slides 106 that function as an ordered group once triggered. In a further example, trigger script may be used to ingest real-time player location and shot data that is evaluated with respect to shot location relative to the player location to determine if a slide 106 should be injected. For example, trigger script may be coded with a player location and distance calculation for an expected time period before a player will be ready for a next shot. This calculation may be used to determine if or which unordered or unordered slide 106 or group is injected, e.g., a slide 106 may have a set duration associated with it that fits within the calculated time period. Thus, based on evaluation of events and associated intervening time, slide 106 or slide group duration settings, interruption settings, presentation control data associated with a group initially interrupted by the trigger group, or combination thereof, a trigger script may be used as a trigger for injection of a slide 106, e.g., of an unordered or ordered group, or an unordered or ordered group that may not be specifically packaged in a trigger group. In a further or another example, script 108, such as trigger script, may cause data to be ingested, e.g., script 108 may listen to or query one or more data sources 30 that maintain shot or player tracking data related to player locations for indication that a player in the group is ready to hit their ball, e.g., player_A_overball, on the hole. This may trigger a return to the trigger or ordered group that was interrupted. In one example, the script 108 is a slide script injected into the interrupting slide 106 that conditionally cuts the set duration of the interrupting slide 106 upon the occurrence of one or more specified events. Upon the occurrence of the event, the presentation controller 110 may transmit the presentation data for the subsequent slide 106 or otherwise instruct presentation 104 of the subsequent slide 106 without satisfaction of the duration settings of the current slide 106, which may be an interrupting slide 106. Thus, the presentation controller 110 may be configured to situationally inject scripts 108 into slides 106 or otherwise apply trigger scripts during a presentation 104 to assist in presentation control. Those having skill in the art will appreciate upon reading the present description that the presentation controller 110 may be configured to perform situational slide 106 injection and interruption without injection of pre-defined scripts 108. For example, the presentation controller 110 may execute an application comprising a presentation algorithm, which may be as described above and elsewhere herein, that analyzes presentation control data, e.g., one or more of duration, frequency, interruption, or group settings, and in some instances, together with event data, e.g., player locations, shot locations, or the like, in presentation control operations to determine appropriate slide 106 injection to satisfy requirements specified by the presentation control data. In one embodiment, the determination may function in a manner similar to that described above and include consideration of presentation control data and event data. Historical event data may be used for estimation of available time periods for injection of slides 106 between slides 106 of an ordered group wherein slide 106 duration is based on evaluation of event data or gaps are otherwise present between slides 106 upon satisfaction of slide 106 duration settings. Consideration may also be made with respect to other presentation data, such as scoreboard information or event information.

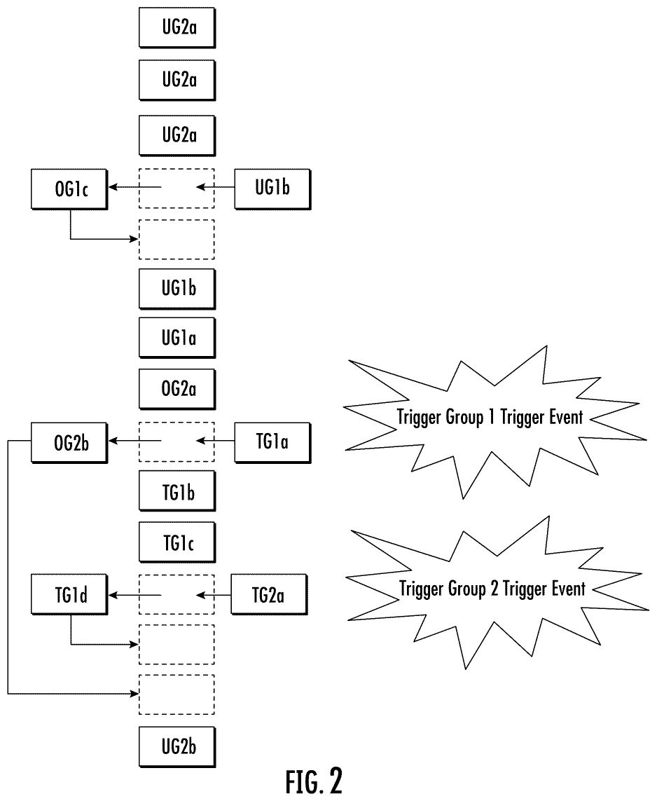

FIG. 2 schematically illustrates an example operation of a slide 106 group concept applied to a presentation 104. The presentation 104 includes one or more ordered groups (e.g., ordered group 1 includes three slides 106: OG1a, OG1b, OG1c; ordered group 2 includes two slides 106: OG2a, OG2b), one or more unordered groups (e.g., unordered group 1 includes four slides 106: UG1a, UG1b, UG1c, UG1d; unordered group 2 includes two slides 106: UG2a, UG2b), and one or more trigger groups (e.g., trigger group 1 includes four slides 106: TG1a, TG1b, TG1c, TG1d; trigger group 2 includes one slide 106: TG2a). The presentation 104 begins with presentation 104 of UG2a, the first slide 106 of the second unordered group. Thereafter, presentation 104 of ordered group 1 begins with presentation 104 OG1a and OG1b, the first two slides 106 of ordered group 1. Ordered group 1 has been set to allow interruption by unordered groups. Here, UG1b, the second slide 106 of unordered group 1, has a high frequency requirement and the processor injects the slide 106 between OG1b and OG1c, the second and third slides 106 of the first ordered group. Being the third slide 106 in the first ordered group, OG1c is then presented following UG1b. The second and first slides 106 of unordered group 1 (UG1b, UG1a,) are then presented. Next, OG2a, the first slide 106 of ordered group 2 is presented. During presentation 104 of OG2a, trigger script for trigger group 1 is triggered and causes presentation 104 of TG1a, the first slide 106 of trigger group 1, to interrupt presentation 104 of ordered group 2. The second and third slides 106 of trigger group 1 (TG1b, TG1c) are then presented following TG1a. During presentation 104 of TG1b, trigger script for trigger group 2 is triggered. Trigger group 1 has been set to allow the ordered trigger group to be interrupted by another trigger script. This results in presentation 104 of TG2a, the only slide 106 in trigger group 2, to be injected, rescheduling presentation 104 of TG1d, the fourth and final slide 106 of trigger group 1 after presentation 104 of TG2a. In this example, both trigger groups 1 and 2 have been set to exit once complete. The second and last slide 106 of ordered group 2 (OG2b), having been displaced by the occurrence of triggers is then presented following presentation 104 of TG2d. The second slide 106 of unordered group 2 (UG2b) is then injected for presentation 104.

In various embodiments, the presentation controller implements a reproducible scheduling policy, which may be implemented within the timeline of FIG. 2, where ordered, unordered, and trigger groups are injected according to these rules. For example, for each transition, the presentation controller may be configured to (1) gather all slide groups with unmet quota for the current time window; (2) filter out any groups that cannot interrupt the current group based on group rules; (3) among the remaining candidates, select the group with the highest remaining quota deficit; (4) if multiple candidates remain, select the group with the earliest last-shown timestamp; (5) if a tie persists, select the group with the lowest lexical identifier; (6) present the selected group and decrement its quota by the actual measured duration; and (7) repeat the process at the next transition. In one embodiment, the scheduling policy is implemented in a fixed order so that tie-breaks and quota satisfaction are reproducible.

As introduced above, the presentation controller 110 may be configured to apply a scheduling policy, which may also be referred to as a scheduling algorithm, to select which slide group (e.g., ordered group 210, unordered group 220, or trigger group 230) to present at each transition point. For example, the scheduler may maintain, for each group, a record of the required impression quota for a given time window (e.g., per hour, per day, or other specified period, which, in some embodiments, may be variable based on time of day, occurrence of specified events, or otherwise), the number of impressions already delivered, and the timestamp of the last presentation. At each transition-such as the end of a slide or group on display 204—the scheduler may (1) gather all slide groups with unmet quota for the current time window; (2) filter out any groups that are not eligible to interrupt the currently running group, based on the group's interruptibility settings (e.g., see group interrupt settings option 350 (FIG. 4H)); (3) select, among the remaining candidates, the group with the highest remaining quota deficit; (4) if multiple groups have the same quota deficit, select the group that was shown least recently, as determined by the earliest last-shown timestamp; and (5) if a tie still exists, select the group with the lowest lexical identifier or another consistent tie-break property (such as group_id). When a group is presented, the scheduler may decrement its quota by the actual measured duration of the presentation, as recorded in the metrics table (see, e.g., FIG. 4J). This or a similar process may be repeated at each transition to ensure all frequency and exposure requirements are satisfied in a predictable and reproducible manner, and that tie-breaking is handled without ambiguity. The scheduler may operate continuously throughout the presentation. Optionally, machine-learning or heuristic ranking may be layered on top of this selection policy without overriding hard constraints (e.g., regulatory messaging frequency, sponsor exposure requirements, or run-to-completion rules)

In various embodiments, at each transition point, the presentation controller 110 may identify slide groups (e.g., 210, 220, 230) with unmet quota for a current time window. The presentation controller 120 may then filter out groups that are not eligible to interrupt the currently running group, based on the group's interruptibility settings. Among the remaining candidates, the presentation controller 110 may select the group with the highest remaining quota deficit. If multiple groups have the same quota deficit, the presentation controller 110 may select the group that was shown least recently, e.g., as determined by the earliest last-shown timestamp. If a tie still exists, the presentation controller 110 may select the group with the lowest lexical identifier or another consistent tie-break property. When a group is presented, the scheduler may decrement its quota by the actual measured duration of the presentation, as recorded in the metrics table. This process may be repeated at each transition, ensuring that all frequency and exposure requirements are met in a predictable and reproducible manner, and that tie-breaking is handled without ambiguity. While optional machine learning guidance may be used to rank otherwise eligible candidates, e.g., using one or more of recent impression history, dwell-time proxies, or event phase, the scheduling algorithm operated by the presentation controller 110 may be configured to remain the default selection mechanism. In some embodiments, machine learning influence, which may be optional, may be constrained to ranking among candidates that already satisfy hard constraints, which may include interrupt settings 350, required quotas, and run-to-completion rules, and unable to override those constraints.

As introduced above, the presentation platform 100 may be configured for integration of video. Video integration may be driven by scripts 108. Video integration may include pre-recorded video, such as highlights, montages, advertisements, or other video productions or recorded video feeds. In some embodiments, video integration may comprise live video integration. In one configuration, the presentation platform 100 may be configured to capture or receive live video, such as a live video feed, for presentation 104. The live video may be of the event, another event, or otherwise. In one configuration, the presentation platform 100 or scoreboard controller 210 may be configured to ingest one or more live video feeds from one or more data sources maintaining live video, which may include streaming live video, such as a cloud source or another system or application, which may be local or remote to the event, presentation platform 100, or both. In one example, the presentation platform 100 may be configured to receive or access a plurality of live video feeds of the event from a video source. A slide 106 may comprise or consist of a presentation 104 of a live video feed. In some embodiments, the live video data may be specified for inclusion via slide scripts. In one embodiment, the presentation platform 100 may be configured with scripts 108 to trigger integration of replays of live content from other systems into slides 106 for inclusion in the presentation 104. In one example, a trigger script comprises a bucket query for video. If the video is available, the trigger script triggers presentation 104 of a slide 106 or trigger group including the slide 106. A slide script paired with the slide 106 may also drive integration of the video into the slide 106 presentation 104. In another example, the trigger script listens to a WebSocket or other data feed for indication of a player group entering a tee box. This may trigger a trigger group wherein the first slide 106 includes graphics identifying the players and current scores or leaderboard position. A slide script associated with the first slide 106 may be invoked to query a data source 30 that maintains shot tracking to dynamically update the slide 106. A slide script may be run against the first slide 106 a listen for event data indicating a player standing over ball with respect to a player in the group on the hole the scoreboard 200 is located, as specified in the scoreboard information. This may invoke a slide script to perform a bucket query for a live video feed of the player setting up and hitting the ball for integration into the presentation 104, either into the slide 106 or a next slide 106.

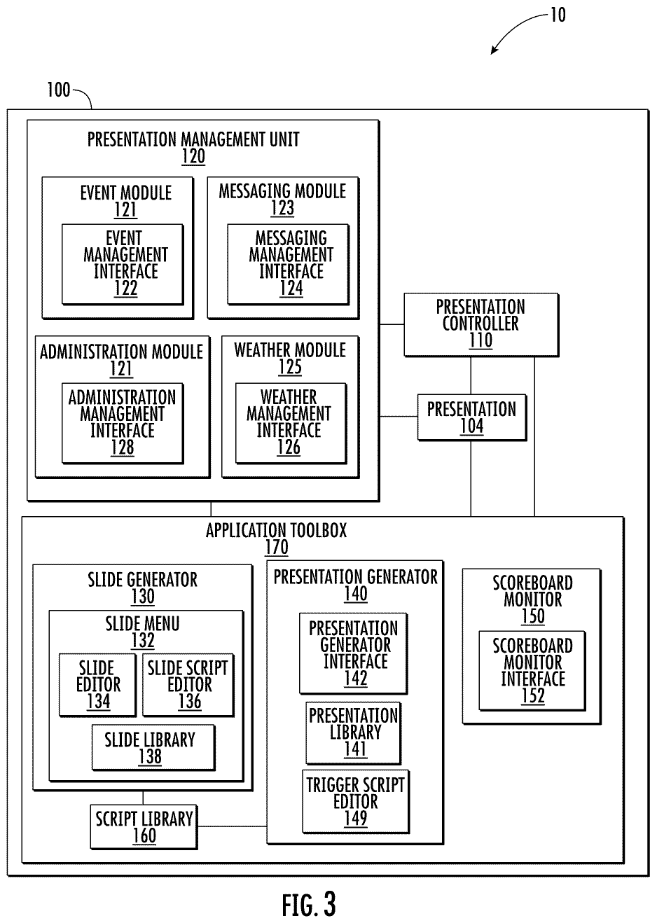

With further reference to FIG. 3, a presentation platform 100 may provide various modules through which users may interact with the presentation platform 100. Example modules may include one or more of an event module 121, messaging module 123, weather module 125, or administration module 127.

The event module 121 may be configured for scoreboard management operations provided by the presentation platform 100, which may include one or more of scoreboard assignment, scoreboard monitoring, power management, or presentation control operations. For example, the event module 121 may provide an event management interface 122 that interfaces users with scoreboard management operations such as defining scoreboard and event assignments. For example, the event management interface 121 may be configured for tournament selection, providing scoreboard assignments (e.g., addition or removal of scoreboards 200 or scoreboard groups to an event), or defining scoreboard locations or other scoreboard information that may be used to direct presentation operations (e.g., set hole number, location, or both) of scoreboards 200. The assignments may be used to provide event and scoreboard information used in scripting operations described above and elsewhere herein. The event management interface 121 may also include options for setting on/off times for all or particular scoreboards 200, assigning presentations 104 to scoreboards 200, changing assigned presentations 104, monitoring scoreboards 200 (e.g., online/offline, presentation 104), or combination thereof. In some embodiments, the data model may be fed event information, scoreboard information, or both from the operations of the presentation management unit 120, such as the event module 121, administration module 127, or both.

The messaging module 123 may be configured to perform scoreboard messaging operations provided by the presentation platform 100 with respect to messages that appear on scoreboards 200. The messaging module 123 may include a messaging management interface 124 that interfaces users with the scoreboard messaging operations such as generating messages, defining message displays such that a message displays with a presentation 104 or overrides a presentation 104, defining which scoreboard messages appear, viewing assigned scoreboard information such as course, hole, or location, viewing if any messages have been enabled on scoreboards 200, viewing specific messages per scoreboard, or combination thereof.

The weather module 125 may be configured to perform weather management operations provided by the presentation platform 100 with respect to weather messages that appears on the scoreboards 200. The weather module 125 may include a weather management interface 126 that interfaces users with the weather management operations such as defining weather messages, defining presentation parameters of weather messages such as whether a weather message is to be included in a presentation 104 or override a presentation 104, defining which weather messages appear, or combination thereof. The weather management interface 126 may provide information and monitoring features such as generating a display showing assigned scoreboards 200, which may include the assigned course, or hole location of each assigned scoreboard, whether any weather messages have been enabled on scoreboards 200, or specific weather messaging slides 106 per scoreboard.

The administration module 127 may be configured to perform administration operations with respect to the presentation platform 100. The presentation management unit 120 may provide administrative users access to the administration operations via an administration management interface 128. The administration management interface 128 may provide various functionalities such as user credentialing with respect to presentation platform administration operations. The functionalities may include slide creation, script creation, or other presentation platform administration operations.

The presentation platform 100 may include an application toolbox 170 including various presentation tools. In various embodiments, one or more of the tools may be accessed by the presentation management unit 120, presentation controller 110, or by other applications or users of the presentation platform 100. The application toolbox 170 may include a slide generator 130 configure to generate slides 106, slide scripts, or both. The slide generator 130 may include a slide menu 132 providing various slide generation operations. The slide menu 132 may include one or more of a slide editor 134 to create or edit slides 106, a slide script editor 136 to create or edit slide scripts, or a slide library 138 including previously generated slides or slide frameworks for subsequent use or editing. The application toolbox 170 may include a presentation generator 140 and presentation generator interface 142 configured to enable creation or editing of presentations 104. The presentation generator 140 may include a presentation library 141 including previously defined presentations for subsequent use or editing. The presentation generator 140 may include a trigger script editor 149 configured to enable creation or editing of trigger scripts. One or more of the slide editor 134, slide script editor 136, presentation generator interface 142, or trigger script editor 149 may include debugging features with respect to debugging slide script, slides, trigger script, or presentations. A script library 160 may be included or accessible by the presentation management unit 120, presentation controller 110, slide generator 130, or presentation generator 140. The script library 160 may include previously created scripts 108, e.g., slide scripts, trigger scripts, or both, which may include script frameworks, for subsequent use or editing.

The presentation generator 140 may include or be configured to access script library 160 that maintains previously generated trigger scripts or trigger script frameworks of quick import or customization. The script library 160 may additionally or alternatively maintain previously generate slide scripts or slide script frameworks for quick import or customization when generating slides 106 using the slide generator 130. For example, the slide script editor 136, trigger script editor 149, or both may access the script library 160 to retrieve scripts 106 for use or editing or to store scripts 106 for later use.

The presentation generator 160 may include or be configured to access a trigger script editor 149 comprising an interface that enables users to edit trigger script. The trigger script editor 149 may have user access limitations such that only credential users may access. For example, access may be limited to administration managers or users accessing the trigger script editor 149 via the administration module 127. Import and export of scripts may also be scripted for automatic import or export of scripts. Both slide and trigger scripts may be coded for script import/export functions. For example, a script may evaluate event information, scoreboard information, or event data that may trigger the import or export of slide script with respect to the slide or trigger script with respect to the presentation 104. In one example, the presentation controller 110 may execute the script and, if an import script function is called, the presentation controller 110 may access the application toolbox 170 to retrieve the script 108 from the script library 160. As described in more detail elsewhere herein, scripts 108 may be imported from data sources 30 such that the presentation controller 110 may access data sources 30 to retrieve scripts 108. The retrieved scripts 108 may be imported into slides 106 by the presentation controller 110. In one embodiment, slide scripts may code for importation of slides 106 into the presentation 104 for customization of the presentation 104 on the fly. In some embodiments, the imported or exported slides 106, scripts 108, or both may be retained in the presentation 104, e.g., in the presentation library 141, for future use.

In some embodiments, the presentation platform 100 includes a scoreboard monitor 150 that provides real-time monitoring of scoreboard displays. For example, the scoreboard monitor 150 may be configured to generate one or more monitoring pages within a scoreboard monitoring interface 152 providing the real-time displays. In one embodiment, the scoreboard monitor 150 is configured to generate the one or more monitoring pages based on user specified arrangements. For example, options may be provided to define scoreboard monitoring interface 152 parameters such as setting a number of scoreboards 200 to show per monitor page and which monitor page to view. In various embodiments, the scoreboard monitor 150 may be accessed via the one or more of the modules. The scoreboard monitor interface 152 may provide the same or different operational features to users based on credentialed status of the users.

As introduced above, the event module 121 may include an event management interface 122 comprising one or more interfaces that interface users, such as event managers, with event management operations. For example, event management operations may include scoreboard assignment. For instance, the event management interface 122 may enable a user to define event assignments. The interface may provide an event list or field for user selection or entry. Selection or entry of an event may enable access to management operations related thereto. For instance, interface operations may be available that enable users to create a grouping of scoreboards 200 for an event or modify a grouping of scoreboards 200 assigned to the event. In one embodiment, selecting or otherwise specifying an event may output a list of scoreboards 200 or scoreboard groups previously assigned to the event. Additionally or alternatively, an entry field or a listing for selection of scoreboards 200 or scoreboard groups may be presented. In one example, the event module 121 may be configured to assign the host course of the selected event by default when a scoreboard 200 is added to the event.

In an above or another embodiment, the event management interface 122 may interface a user with event management operations such as scoreboard monitoring wherein the event management interface 122 presents event management information, such as information tracked by the presentation platform 100, regarding the operations of scoreboards 200. In one example, presentation metrics may be viewable to evaluate which slides 106 have been displayed, duration of slide 106 displays, times of displays, or combination thereof. An example interface for viewing such metrics with respect to slides is described in more detail below with respect to FIG. 4O. Power management, presentation control, or both may be available via interaction with the event management interface 122 with respect to a change or modification of the information and associated operations. For example, the information may include site of the scoreboard, such as course, hole, or location. In a further example, scoreboard assignment features of the event module 121 may include or provide access to a list of unassigned scoreboard sites and enable users to select or otherwise specify a scoreboard to be assigned to the site. Using the event module 121, site information may be defined or modified to, for example, change the course to a secondary course of the event, set a hole number, or set a location (e.g., green, tee box, clubhouse, or other grounds location), for each scoreboard. In some embodiments, the event module 121 may be configured to provide information via the event management interface 122 regarding the real-time online or offline status information of the scoreboards 200.

The event module 121 may be configured to provide access via interaction with the event management interface 122 to the scoreboard monitor 150 to view one or more monitor pages providing real-time displays of scoreboards 200. In one example, the event module 121 may enable users to define scoreboard monitor interface parameters such as setting a number of scoreboards 200 to show per monitor page and which monitor page to view. In some embodiments, users may add scoreboards 200 to a scoreboard group or define a scoreboard group. A scoreboard group may be configured with presentation 104 programming that overlaps in one or more aspects. For example, presentation 104 programming may include power on/off time, presentation parameters with respect to one or more presentation content groupings, or other presentation 104 aspect. In this or another example, scoreboard groupings may be defined for ease of monitoring by selection of the scoreboard group for monitoring via the scoreboard monitor interface 152. Example scoreboard groups may group scoreboards 200 by event, course, hole, location on hole (e.g., green scoreboards), or other location related criterion. In this or a further embodiment, the event management interface 122 may interface users with event management operations such as power management. For example, the event module 121 may enable setting of on and off times for scoreboards 200. In one example, power schedule times may be set uniquely per scoreboard. The event module 121 may additionally enable adjustment of set start and end times, which may be individually, in groups, or for all assigned scoreboards 200. For example, start and end times may be manually or automatically adjusted for each specific local event time zone.

The event management interface 122 may interface users with event management operations, such as presentation control. For example, the event management interface 122 may present information related to presentation 104 programming operations, wherein user interaction may cause the event module 121 to change the presentation 104 for all or some scoreboards 200, e.g., a scoreboard grouping, to an alternate presentation 104. In one example, the event management interface 122 may be configured to provide a list of available alternate presentations 104 from which to select or change an assigned current or scheduled presentation 104. The available alternate presentations may be predefined for the presentation or by type of presentation. In one example, the event module 121 accesses the presentation library 141 to provide the list of alternate presentations or to access the presentation data for the alternate presentations when selected. Presentation control setting options may additionally or alternatively be provided for viewing or setting start and end times for a presentation 104.

FIG. 4A depicts an example event management interface 122 configured to enable a user to select events to view and manage scoreboards. The event management interface 122 includes an event selection interface 300 for selection of an event. As shown, the event selection interface 300 includes dropdown menus for specifying an event to manage and includes event identification information including an event code, event year, and event name. However, other event identification information may be utilized. The event management interface 122 may also include quick access tools such as a recently visited events list 301 that incorporates quick links to recently selected events to manage.

FIG. 4B depicts a further or another example event management interface 122 configured to interface users with event management operations of the presentation platform. The event management interface 122 includes a scoreboard management window 302 provided in an interactive display that includes information regarding scoreboards. As shown, the scoreboard management window 302 includes a listing of each scoreboard, the currently assigned presentation, course (Spyglass Hill, Pebble Beach, Pebble Beach), hole (18, 14, 19), hole location (green, tee, clubhouse), the assigned presentation start and end times, whether the presentation is currently playing, and whether the scoreboard is online, e.g., a network connection is established between the presentation platform and the scoreboard controller. Interface options are also provided to remove scoreboards from the scoreboard management window 302. The event management interface 122 also includes various assignment features 303 enabling a user to make or modify scoreboard assignments. For example, interactive fields are provided within the interactive display of the scoreboard management window 302 to change scoreboard assignments with respect to course, hole, or location. Thus, the event management interface 122 may be used to manage scoreboards at multiple events simultaneously. As described in more detail herein, this assignment data may provide scoreboard information used for presentation control operations that inform slide presentation, slide content, slide group injection, or other presentation control operations, which may generally be driven, at least in-part, by scripting. Presentation assignment options 304 are also provided for user interaction to modify assigned presentations. The currently scheduled or playing presentation is identified in the monitor feature display. Scoreboards may be selected from the monitor feature and fields are provided to change or override the presentation and set or update start and end times. A user may change the start and end times of a currently scheduled or playing presentation or change the currently scheduled or playing presentation to another presentation from a menu of available presentations and define the start and end times for a selected presentation. Scoreboards may also be added to the scoreboard management window 302 for monitoring or modification of scoreboard assignments or presentations from an add scoreboard field 305.

As introduced above with respect to FIG. 3, the presentation platform 100 may include a scoreboard monitor 150 comprising a scoreboard monitor interface 152 including a monitor page display that includes a display of the real-time presentation 104 being displayed on each scoreboard 200 being monitored. In the event management interface 122 shown in FIG. 4B, a scoreboard monitor link 306 is provided to the scoreboard monitor interface 152. Using the scoreboard monitor link 306, a monitor page display is provided with a graphic display of what scoreboards 200 are showing in real-time. In some embodiments, the number of scoreboards 200 to be shown on a page may be defined by a user. The monitor page may include multiple monitoring pages, and users may select which monitoring page they would like to view. In one embodiment, which scoreboards 200 are displayed on which monitor pages may be definable by users. For example, the scoreboard monitor interface 152 may include interactive features including scoreboards 200, scoreboard groups, definable scoreboard groups, or the like that a user may select for inclusion on particular monitor pages.

With reference again to FIGS. 1 & 3, the presentation management unit 120 may include a messaging module 123. The messaging module 123 may include a messaging management interface 124 comprising one or more interfaces to interface users, such as messaging managers, with operations of the messaging module 123. For example, the messaging management interface 124 may include interactive features that enable a user to select a tournament in which to manage messaging operations with respect to scoreboards 200 assigned to an event. The messaging management interface 124 may include an interface element identifying assigned scoreboards 200 available for messaging management operations. The interface element may also display information relating to the assigned scoreboards 200 tracked by the presentation platform 100. In some embodiments, the information may be similar to that displayed on the event management interface 122. In one example, the information includes event site information for scoreboards 200, such as course, hole, or location. In one configuration, the messaging management interface 124 may provide real-time online/offline status information of scoreboards 200. The information may include identification of a scoreboard presentation 104 assigned to the respective scoreboards 200. The messaging module 123 may also be configured to access the scoreboard monitor 150 to view one or more monitor pages that provide real-time displays of scoreboards 200. The scoreboard monitor 150 and associated features of the scoreboard monitor interface 152 available to users of the messaging module 123 may be similar to or the same as that described above with respect to the event module 121. For instance, real-time views of current displays of scoreboards 200 may be presented in one or more monitor pages. In one example, users using the messaging module 123 may define parameters of the scoreboard monitor interface 152 such as setting a number of scoreboards 200 to show per monitor page and which monitor page to view.

The messaging module 123 may provide messaging management operations such as enabling messages. For example, the messaging management interface 124 may provide interactive features allowing users to enable messages for display on one or more scoreboards 200. In some embodiments, scheduling options may be provided user interaction to define scheduling parameters with respect to an enabled message. For instance, users may set whether a message is included in a scheduled presentation 104 if the message is to override the presentation 104, which may include interrupting a scheduled presentation 104, so only the message appears without the other presentation content. The messaging management interface 124 may include options to set whether messages appear on all scoreboards 200 assigned to the selected event or only specific scoreboards 200, such as those located on specific holes, located at specific hole locations, assigned to particular scoreboard groupings, or those assigned a particular presentation 104. In some embodiments, the messaging management interface 124 may provide options with respect to location, format, size, design, or combination thereof with respect to a message display, which, in one example, may be defined by the user to be same or different with respect to one or more scoreboards 200. The messaging management interface 124 may provide options for setting presentation control data with respect to messaging that enables users to set or modify start time, end time, duration time, message display intervals, or other scheduling aspects for messages. For example, display of messages, messaging slides, or aspects thereof may be set to definite times, time periods, or durations or may be set to be conditional based on analysis presentation or other data ingested by the presentation platform 100. The messaging management interface 124 may provide a display of specific messages that have been enabled for each scoreboard 200. In one embodiment, the messaging management interface 124 may identify which user enabled which message for which scoreboard 200 or groups of scoreboards 200. Other information may also be included such as the time the message was created, enabled, presented on which scoreboard, or other information.

The messaging module 123 may be configured to cause scoreboards 200 to display messages that have been enabled on scoreboards 200. For example, the presentation controller 110 may inject the message into a presentation 104 as a messaging slide 106 or incorporate messages into slides 106 that are a part of the scheduled presentation 104. In some embodiments, a presentation 104 may be assigned messages prior to start of the presentation. In one configuration, the presentation controller 110 may inject messages or messaging slides into presentations on the fly, while a presentation is playing.

In various embodiments, the messaging module 123 may be configured to create text-based messages for display on scoreboards 200. For example, the messaging management interface 124 may include a message creator that enables user directed creation of text messages. For example, a field may be included within which the user may enter text to be displayed on messaging slides 106 or non-messaging slides 106, e.g., embedded in a designated message field, presented in picture in picture format, injected into a message field next to a resized display of the original slide content, overlaid or scrolled over original slide content, or other suitable technique. In one embodiment, there is no limit to the number of messages that may be created using the message creation interface. In some embodiments, the messaging module 123 includes a message library that maintains previously created messages from which a user may select a message to use or edit. In various embodiments, the message library is provided in a slide library 138 that includes slides 106 that users may select to include in presentations 104 according to the various presentation operations described herein. In one configuration, the message library includes predefined graphics, text messages, or both. A user may select a graphic to pair with text or enter text into a text field associated with a graphic. As described in more detail below, the presentation platform 100 may employ a slide format in which presentations 104 include a collection of one or more slides 106. Slides 106 may include a slide framework of components into which additional slide content data may be injected. The data may include text, graphics, video, audio, among others. The injected components may comprise dynamically integrated slide content. In some embodiments, messages may be created in a slide format. For example, messaging slides may be predesigned and available for selection via the slide library 138. The messaging slides may additionally or alternatively be configured for further modification of slide components. For example, messaging slides 106 may be available for selection and integration of desired text. The messaging slides 106 may include graphics or graphics components, video, audio, text, among others. Messaging slides 106 may include data integrations or integration fields for injection of integration content.

FIG. 4C depicts an example messaging management interface 124. The messaging management interface 124 is shown with respect to a selected event wherein three scoreboards have been selected for display of a message. A scoreboard management window 302 is provided that lists the scoreboards and associated information, such as assignment information and real-time state information. The assignment information includes fields for scoreboard name, presentation name, course (Spyglass Hill, Pebble Beach, Pebble Beach), hole (18, 14, 19), and hole location (green, tee, clubhouse). The real-time state information includes messaging state, showing messages, playing state, and online status. The messaging state may be used to indicate if the scoreboard is displaying a message. If the scoreboard is currently showing a message, the message may be identified in the showing messages field. An indication of whether the assigned presentation is currently playing may be provided in the playing state field. An indication of whether the scoreboard is online may be provided in the online status field.

The messaging management interface 124 also includes a message creator 307 including a field in which a user may enter a message. In one embodiment, the messaging module may be configured to include a plurality of selectable slide designs for use in messaging operations. The designs may include embedded or selectable graphics, animations, text, or other slide or presentation related features that may be used to create a message. Slide or presentation related features may include style or formatting such as text size, location, font, color, or other features, such as scrolling message, picture in picture, slide overlay, or messaging slide framework. In the illustrated messaging management interface 122, the message creator 307 includes slide design features comprising one or more messaging slide frameworks that may be specified by the user to cause the messaging module to integrate the message in the specified slide framework. The messaging module may be configured to generate a graphical display preview 308 of a created message in the messaging management interface 124 to provide the user a preview of the created message.

The messaging management interface 124 may also include a message presentation indicator 309 configured to receive a setting from a user as to whether a message is to be included in the assigned presentation or override the presentation so only the message is displayed. In the illustrated embodiment, a dropdown menu is provided to set the presentation criteria for the presentation platform to include the message in the presentation or override the presentation with the message.

The messaging management interface 124 may also include a message link 310. The message link 310 may comprise an interactive button that causes display of messages that have been created on scoreboards. In one example, the message link 310 displays messages that have been enabled per scoreboard. In this or a further example, the display may also identify which user enabled which message. A message deletion element 311 may be provided to cause deletion of messages. A scoreboard monitor link 306 may also be available to link users with the scoreboard monitor interface 152 of the scoreboard monitor 150 (see, e.g., FIG. 3) to view real-time displays of the scoreboards, which may be similar to that described above with respect to the event management interface 122 shown in FIG. 4B. As noted above, certain customization features may be provided with respect to the scoreboard monitor 150, such as selection of which scoreboards to view, setting a number of scoreboards to show per monitor page, or which monitor page to view.

With reference again to FIGS. 1 & 3, the weather module 125 may be configured to manage weather messaging operations with respect to scoreboards 200. The weather module 125 may include a weather management interface 126 comprising one or more interfaces configured to interface users with operations of the weather module 125. Users may include, for example, credentialed weather managers. The weather management interface 126 may interface users with event selection to select an event, e.g., tournament, in which to manage weather messaging operations with respect to scoreboards 200 assigned to the event. The weather management interface 126 may identify assigned scoreboards 200 available for management of weather messaging. In some embodiments, information provided with respect to the scoreboards 200 may be similar to that displayed on the event management or messaging management interfaces 122, 124. In one example, the information includes location information for the scoreboards 200, such as course, hole, or hole location. The information may additionally or alternately include real-time online/offline status, identification of an assigned presentation 104, or both.

The weather management interface 126 may include interface components that enable a user to select or create weather messages, which may comprise weather slides. Various configurations of weather slides and slide handling features may be provided. For example, weather slides may be separate slides 106, provided in a picture-in-picture format for display with other presentation slides 106, be provided within a window next to a resized display of other presentation slides 106, overlay a portion of other presentation slides 106, include text, which may be static or scrolling, over other presentation slides 106, or the like. Weather slides may incorporate graphics or other design elements. In some embodiments, one or more weather slides are predefined with appropriate text or fields for incorporation of user defined text. In some configurations, the weather slides available for a particular event may be set, and the available weather slides may be presented for selection in the weather management interface 126. This may be beneficial where different weather slides are used at different events. In one embodiment, the weather management interface 126 may enable users to create or modify weather slides by, for example, modifying or adding text, graphics, or animations. For example, the weather module 125 may include slide generator features for creation of slides or link to the slide generator 130 to enable creation of weather slides or weather messages. In some embodiments, the weather management interface 126 may access or enable access to the slide library 138 for selection of previously generated weather slides for use or editing.

The weather module 125 may be configured to provide presentation control features with respect to weather slides, such as enabling users to enable weather slides 106, e.g., assign weather slides to one or more scoreboards 200, set whether the weather slides are to be included in an assigned scoreboard presentation 104 or override the assigned presentation 104 so only the weather slide appears without other presentation content, set whether weather slides appear on all scoreboards 200 or only specific scoreboards 200, or combination thereof. In some embodiments, the weather management interface 126 may provide display options with respect to a weather slide, such as location, format, size, design, or combination thereof. In one example, the display options for a weather slide may be specified by the user to be the same or different with respect to one or more scoreboards 200. In one embodiment, the weather management interface 126 provides information regarding enabled weather slides. For example, the weather management interface 126 may display weather slides that have been enabled on scoreboards 200. The weather management interface 126 may additionally or alternatively display specific weather slides that have been enabled for each scoreboard 200. In one embodiment, the weather management interface 126 may identify which user enabled which weather slide. In a further embodiment, other information with respect to weather slides or their display may also be included such as the time the weather slide message was created, enabled, or presented on which scoreboard.

The weather module 125 may also include or provide users of the weather module 125 access to the scoreboard monitor 150. For example, users may access a monitoring page via the weather management interface 126, which may be similar or the same to that described above with respect to the event module 121, messaging module 123, or elsewhere in herein, to view what the scoreboards 200 are showing in real-time.

FIG. 4D depicts an example weather management interface 126. The weather management interface 126 is shown with respect to a selected event and includes a scoreboard management window 302 including three scoreboards selected for display of a weather slide. The scoreboards are displayed with corresponding scoreboard information including assigned presentation, course (Spyglass Hill, Pebble Beach, Pebble Beach), hole (18, 14, 19), and location of the scoreboard (green, tee, clubhouse). A weather message state for each scoreboard along with whether the scoreboard is showing a weather message is also provided. The scoreboard information also includes real-time online/offline status information for each scoreboard. The weather management interface 126 includes a weather message selection element 312 including a list of available weather slides 312a, 312b, 312c, 312d. In the illustrated embodiment, previews of slide designs are displayed for quick reference and include message displays including text and graphical elements. A user may select which weather slide 312a, 312b, 312c, 312d to display on the selected scoreboards. A preview dimension field 313 may be available to preview display of the slide according to specified preview display dimensions. As noted above, in some embodiments, the available slides may be set prior to an event or during an event. For example, presentation platform administrators may set, via operation of the administration module, which weather slides appear per event since different weather slides may be used at different events. In some embodiments, weather slides may be available for selection in the slide library, which, as noted above, may include a message library. In one embodiment, the weather module includes or links to the slide generator to enable users to generate slides including weather slides.

The illustrated weather management interface 126 includes a message presentation indicator 309 that enables a user to set whether the selected weather slide is to be included in the assigned scoreboard presentation or is to override the presentation so only the selected weather slide is displayed. In the illustrated embodiment, a dropdown menu is provided for providing the setting. An update weather feature 314 may also be provided that enables a user to update or replace a previously selected or enabled weather slide with another slide. A clear weather feature 315 is also provided that enables the user to remove previously selected or enabled weather slides. A scoreboard monitor link 306 may be provided to the scoreboard monitor interface of the scoreboard monitor via interaction with the link 306 to view one or more monitor pages that provide real-time displays of the scoreboards. In some embodiments, the weather management interface 126 may include a display or provide a link that causes display of weather slides that have been enabled on scoreboards. In one example, the display lists the weather slides that have been enabled as to each scoreboard. In this or another embodiment, the weather management interface 126 may identify the user that enabled each weather slide.

With reference again to FIGS. 1 & 3, The administration module 127 may be configured to perform administration operations with respect to the presentation management unit 120. The administration module 127 may be configured to preform various administration operations such as enabling administrators to view or set permissions for which scoreboards 200 and presentations 104 are accessible or visible via the event module 121.

In some embodiments, the administration module 127 is configured to control which weather slides 106 are available for an event. For example, the presentation platform 100 may include an administration management interface 128 comprising one or more interfaces that interface users, such as credentialed presentation platform 100 administrators with the operations of the administration module 127. Interfacing with the administration management interface 128, users may select available slides, which may include, message slides or weather slides, slide groups, presentations, scoreboards, or events for use by the presentation management unit 120.

As introduced above, the presentation platform 100 may include access control features that control access to various operations of the presentation platform 100. In some embodiments, access to certain operations of the various modules of the presentation management unit 120, application toolbox 170, or combination thereof may be credentialed such that only users assigned to the specified management roles are granted access. For example, the administration module 127 may be configured with access control features whereby administrative users may define which operations the event module 121, messaging module 123, and weather module 125 or users thereof may access. In one example, an administrator using the administration management interface 128 may filter which scoreboards 200 and presentations 104 may be controlled, viewed, or both via management operations of the event module 121. For example, the administration module 127 may be configured to filter which scoreboards 200 and presentations 104 are visible via the event module 121 based on settings defined in the administration module 127 via user interaction with the administration management interface 128. Similar settings may also be defined with respect to the messaging module 123, weather module 125, or both. Similar settings may be defined with respect to the presentation generator 140, slide generator 130, scoreboard monitor 150, or tools of the application toolbox. Thus, in some configurations, the administration module 127 may be used to define allowed presentation operations that may be performed by users of the various components of the presentation platform 100.

The administration module 127 may be configured for creation of slides 106 and scripts 108 that control certain presentation operations. In one example, the administration module 127 is configured to enable users to view slide 106 histories via the administration management interface 128. Slide 106 histories may identify what changes have been made to a slide 106, when changes have been made to a slide 106, which user made changes to a slide 106, or combination thereof. Additional features may include viewing and retrieving deleted slides 106. For instance, a deleted slide history may be provided for user review that enables the user to select a deleted slide 106 to retrieve for later user or for storage in a slide library 138.

As introduced above, the presentation platform 100 may include a slide generator 130. The slide generator 130 may be accessed by one or more of the administration module 127, event module 121, messaging module 123, or weather module 125. In one embodiment, the administration module 127 is configured with access control features to control user access via other modules to the slide generator 130. The slide generator 130 may be configured to build content via creation of slides 106, which may also include creation of scripts 108 that provide presentation control operations such as updating slides 106, slide asset integration, or dynamically controlling slide 106 presentation 104 based on events or ingested data and slide 106 updates. For example, slides 106 may be created or edited using the slide editor 134. Slide scripts may be created or edited using the slide script editor 136. Presentations may be created or edited by interfacing with the presentation generator 140 via the presentation generator interface 142. Trigger scripts may be created or edited using the trigger script editor 149. In one configuration, the presentation generator 140 may also be used to define slide groupings. In various embodiments, slides 106, scripts 108, or both may be integrated into the presentation platform 100 prior to play or on the fly. Slides 106 may be built via the slide generator 130 with any suitable program language to handle the desired content and presentation of such content. Slides 106 may be built to be responsive with markup languages and presentation styling languages, such as HTML and CSS, to provide presentation flexibility, e.g., so only one slide 106 is needed for various scoreboard pixel sizes.

In various embodiments, the slide generator 130 includes a slide menu 132. The slide menu 132 may comprise an interface including selectable slide components for incorporation into a slide. The slide components may include, for example, tables, graphics, animations, fields, such as text fields, embedded video fields, sponsor fields, among others. The slide menu 132 may include selectable formats, styles, or both. Previously used slides 106 may be available for selection. In one configuration, previously used slides 106 may be accessed via the slide library 138 that maintains a repository of previously generated slides 106 or components thereof. In some embodiments, slides 106 may include slide frameworks that may be injected with content for inclusion into a presentation 104 or that may be assigned slide script to automatically customize the slide to an event. For example, slide scripts may be used to automatically customize slides 106 on the fly. When the slide script is executed, for instance, the presentation controller 110 may automatically update the slide 106 to include custom data based on evaluation of presentation data comprising one or more of event information, scoreboard information, or event data. As an example, a sponsor slide 106 may be coded to include a sponsor graphic. The presentation platform 100 may include sponsor designations for events or a slide script may be used to specify a data source query in which sponsor information for an event is otherwise identified. Slide script may utilize the event information specifying the event, e.g., tournament, the slide 106 is being presented to identify event sponsors to customize the slide 106 for the event by injecting a sponsor logo or other sponsor data into the slide 106, which may by stored and obtained locally or via data communication with a data source 30. For example, in some configurations, slide script may be configured to retrieve a sponsor logo for the designated sponsor from a local or remote data source 30. In one configuration, a sponsor designation may include or reference a location of a sponsor graphic for the sponsor to inject into the slide 106. Thus, the slide 106 may comprise a situationally customized sponsor slide 106 that can be used for multiple events wherein slide script is used together with event information to identify an event sponsor and inject the sponsor logo or other data into the slide 106 for use in the presentation 104. In some instances, scoreboard information may additionally or alternatively be similarly used to identify customizing data to customize a slide 106 to the particular scoreboard or event. Using this approach and others described herein, the presentation platform 100 may be configured to provide infinitely customizable presentations 104 and slides 106 for automated real-time control of presentations 104. As noted above and elsewhere herein, the presentation controller 110 may execute the slide script to update the slide 106 and generate markup language, presentation styling language, or similar for delivery and processing by the browser 212 to render the display. In some embodiments, the scoreboard controller 210 may perform all or part of slide scripting operations described above with respect to the presentation controller 110. Additionally or alternatively, slide scripts may be coded with skip functionality. For example, in a sponsor slide use case, a sponsor slide is skipped if the particular sponsor is not an event sponsor identified via scripting using the event information. For instance, database 114 or data model thereof may maintain event information with respect to sponsorship for tournaments that the script pulls for evaluation to determine if the slide should be included in the presentation or skipped.

The slide editor 134 may provide slide editing functionality. For example, the slide editor 134 may interface users with visual editing, text editing or both. Visual editing may include addition of slide components and setting component properties. For example, visual editing features may provide tools for addition or modification of styles, formatting, text, or other visual components such as various assets, e.g., graphical material, animations, video, or the like. Text editing may include addition or modification of text. The slide menu 132 may also interface users with editing functionalities such as importing and exporting of slide code. Import and export features may include import and export of slide script from the script library 160 or a data source 30. In some embodiments, users employ the slide menu 132 to tag slide components to be leveraged by slide scripts. In some embodiments, the slide generator 130 may include a slide history feature that enables users to view history of selected slides 106, such as what changes have been made to visual components, text components, assigned scripts 108, or combination thereof. In some embodiments, the slide history feature also includes an identification of the user making the edits, the date of the edits, or both.

FIG. 4E illustrates an example of a slide editor 134 that incorporates a visual editor 315 and a text editor 316. The slide menu 132 is depicted visually editing a slide 317 comprising a leaderboard slide that includes a table with fields for injection of event data comprising player name, current score, and current position relative to the field. A quick component import feature 318 is provided enabling import of code or other files into the slide 317. As shown, the quick component import feature 318 takes HTML files to inject/replace the slide body in the editors 315, 316 and supports drag and drop import. Visual and text editing features 319 are provided for use to edit the slide 317. The visual editor 315 is depicted as being selected in the illustrated slide editor 134. The visual editor 315 provides tools 319 for movement, removal, creation, and other editing of visual components. Options are provided for specifying resolution to ensure compatibility with desired pixel dimensions. A slide history feature 320 is also provided to view a slide edit history for the slide 317.

With reference again to FIGS. 1 & 3, the presentation platform 100 may employ scripting. Scripts 108 may be written in any suitable scripting language. For example, scripts 108 may be written in Python and run against slides 106. In some configurations, multiple scripts 108 may be used against a single slide 106. For instance, slide scripts and slides 106 may correspond to the same core image or other type of component. Slide scripting may be configured within the presentation 104 and run against data to determine whether a change in presentation of the slide 106 should be made to customize the presentation 104. Slide scripts may generally invoke data source queries for updated data to update content of slide 106 components. Scripts 108 comprising trigger scripts may also be incorporated in presentations and may generally invoke data source queries for evaluation of data with respect to a specified trigger. The data evaluated may correspond to the event. For example, live event data such as scores, player locations, shot tracking, weather, or other event related information may be used to direct presentation 104. Trigger script may be used to drive any state change in the presentation operations of the presentation system 10.

The slide menu 132 may include or access predefined slide scripts that are selectable for running against a slide 106. In some embodiments, the predefined slide scripts are maintained in the script library 160. The slide scripts may include previous used scripts, previously coded scripts, partial scripts, editable scripts, or combination thereof. The slide menu 132 may enable users to assign slide scripts to run against specific slides 106. Additionally or alternatively, the slide menu 132 may enable users to assign slide scripts to run against specific slides 106 on specific scoreboards 200 that the users select. In some embodiments, selecting slide scripts, scoreboards 200, or both may include entering or otherwise identifying the slide scripts, scoreboards 200, or both. In one embodiment, an editable slide script may be selected and the presentation controller 110 may automatically modify the script 108, e.g., import suitable code, for executing the script 108 relative to a particular scoreboard 200. For instance, scoreboard information relevant to the script 108, such as a hole number the scoreboard is located, may be imported into the script 108 when the slide 106 or presentation 104 including the slide 106 is assigned to the scoreboard. In another instance, scoreboard information, presentation information, or both are accessible to the presentation controller 110 via the presentation and scoreboard assignment information defined in the platform. In this or another instance, the presentation controller 110 may execute slide script assigned, e.g., paired, with the slide 106 just prior to presentation of the slide to update or skip the slide 106 as specified by the slide script. For example, a skip slide functionality may be coded in slide script to cause the slide 106, a slide script paired with the slide, or the slide and a paired slide script combination to be skipped or presented at particular times, days, events, or course locations. For example, a skip slide functionality may be used to code, e.g., using Python, when specific slide/script combos appear or not on scoreboards 200.

In various embodiments, a slide 106 or presentation 104 may be coded with particular parameter designation with respect to presentation data, e.g., times, days, scoreboard locations, events, among others, that control when the slide or 106 or presentation 104 is to be displayed. This functionality may be managed by scripting to automate a presentation 104 following assignment to scoreboards 200. For example, slides 106 may be coded to be specific to an event, events, holes, hole locations, or other parameter designation. This designation may be coded or otherwise defined relative to the slide 106. When a presentation 104 including the slide 106 is assigned to a scoreboard, the presentation platform 100 may compare the presentation data, e.g., event and scoreboard information, with the parameter designations of the slide 106 and only include the slide 106 for presentations 104 on scoreboards 200 having matching designations, which may include parameter values. This may be performed during display of the presentation 104 by execution of slide scripts. In this or another example, slide script may be used to control injection of additional or alternate components or content thereof based on parameter designations such as an event, hole, or hole location. For example, when a presentation 104 including the slide 106 is assigned to a scoreboard, the presentation platform 110 may compare the assigned event and scoreboard information with the parameter designations and present the slide 106 according to the slide content associated with the parameter designations corresponding to the event or scoreboard information of the assigned scoreboard. The presentation controller 110 may retrieve slide assets or other associated slide 106 components and generate appropriate code for rending the slide 106 to the browser 212 for display in the presentation 104.

The slide script editor 136 may include script editing tools such as fields to create slide scripts, edit script text, debug script, debug a scoreboard with respect to presentation of the slide, or combination thereof. In some embodiments, the slide script editor 136 includes an import export functionality enabling users to import and export slide script from the script library 160, other applications, or data sources 30.

As introduced above, the presentation platform 100 may be configured with import/export functionalities. For example, the presentation platform 100 may include an import/export tool configured to import and export previously generated data for the operations of the presentation system 10. For example, slides 106, scripts 108, presentations 104, assets, or the like may be imported and exported into, from, or within the presentation platform 100. In one embodiment, all the modules, generators, or combination thereof allow for import/export functionality. In one example, this import/export ability allows for environment promotion in addition to other use cases. In an above or another example, the administration module 127 is configured with an ability to import/export a high-level item and include all dependencies. When using the high-level export, for example, administrative users may exclude assets they choose not to include when importing.

As introduced above, the presentation system 10 may be configured for integration of assets or other presentation data from other applications or systems, e.g., retrieved from data sources 30. For instance, scripting may drive data retrieval from data sources 30 and the data may be ingested and integrated into slides 106. In one example, the integrations comprise ball tracing. In some embodiments, integrations comprise ball traces for embedding or layering onto video or images. For instance, ball tracking data may be integrated into slides 106 and include videos or images incorporating ball tracers that depict flight of the ball. In one example, the ball tracers are mapped to video or images and the presentation controller 110 is configured to embed or layer the ball tracers onto video or images according to the mapping or retrieve the same. Other examples of integrations may also include weather radars. For example, a weather alert slide may include a framework comprising a video frame component wherein scripting is run to call a dynamic weather radar graphic for the event area and integrate the weather radar graphic into the video frame of the slide framework. In one embodiment, the graphic comprises a dynamic graphic and is streamed to the slide 106.

FIG. 4F illustrates an example slide script editor 136 editing a slide script that may be paired with the leaderboard slide described with respect to FIG. 4E to run against the same. The selected slide script is displayed in a scripting window 321 and is editable by the slide script editor 136. The slide script may include a data model query, API call, or other data query to retrieve event data comprising leaderboard data corresponding to an event, which may include the current event or previous events, which is ingested and injected into the slide to update the leaderboard for presentation. The slide script may typically be configured to run prior to presentation of the slide, but in some embodiments may be configured to run during actual presentation of the slide to dynamically update the slide during presentation. The slide script editor 136 includes debug functions for running the script to debug the slide or scoreboard 323. The slide script editor 136 is configured to selectively execute the slide script and display the resulting slide in a preview window 324 as it would be presented on the scoreboard to provide a visual preview of the slide with the executed script, which is also displaying in a debug window 325. The debugging features may enable a user to select different size scoreboard displays, select slides to run the script against, manipulate views, or blend these or other available editing features to generate a preview of what would be displayed on the scoreboard using the selected script with a selected slide.

With reference again to FIGS. 1 & 3, the administration management interface 128 may include a visual scoreboard history feature that provides a visual history of a scoreboard's presentation history. The administration module 127 may be configured to provide various user-controlled handling of the history to assist in review and other management operations. For instance, users may review what has been shown on each scoreboard, filter by scoreboard, filter by time, filter by scoreboard and time, filter by one or more of shown, failed, skipped, paired script, slide name, assigned slide group, assigned slide group type, or others. The visual history feature may additionally or alternatively provide information about one or more of presentation date, time, duration, or other details about the content presented on a selected scoreboard. In various embodiments, the scoreboard controller 210 may transmit one or more of the above presentation metrics to the presentation controller 110 that the administration module 127 uses to generate the visual history.

As introduced above, the presentation system 10 may implement a presentation concept proving a high-level slide 106 grouping wherein the grouping concept provides a presentation framework geared toward automated or minimal user interaction for execution of presentations 104 during or between events. The groupings may include ordered groups, unordered groups, trigger groups, or combination thereof. In one example, the administration module 127 is configured with presentation control operations to enable creation of groups, modification of groups, or combination thereof. Presentation control operations may include addition of slides 106 to a presentation 104, defining a slide order, assigning or editing slide scripts for assigned slides, assigning or editing trigger scripts for the group, or both. For example, in various embodiments, the administration management interface 128 enables users to define operations of presentation platform 100 with respect to a presentation generator 140. In one example, the administration management interface 128 may include features enabling users to direct operations of the presentation generator 140 to, for example, add, remove, or modify one or more of ordered groups, unordered groups, trigger groups, messaging groups, weather groups, or offline content. The administration management interface 128 may be configured to enable users to set presentation access, such as access to view presentations 104, access to add or modify presentations 104, or combination thereof. The presentation control operations may additionally or alternatively include setting whether unordered groups can interrupt ordered groups in a presentation 104. In some embodiments, the presentation control operations include slide specific operations such as setting duration of each slide 106. For example, slide duration may be set for a specific period of time, to match a duration of an asset (e.g., embedded video), or otherwise. The presentation control operations may additionally or alternatively include setting parameters of data source access, data handling, or both. For example, the presentation platform 100 may be configured to communicate with one or more data sources 30 to obtain data used by the presentation platform 100 for presentation control such as slide updating, asset integration into slides, slide or presentation enable or disable, or combination thereof. For example, users using the administration management interface 128 may interface with the administration module 127 to cause the presentation platform 100 to one or more of set, enable/disable, or modify APIs or API endpoints, query data sources 30, set polling intervals, establish API subscriptions (which may include WebSockets), perform event listening operations, enable/disable queries, among others. Data sources 30 may include live event tracking resources such as shot tracking or player location tracking. Data sources 30 may include databases, which may include any data environment such as object storage system, storage pool, flat data environments, cloud storage, among others. In one example, a data source 30 includes a data bucket into which video captured of the event is stored and available for integration into to slides 106. Data sources 30 may include weather forecast resources, event management resources, data repositories including graphics, animations, videos, or other information or assets that the presentation platform 100 may use as or to derive slide content or to directly or indirectly control aspects of a presentation 104. Consistent with the above, communication units 102, 202 may be configured to communicate with data sources 30, which may include querying databases, API calls, listening operations, or the like. Communications may be under control of scripts 108, e.g., scripts 108 may cause initialization of database queries, creation of API subscriptions, API calls, or the like. Communications may include listening to data feeds provided by data sources 30. Using the administration management interface 128, which may include or access a presentation generator 140, users may set data source queries, which may include API queries, enable or disable queries, set API endpoints, or other operations. Data sources 30 may comprise a database maintained by a data storage device 114, 214, which may include a storage service. The data storage device 114, 214 may include one or more databases that store data retrieved from other data sources 30 by the presentation controller 110, which may be driven by querying or listening operations at the direction of scripts 108 as described herein. For example, the data storage device 114 may maintain a data model including presentation data such as event data, scoreboard information, event information, or combination thereof. The presentation controller 110 or other processing unit of the presentation platform 100 or presentation system 10 may be configured to maintain the data model according to defined structures, relationships, or business rules of the data model. The data model may include various types of event data with respect to one or more events, such as scoring data for a current event, which may include shot data, player groupings. In one embodiment, the data storage device 114 may store presentation platform data with respect to presentation data such as event information, scoreboard information, slides 106, scripts 108, slide groupings, presentations 104, or other data used by the presentation platform 100 to perform its operations described herein.

The presentation platform 100 may employ scripting configured to automate aspects of presentations 104, which may include automating a presentation 104 in a real-time event environment, application of a presentation 104 to multiple events wherein the presentation 104 uses data associated with the event to cause customization of the presentation 104 to the event, or both. Scripts 108 may be used to trigger a change in a presentation 104, which may include a slide content update or injection of presentation data. For example, slide scripts may be used to dynamically update slides 106. Additionally or alternatively, trigger scripts may run behind a presentation 104 and drive ingestion and evaluation of event data from one or more data sources 30 to direct aspects of presentations 104 as defined by the trigger scripts. Scripts 108 may be configured to invoke API queries, e.g., calls or other data request or listening. Scripts 108 may include listeners, monitors, or otherwise monitor a data source 30 for presence of triggers. For example, a script may invoke an API call, listen to a WebSocket feed. Scripts 108 may invoke a data source query for presentation data used to update slide content 106 or trigger presentation 104 of a trigger group. Slide scripts may invoke data source queries and evaluation of the returned data may trigger a change to slide content, e.g., update a dynamic component in the slide 106, such as scores, leaders, locations of players, sponsor data, or other content. Script may be configured to invoke query a data source 30, which may include the data model, for video wherein if the video is available, the video may be integrated into a video frame of a slide 106 or trigger a change to another slide 106 in which the video is integrated. Additional changes to presentations 104 driven by scripts 108 may include changes from one slide 106 in in presentation 104 to another slide 106, ingestion of score data from one or more shot tracking data sources, interruption of a presentation 104 with messaging, which may include messaging slides 106 provided by the messaging module 123 or weather module 125, injection of ordered slides or group into a presentation 104, injecting of unordered slide or group into a presentation 104, or other presentation operations described herein.

The presentation controller 110 may execute a presentation algorithm to execute the presentation within the parameters of the presentation specified by the presentation control data, e.g., presentation settings, associated with the presentation. The presentation control data may include, for example, settings with respect to slide duration, slide frequency, slide groupings, interrupt settings, and the like. For example, the presentation platform 100 may include group packaging options to enable a user to set whether ordered slides may be interrupted by unordered slides or groups. For instance, if consistent with group settings, the presentation controller 110 may inject an unordered slide between ordered groups or between slides of an ordered group. In some embodiments, the algorithm evaluates event data along with presentation control data to determine slide injection or other presentation scheduling operations. In one example, if data ingested from a data source 30 maintaining live player tracking data indicates players are walking to their balls on the hole the scoreboard is located, the presentation algorithm may trigger injection of an unordered slide within an ordered group that runs with respect to a player group as the players approach the tee box through hole completion. In a further example, script or the presentation algorithm may cause data to be ingested from a data source 30 that maintains live shot data, which may be the same or different than the data source 30 that maintains the live player tracking data, and evaluate shot location relative to the player location to determine if a unordered slide 106 should be injected. For example, script or the presentation algorithm may be coded with a player location and distance calculation for an expected time period before a player will be ready for a next shot. This calculation may be used to determine if or which unordered slide 106 is injected, e.g., an unordered slide 106 may have a set duration associated with it, consistent with the presentation control data set for the presentation 104. In a further or another example, script or the presentation algorithm may cause data to be ingested, e.g., listening or querying operation with respect to a data source 30 maintaining live player tracking data for indication that a player in the group is ready to hit their ball, e.g., player_A_overball, on the hole. This may trigger a return to the ordered group. In some embodiments, the presentation algorithm utilizes artificial intelligence/machine learning with respect to injection operations to optimize compliance with presentation control data while also providing timely slide presentation with respect to the event as well as variety to enhance the viewing experience.

As introduced above, the presentation generator 140 may include a presentation generator interface 142 configured to interface users with the operations of the presentation generator 140. In one embodiment, one or more operations of the presentation generator 140 may be under control of the administration module 127. For example, the administration module 127 may set permissions for access to the operations of the presentation generator 140 or presentation generator interface 142. In this or another example, the administration module 127 comprises or accesses the presentation generator 140, or the administration management interface 128 comprises or accesses the presentation generator interface 142. Using the presentation generator interface 142, users may define one or more presentations 104. For example, the presentation generator 140 may access the slide generator 130 to select or edit slides or slide scripts. Users may access the presentation generator 140 to select or edit presentations or trigger scripts, or select or edit slide groups to create a presentation 104. The presentation generator 140 may also include or access a presentation library 141 comprising two more predefined slide presentation groupings for selection and assignment to scoreboards 200. The presentation generator interface 142 may additionally or alternatively be configured to enable users to edit a presentation 104 to include additional slides 106, remove slides 106, modify slides 106, or select, import, or edit trigger scripts, or otherwise define or modify a presentation 104.

In various embodiments, the presentation generator 140 is configured to enable users define or modify data source settings, such as setting a path to a data source 30 used in scripting operations or other presentation platform operations, which may include retrieval of data used by the presentation algorithm to determine slide order or slide injection. Data sources 30 may maintain file data such as images, video, or other files. In one example, data sources 30 comprises an S3 bucket. In addition to setting a path, the presentation generator 140 may be configured to enable creation or modification of other data source settings used to control aspects of presentation operations with respect to data sources 30, such as setting queries, enabling or disabling queries, setting API endpoints, establishing API subscriptions (e.g., WebSocket subscriptions), defining queries such as whether subfolders are to be searched, setting polling intervals, or other operations. In one embodiment, the presentation platform 100 is configured to enable administration users, via the administration module 127, to set polling intervals and enable or disable data source queries using an API without using the presentation platform 100 graphical user interface. For example, the presentation platform 100 may include or provide access to an API that enables use via the administration module 127, or administration management interface 128 thereof, to selectively enable or disable queries. Data source queries may include WebSocket subscriptions in which data is pushed to the presentation platform 100 through an open connection that effectively acts as zero interval polling. Scripts 108 may include event listeners to listen to events from a subscribed connection. WebSockets or similar may be selectively enabled or disabled. For example, the presentation generator interface 142 may include or provide access to an API to enable or disable each WebSocket. Additionally or alternatively, one or more data handler scripts 108 may be assigned to one or more WebSockets or other data sources 30 to transform data to a desired formatting.

In various embodiments, slide groups may be defined with respect to a presentation via interaction with operations of the presentation generator 140. One or more predefined slide groups may be available for selective inclusion in a presentation 104 from a presentation library 141. In some instances, the slide groups may be available for further user editing of the group packaging to customize the same for use with a particular presentation 104 or presentations 104. As introduced above, slide groups may be packaged in one or more ordered groups, unordered groups, trigger groups, messaging groups, weather groups, or offline groups. With respect to trigger groups, the presentation generator interface 142 may enable users to select which data source 30, e.g., API/WebSocket/database query, to listen to for determining a trigger event. Additionally or alternatively, the presentation generator interface 142 may be configured to enable users to set if an unordered group or particular slide 106 of an unordered group can interrupt a particular or multiple trigger groups. The presentation generator interface 142 may include options that a user may employ to set trigger group runtime, such as if triggered content is to run continuously or if the presentation 104 is to exit back to the pre-trigger presentation 104 once the triggered content completes. In one embodiment, the presentation generator interface 142 includes options for setting if other triggers can interrupt a trigger group.

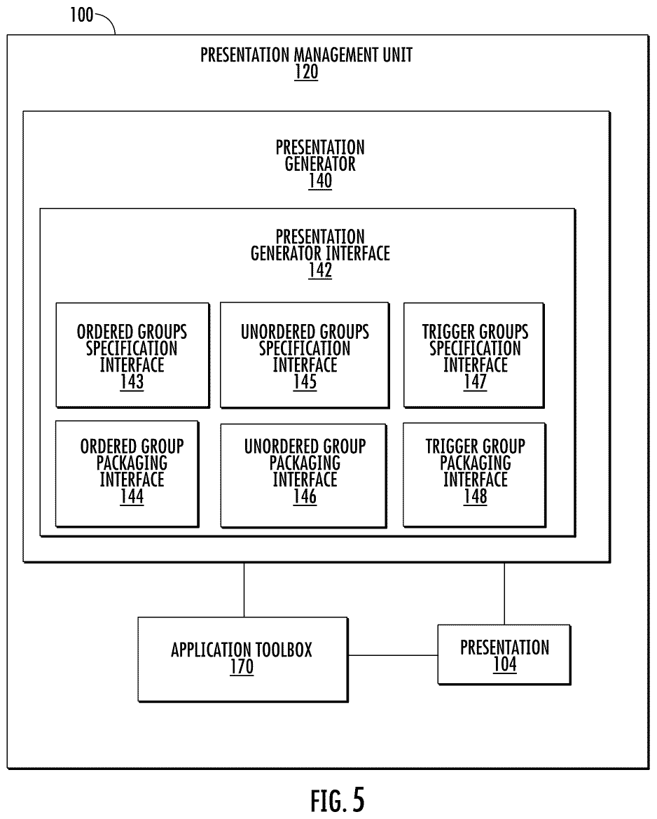

With further reference to FIG. 5, the presentation generator 140 may be configured to enable a user to define a presentation 104. Defining a presentation may also include defining related presentation control data. Presentation control data may include slide durations, slide frequencies, interrupt settings, or other data used to control presentations. In some embodiments, presentation control data includes data source settings, such as those identified above and elsewhere herein.

Further to the above, the presentation generator interface 142 may include an ordered groups specification interface 143 for specification of ordered groups to be included in a presentation 104. An ordered group packaging interface 144 may be provided for defining slides 106 to be included in an ordered group. For example, the ordered group packaging interface 144 may enable users to select a collection of paired slides 106 and scripts 108 to group in an ordered group. The ordered group packaging interface 144 may also be configured for setting slide 106 duration, such as by unit of time or asset duration. For example, if the slide 106 comprises a short video or animation, a user can set the duration to match the asset's duration or override it. Script assignments may also be provided to assign scripts 108 to each slide 106. In some embodiments, links may be provided to the slide generator 130 to access operations of the slide editor 134, slide script editor 136, slide library 138, or script library 160 to select or edit slides or slide scripts with respect to slides. The ordered group packaging interface 144 may include setting options to set whether an unordered group may interrupt the ordered group.

The presentation generator interface 142 may include an unordered groups specification interface 145 for specification of unordered groups to be included in a presentation 104. An unordered group packaging interface 146 may be provided for defining slides 106 to be included in an unordered group. For example, the unordered group packaging interface 146 may enable users to select a collection of paired slides 106 and scripts 108 to group in an unordered group. The unordered group packaging interface 146 may also be configured for setting slide 106 duration, such as by unit of time or asset duration. For example, if the slide 106 is just a short video or animation, the user can set the duration to match the asset's duration or override it. Frequency settings may be included to receive a frequency designation for each slide 106. The frequency designation may include a number of times the slide 106 is to be presented within a specified time period. In some embodiments, other frequency designations may be used, such as relative to presentation frequency of another slide 106 or based on the occurrence of an event, e.g., informed by evaluation of event data obtained from data sources 30. Slide script assignments may also be provided to pair slide scripts to slides 106. In some embodiments, links may be provided to the slide generator 130 to access operations of the slide editor 134, slide script editor 136, slide library 138, or script library 160 to select or edit slides or slide scripts with respect to slides.

The presentation generator interface 142 may include a trigger groups specification interface 147 for specification of trigger groups to be included in a presentation 104. For example, trigger groups may employ trigger scripting, such as Python scripting, to trigger display of specific content at a specific time based on evaluating scoring or other event data obtained from data sources 30 in real-time. Trigger group content may be organized as an ordered group and behave like an ordered group once triggered. A trigger group packaging interface 148 may be provided for defining slides 106 to be included in a trigger group. The trigger group packaging interface 148 may include data source setting options with respect APIs, WebSockets, bucket queries, or combination thereof for each trigger group to listen to when determining whether to trigger or not. The trigger group packaging interface 148 may also be configured for defining various presentation control data settings such as slide duration, e.g., by unit of time or asset duration. Slide script assignments may also be provided to assign slide scripts to each slide 106. In some embodiments, links may be provided to the slide generator 130 to access operations of the slide editor 134, slide script editor 136, slide library 138, or script library 160 to select or edit slides, slide scripts, or trigger scripts. In one configuration, the trigger group packaging interface 148 is configured for trigger script editing. For example, the trigger group packaging interface 148 may link to the trigger script editor 149. Various embodiments may link to the script library 160 for selection of trigger scripts to use or edit for use. Group presentation control data options may be provided to set if the trigger group may be interrupted by an unordered group, if the trigger group is to continue running after the slides 106 have been presented or exit back to the presentation content prior to the trigger, if the trigger script may be cut short, or if the trigger group may be interrupted by another trigger group. A display of the trigger script may be included. Scoreboard debugging, script debugging, or both may also be provided.

In various embodiments, the presentation generator interface 142 may include an offline specification interface for specification of offline content. Offline content may be presented when the scoreboard is offline, e.g., when the scoreboard is on, but is not running the presentation 104. Offline content may be presented during times the scoreboard is running the presentation 104 but is not running the grouped content. Offline content may include tournament logos, leaderboards, testing content, weather loops, messages, sponsors, or any other slide content. The offline content may include groups such as unordered or ordered groups or particular slides 106. The offline specification interface may include links to ordered group or unordered group packaging interfaces 144, 146 to define groups that may be selected for offline presentation 104. The presentation generator interface 142 may also include specification and editing links for a messaging group, a weather group or both. In some embodiments, links may be provided to the slide generator 130 to access operations of the slide editor 134, slide script editor 136, slide library 138, or script library 160 to select or edit slides or slide scripts.

FIG. 4G illustrates an example presentation generator interface 142. The presentation generator interface 142 may be configured to enable a user to define a presentation by specifying slide groups to be included in the presentation. A name field 326 is available to name the presentation, which has been given the name “Main Presentation” in the illustrated instance. The presentation name may be used throughout the presentation platform to reference or integrate the defined presentation into the operations of the presentation platform. The presentation generator interface 142 may include specification interfaces for specifying groups such as one or more of ordered, unordered, trigger, message, weather, or offline groups. In the illustrated presentation generator interface 142 an ordered groups specification interface 143 including a summary field 327 of chosen ordered groups is shown that enables a user to select groups to edit or delete. The ordered groups may be selected from available ordered groups using an ordered group selection tool (not shown) or otherwise defined by a user using an ordered group packaging interface 144. The ordered groups selection tool may be similar to that shown and described with respect to the unordered group selection tool 328 of the unordered groups specification interface 145. The ordered groups in the selection tool may include groups assigned to be available for the event, e.g., by the administration module, or those in the presentation library.

The unordered groups specification interface 145 includes an unordered group selection tool 328 operable to select unordered groups from available ordered groups. A search function to filter available unordered groups is also provided. Options to further modify the slides included in the unordered groups may also be provided. The unordered group selection tool 328 includes an add unordered group element 329 to enable a user to select unordered groups to include in the presentation from available unordered groups. Links may also be provided to the unordered group packaging interface 146 to enable a user to edit the slides in each selected unordered group. For example, the unordered group packaging interface 146 comprises various unordered group specification tools operable to define an unordered group. The unordered group packaging interface 146 may be used to initially define an unordered group or to further edit a previously defined unordered group. The unordered groups in the selection tool 328 may include those assigned to be available for the event, e.g., by the administration module, or those in the presentation library.

A trigger groups specification interface 147 is available for specifying trigger groups to be included in the presentation 104 and includes a trigger groups specification tool 330. The trigger groups selection tool 330 includes an add trigger group element 331 to enable a user to select trigger groups to include in the presentation 104 from available trigger groups from a list of available trigger groups. A search function to sort available trigger groups may also be provided. Options to further modify the slides 106 included in the trigger groups may also be provided. For example, a trigger group packaging interface 148 may be used to define the slides 106 to be included in a trigger group or to further modify the trigger group. The trigger groups included in the selection tool 330 may include those assigned to be available for the event, e.g., by the administration module, or those in the presentation library.

The presentation generator interface 142 may include an offline content specification interface 334 including an offline content specification tool 335, which may be similar to that described above with respect to the ungrouped or grouped selection tools. The offline content specification tool 335 includes an add offline content element 336 to select offline content to add from a list of available offline content. A search function for available offline content is also provided to filter offline content as desired. Options to further modify the offline content slides may also be provided. For example, the offline content may be edited by the slide generator and related features as described herein. In some embodiments, unordered groups or ordered groups may be selected as offline content, e.g., by including the group name in the offline content specification. The offline content in the selection tool 335 may include those assigned to be available for the event, e.g., by the administration module, or those in the presentation or slide library. The presentation generator interface 142 may include a messaging groups specification interface 338 comprising a messaging group selection tool 339 for selecting one or more messaging groups to include in the presentation. The presentation generator interface 142 may include a weather groups specification interface 340 including a weather groups selection tool 341 for selecting one or more messaging groups to include in the presentation. Editing links for messaging groups or weather groups may be provided. The links may access creation or editing features of messaging or weather messages or groups may be provided. The links may take the user to the messaging management interface 122 (see, e.g., FIG. 4C), weather management interface 126 (see, e.g., FIG. 4D), or the slide generator 130 (see, e.g., FIG. 4E, FIG. 4F), for example, to enable the user to create or edit the slides, which may include associated slide scripts. Options to delete the groups from the presentation may also be provided. A history button 320 is provided to view a history of changes with respect to the respect to the presentation, which may include supplemental information with respect to the date and identity of the users responsible for previous changes. An option is provided to publish the presentation to the event module. Options to delete the presentation are also provided. Once the user has defined the presentation, the presentation may be saved for subsequent use by the presentation platform. Options may also be provided to save the presentation or groups as new or to save and continue editing.

An example ordered group packaging interface 144 is shown in FIG. 4H. A name field 326 is provided to name the ordered group. The name may be used throughout the presentation platform to reference or integrate the ordered group in subsequent operations. A group member editor 344 is provided for adding slides to the ordered group. Any number of slides may be selected for inclusion. The group member editor 344 includes shortcuts to select a previously defined slide from a dropdown. A link 345 to the slide editor 134 (see, e.g., FIG. 4E) to edit a selected slide is also provided. A duration setting 346 is provided to set the duration of the slide. Duration may be set in units of time, such as seconds. Duration settings may also be set to an asset duration such as a video or animation that runs in the slide using asset duration setting 347. A script assignment setting 348 may also be provided for setting a slide script pairing for the slide. A link 349 is provided to the slide script editor 136 (see, e.g., FIG. 4F) to enable the user to edit the slide script. In some embodiments, the user may select additional slide scripts to run against the slide. A history button 320 is available to view a history of changes to the ordered group, which may include supplemental information with respect to the date and identity of the users responsible for previous changes. An interrupt setting option 350 is also provided for the user to indicate if an unordered group is allowed to interrupt the ordered group, which has been indicated to be allowed in the illustrated interface 144. Options to delete slides 106 or the entire ordered group are also provided. Once the user has defined the group, the ordered group may be saved for future use as an available ordered group in other groups specifications. Options may also be provided to save as new or to save and continue editing. With reference again to FIG. 4G, the user may enter, edit, or delete the ordered groups as desired using the tools provided in the group summary field 327. While interface elements such as dropdowns, check boxes, and links are provided in the illustrated embodiment other interface elements may be used.

FIG. 4I depicts an example unordered group packaging interface 146. A name field 326 may be provided to name the unordered group. The name may then be used throughout the presentation platform to reference or integrate the unordered group in subsequent presentation operations. A group member editor 344 includes shortcuts to select a previously defined slide from a dropdown. Any number of slides may be selected for inclusion into the unordered group. A link 345 to the slide 106 editor 134 (see, e.g., FIG. 4E) to edit a selected slide is also provided. A duration setting 346 is provided to set the duration of the display of the slide. Duration may be set in units of time, such as seconds, or an asset duration setting 347 may be used to set duration of a slide to correspond to duration of an asset, such as a video or animation, that runs in the slide. Selectable frequency settings 351 may be included to specify a frequency designation for each slide. The frequency designation may include a number of times the slide is to be presented within a specified time period, which may also be selectable. A slide script may also be provided for the slide using script assignment setting 348 may also be provided for setting a slide script pairing for the slide. A link 349 is provided to the slide script editor 136 (see, e.g., FIG. 4F) to enable the user to edit the script. In some embodiments, the user may select additional slide scripts to run against the slide. A history button 320 is available to view a history of changes to the unordered group, which may include supplemental information with respect to the date and identity of the users responsible for previous changes. Options to delete slides or the entire unordered group are also provided. Once the user has defined the group, the unordered group may be saved for future use as an available unordered group in other groups specifications. Options may also be provided to save as new or to save and continue editing. With reference again to FIG. 4G, the user may delete or add additional unordered groups using the unordered group selection tool 328.

FIG. 4J depicts an example trigger group packaging interface 147. A name field 326 may be provided to name the trigger group. The name, e.g., PlayOverBall, may then be used throughout the presentation platform to reference or integrate the trigger group in subsequent operations. The trigger group operates as an ordered group trigged by the trigger script. A group member editor 344 is provided for adding slides to the ordered group. Any number of slides may be selected for inclusion. The group member editor 344 includes shortcuts to select a previously defined slide from a dropdown. A link 345 to the slide editor 134 (see, e.g., FIG. 4E) to edit a selected slide is also provided. A duration setting 346 is provided to set the duration of the slide. Duration may be set in units of time, such as seconds. Duration settings may also be set to an asset duration such as a video or animation that runs in the slide 106 using asset duration setting 347. A script assignment setting 348 may also be provided for setting a slide script pairing for the slide. A link 349 is provided to the slide script editor 136 (see, e.g., FIG. 4F) to enable the user to edit the slide script. In some embodiments, the user may select additional slide scripts to run against the slide. An interrupt setting 350 is provided for the user to indicate if an unordered group is allowed to interrupt the trigger group. A run/exit setting is also provided to set if the trigger group once triggered runs forever or if the group exit back to the presentation once completed. A trigger interrupt setting 354 is also provided to specify if the trigger group may be interrupted by other trigger groups. Another trigger interrupt setting 355 is provided to specify if other trigger groups may replace the trigger group during its execution. If disabled, the trigger group is forced to play all the way through and another trigger group will not be able to replace it. Options to execute a debug scoreboard function 356 with respect to the trigger script may also be included. A scoreboard preview 358 is provided to view the executed script with respect to the scoreboard debug function 356. The trigger group packaging interface 148 may also include a visual display of the trigger script 357. A history button 320 is available to view a history of changes to the trigger group, which may include supplemental information with respect to the date and identity of the users responsible for previous changes. Options to delete slides or the entire trigger group are also provided. Once the user has defined the group, the trigger group may be saved for future use as an available trigger group in other groups specifications. Options may also be provided to save as new or to save and continue editing. With reference again to FIG. 4G, the user may delete or add additional trigger groups using the trigger group selection tool 330. In one example, trigger script with respect to a trigger group evaluates API data relative to the trigger specified in the trigger script. If the evaluation returns true, then the trigger group is executed. In various embodiments, trigger scripts may be used for any state change in the presentation platform. For example, if trigger script for a final score slide evaluates event data and returns true for last player holed out or otherwise play concluded, the final score slide is triggered for presentation. The final score slide may also include slide script for dynamically updating final scores presented in the slide.

In various embodiments, trigger scripts are evaluated continuously in the background by the presentation controller 110 according to a defined lifecycle that avoids duplicate firings and race conditions. For example, each trigger instance may progress through states including IDLE, PENDING, FIRED, and COMPLETE, with state transitions driven by evaluation of presentation data obtained from data sources 30 (e.g., APIs, WebSockets, or bucket queries). To ensure idempotency, each trigger evaluation may be associated with a de-duplication key (for example, a composite of event identifier, group identifier, and timestamp or sequence number from the data source or otherwise), and the presentation controller 110 may be configured to ignore or de-duplicate any trigger event that reuses a recent de-duplication key inside a configurable minimum re-fire interval. When multiple triggers are eligible concurrently, the presentation controller 110 may apply group rules. Resolution of collisions may use, for instance, group priority, earliest eligible timestamp, and then lexical group identifier. In one example, if a trigger group is marked run-to-completion, subsequent triggers targeting the same scoreboard 200 may be queued until the group completes. Otherwise, the presentation controller 110 may be configured to preempt according to the group's interrupt/replacement settings.

With reference again to FIGS. 1, 3, & 5, the presentation platform 100 may be configured to integrate video into presentations 104. Video integration may be driven by scripts 108. Video integration may include pre-recorded video, such as highlights, montages, advertisements, or other video productions or recorded video feeds. In some embodiments, video integration may comprise live video integration. In one configuration, the presentation platform 100 may be configured to capture or receive live video, such as live video feed, for use presentation 104. The live video may be of the event, another event, or otherwise for presentation 104. In one configuration, the presentation platform 100 may be configured to ingest one or more live video feeds from one or more video sources, such as a cloud source or another system or application, which may be local or remote to the event, presentation platform 100, or both. In one example, the presentation platform 100 may be configured to receive or access a plurality of live video feeds of the event from a video source. A slide 106 may comprise or consist of an integrated live video feed. In some embodiments, live video data may be specified for inclusion via scripts 108. For example, slide script may include a data source query for available video data for injection into the slide 106. If the video is available, the video is integrated into the slide 106 and presented. If the video is not available, the slide script may specify that the slide 106 is skipped or alternative presentation data may be injected into the slide 106 rather than video. In one embodiment, the presentation platform 100 may be configured to trigger integration of replays of live content from other systems. In one example, a trigger script comprises a bucket query for video. If the video is available, the script triggers presentation 104 of the slide 106 or a trigger group including the slide 106. The script may also drive integration of the video into the slide 106 presentation 104. In another example, the trigger script listens to WebSocket for indication of a group entering a tee box. This may trigger a trigger group wherein the slide 106 includes graphics identifying the players and current scores or leaderboard position. A slide script associated with the first slide 106 may be invoked to query a data source 30 that maintains live shot tracking data with respect to the event to dynamically update the slide 106 with received event data. A script may be run against the slide 106 that listens for an indication of player standing over ball with respect to a player in the group on the hole. This may invoke a bucket query for a live video feed of the player setting up and hitting the ball for integration into the presentation 104. The presentation platform 100 may then integrate the video into the slide 106 or causes injection of a next slide 106 in which the video is integrated, or otherwise integrate the video into the presentation 104. In one example, the live video is streamed to the browser from the presentation platform 110 or a data source 30 for presentation within a video frame component of the slide 106. In one embodiment, the video frame component comprises an embedded content frame, such as an inline frame (e.g., an iframe in HTML), configured to display streaming video content within the slide

FIG. 4K illustrates an example administration management interface 128 configured to enable users to define data source settings, such as those with respect to queries related to scripting with respect to trigger groups, slide scripts, building the data model, or combination thereof. For example, the presentation platform 100 or presentation system 10 may configured with data source settings for querying of data sources 30. The queries may result in retrieval of data for incorporation into the data model for use in scripting or other presentation operations. For example, slide scripts may invoke the bucket query or query the data model for particular data stored in the data model that was obtained via the bucket query. In this or another example, trigger scripts may listen to the bucket query for trigger determinations. In the illustrated example, a bucket query setting to a live tracking system, e.g., ShotLink®, data source is shown that may be invoked for availability of player video, which may be used for integration of the video in slides, triggering trigger groups, or for other presentation operations. A path field 360 is provided to designate a file, file location, or other data identifier with respect to the endpoint from which a query is made. In the illustrated interface, a bucket query is shown to query objects stored in an object storage environment. Other queries may also be used such as container queries, media queries, or other queries with respect to data storage environments. A path to a bucket, such as an S3 bucket, which contains files may be set. These files may be images, videos, or any other file type. A polling interval 361 for how often to check the bucket may also be set. Other search parameters 362 such as whether to search subfolders may also be set. A setting 363 for enabling bucket queries for particular scoreboards 200, events, holes, or hole locations is also available. In some embodiments, state control scripts may be employed to enable and disable API calls when not needed, e.g., based on event information, scoreboard information, or other information specified by scripts, to automate presentations by preprogramming presentation criteria based on data that may be obtained and evaluated by scripting. Thus, an API may be provided to enable or disable each bucket query, polling interval, or both without having to use administration management interface 128 or other presentation platform interface to customize the presentation for each event. Options to delete, save, save as new, or save and continue editing the query are included. A history button 320 is provided to view a history of changes to query, which may include supplemental information with respect to the date and identity of the users responsible for previous changes. The data source settings comprising the query may be saved in the presentation platform under the specified name 326 given to the query and may be imported for use in scripts.

FIG. 4L illustrates an example administration management interface 128 configured to enable users to define data source settings such as setting API endpoints for use in scripting operations. For example, slide scripts may invoke the API or query the data model for particular data stored in the data model that was obtained via the API. In this or another example, trigger scripts may listen to the API for trigger determinations. The administration management interface 128 includes a listing of scripts 348 and associated API endpoints 365. Multiple APIs may be set using the interface 128, such as real-time score tracking, shot tracking, or player tracking API. A polling interval settings 361 for how often to check the API may also be set. A setting 363 is provided to enable endpoints. In some embodiments, state control scripts may also be used as described above such that an API may be used to enable or disable each bucket query, polling interval, or both without having to use administration management interface 128 or other presentation platform interface to customize the presentation for each event. The type of API 366 and path 367 may also be provided and editable. As shown, the API types are “get”. An interface element 368 is provided to select endpoints to change to allow multiple endpoints to be changed together. Interface elements are also provided to add API endpoints 369 and import API endpoints 370, e.g., from a script library 160 (see FIG. 3), endpoint library, slide library, previous presentations, data sheets, other applications, systems, or other source.

FIG. 4M illustrates an example administration management interface 128 configured to enable users to define data source settings comprising subscription to a data feed push, a WebSockets in the illustrated example, for use in scripting operations. Similar to the API and bucket query settings, slide scripts may query the data model for particular data stored in the data model that was obtained via the WebSocket or other data feed push. In this or another example, trigger scripts may listen to the data feed for trigger determinations. The WebSocket subscription may be given a name 326 to identify the subscription and is saved in the presentation platform under the name and may be imported for use in scripting operations. An endpoint field 365 is provided to specify the end point. A path field 367 to identify and edit the path is also provided. Options to delete, save, save as new, or save and continue editing the query are included. A history button 320 is provided to view a history of changes to query, which may include supplemental information with respect to the date and identity of the users responsible for previous changes. An enable setting 363 is provided to enable the endpoint. A data handler script setting 371 is provided to enable assignment of a data handler script to the data output. For example, a data handler script may be assigned to the WebSocket to transform data received to a different format used by the presentation platform. Links to data handler script selection or editing features may also be provided. Options to delete, save, save as new, or save and continue editing the WebSocket subscription are included. A history button is provided to view a history of changes, which may include supplemental information with respect to the date and identity of the users responsible for previous changes. The subscription may be saved in the presentation platform under the name given and may be imported for use in scripts.

WebSockets may be utilized to avoid API limitations related to rapid polling frequencies. The open connection provided by WebSockets effectively establishes a zero second polling interval with an API. WebSockets or similar may be used to have data pushed to the presentation platform from data sources as soon as the data is changed or available in data source, such as a system configured for real-time score tracking, shot tracking, player tracking, or combination thereof. An example of such a data source for receiving live player group locations is operated by PGA TOUR® and is feed by the ShotLink® system. In the illustrated example, the endpoint comprises a WebSocket subscription to group locations presentation platform subscribes to locations of groups to obtain real-time location of groups from a real-time player tracking system. This information may be used for trigger operations, such as no player on hole, group on green, group in tee box, player approaching ball in fairway, as examples.

As introduced above, data handler scripts may be used to transform data. Data handler scripts may be assigned to data sources to handle the incoming data for use in the presentation platform, which may include integration into the data model. For example, data handler scripts may be used to transform incoming data, trigger retrieval of additional data from the same or different data source based on the incoming data, validate incoming data, import or export scripts based on the incoming data, among others. In one configuration, data handler scripts may be used to modify data source settings for one or more data sources, e.g., automatically create or modify an end point, subscription, polling interval, or other data source setting. FIG. 4N illustrates an example administration management interface 128 for defining a data handler script for use by the presentation platform. Data handler scripts may be given a name 326. The data handler scripts may be created, imported, or otherwise called within the platform by name. The data handler scripts may be utilized to transform data received to different formatting as needed. One or more debugging features such as with respect to user specified API endpoint, WebSocket subscription, or both may be provided. As shown, options are provided for debugging the API endpoint 372, debugging a WebSocket subscription 373, debugging a spreadsheet endpoint 374, and debugging a tournament 375. The debugging function may provide representations of latest incoming data 376 and example output source data 377. A visual display of the data handler script may also be provided 378. In various embodiments, to promote compatibility as external feeds evolve, data handler scripts may write versioned records to the data model and include a simple compatibility shim for readers. For example, a handler may transform an incoming payload that identifies group location states into a normalized PlayerStateUpdate record with fields including event_id, group_id, hole_no, state (such as IN_TEEBOX, APPROACH, OVER_BALL, or COMPLETE), t_observed, as examples, and tag it with a schema_version field. Slide and trigger scripts may be configured to be version-aware and map schema differences at read time so feeds remain compatible across updates.

In various embodiments, slide script may be configured to call or otherwise access event information (e.g., tournament name, round, scoreboard location, identification of tournament sponsors) for evaluation to make presentation determinations regarding slide content or whether a slide is presented or skipped. Live event data (e.g., player locations, scores, shot data, or the like) may also be used for these purposes. In this or a further embodiment, slide script may be executed to obtain slide content, such as live event data, live video, non-live data such as replays, preproduced videos, sponsor or tournament logos, player bios, player headshots, or other information not statically packaged with a slide. Slide content obtained from the operation of the slide script may be referenced in the HTML and may also be transmitted to the scoreboard controller or browser as a slide resource or asset. Such content acquisition operations may include a query invoked by slide script to a local or remote data source, which may include making API calls or bucket queries. Additionally or alternatively, content acquisition driven by slide scripts may include data model queries. The data model may be maintained by a local or remote database, which may include a database or other data source that operations completely or partially in a cloud computing environment. Data source settings may include those with respect to obtaining presentation data for integration into the data model or that may otherwise be used in the presentation operations described herein. The data source settings may include settings with respect APIs, API endpoints, paths, bucket queries, subfolders, intervals, and data feed push subscriptions (e.g., WebSocket subscriptions), which may be used by the presentation system to acquire presentation data that the presentation system uses to maintain the data model in a structure in which slide scripts are coded to access in a reusable manner. Data handler scripts may assist in the maintenance of the data model by transforming the incoming data into suitable format or otherwise handling the incoming data for integration into the data model. Trigger scripts may also be set to listen to the incoming data, e.g., listen to APIs, bucket queries, WebSockets, to determine when to trigger. Additionally or alternatively, trigger scripts may invoke the particular call, query, or push.

FIG. 4O illustrates an example visual scoreboard history feature of the administration management interface 128 that provides a visual history of a scoreboard's presentation history. The administration module 127 may be configured to provide various user-controlled handling of the history to assist in review and other management operations. For instance, users may review what has been shown on each scoreboard, filter by scoreboard, filter by time range, filter by scoreboard and time, filter by one or more of shown, failed, skipped, script, slide, group, or others. The visual history feature may additionally or alternatively provide information about one or more of date, time, duration, slide, script name, group type, name, or other details about the content presented on a selected scoreboard. A scoreboard selection element 380 is provided to select a scoreboard. A time window element 381 is also provided to define the time window to include in the history. A display history element 382 is provided to cause display of the history of the selected scoreboard. Filter options are provided to filter by script 383, slide name 384, group name 385, group type 386, or online filter 387. A display 388 of slides 106 meeting the filter requirement is provided along with slide details such as data shown, time shown, duration, slide name, slide script name, group type, and group name.

User access to the presentation platform may be controlled by login requirements. For example, users may be provided access to the presentation platform via single sign-on using OneLogin® or other suitable service. Once users are granted access, they may be joined to the presentation platform as a guest with no permissions. For example, user permissions may be set by administration users via a user section of the administration management interface. In a further example, the user section enables administration to provide granular permissions or group permissions per user.

The presentation platform may employ group credentialing with respect to user access to the various operations of the presentation platform. For example, the administration module may be configured to create groups and apply permissions to each group. In operation, an administrator user may access the administration management interface to define groups and set permissions for each group that the administration module to apply. The groups may be module specific, e.g., user permissions specific to users credentialled for access to the event module, messaging module, weather module, or administration module, or as otherwise set.

The presentation platform may be configured for filtered logging. For example, a predefined portion or all actions may be tracked and recorded in data storage. The actions may be incorporated into an audit log. The audit logs may be visible to credentialled users. For example, all or portions of the audit log may be viewable to users based on permissions applicable to the user. The presentation platform may include an audit log viewer for viewing the audit logs. In one example, the audit log viewer includes filtering features operable to filter the log by actor, action, resource type, or the like.

In one example, the presentation platform is configured to monitor operations and generate alerts when appropriate. For example, the presentation platform may employ backend logging that allows external monitoring systems to listen to specific attributes. Using these attributes, for example, scoreboard online/offline status, may be used by external monitoring systems to generate alerts that alert staff of specific situations, such as scoreboard offline. Additionally or alternatively, using the attributes, external monitoring systems can display metrics and other statuses in dashboards and reporting systems. Such dashboards or reporting systems may be part of the presentation platform or separate.

The presentation system 10 may comprise various programed computing hardware including a processor configured to execute a software program, computer readable mediums storing software program instructions, and the like. In some embodiments, the presentation platform 100 may comprise a service provided by hardware executing software program instructions. In one embodiment, the presentation platform 100, scoreboard controller 210 or both may include one or more native applications executed on a computing device such as a server, mainframe, personal computer, laptop, mobile device, tablet, or other suitable computing device. The presentation system 10 may operate within various computing environments such as cloud-based, virtual, remote access, standalone, networked, or combination thereof. In various embodiments, the presentation system 10 may be configured for operation in various network environments. For example, the presentation system 10 may be configured for operation in network-based environments comprising one or more of local, distributed, or hybrid network environment. In these or other embodiments, the presentation system 10 may be configured for operation in a web-based, cloud-based, or other suitable network environment. Networks may include wireless networks, local area networks (LAN), personal networks (PAN), wide area networks (WAN), among others. Example networks may include internet, intranet, virtual local networks, private intranets, or combination thereof. In various embodiments, computer hardware and software may comprise a server. For example, the presentation system 10 may comprise a client-server architecture. In some embodiments, one or more aspects of the presentation platform 100 comprises a server that hosts an application. In one example, the application comprises a network application, such as a web-application, executed, at least in part, on the server. In one example, the application is a web application. The server may include one or more servers. The server may comprise a physical server or virtual server, such as a cloud server, or combination thereof. The server may comprise various server types such as a webserver, database server, file server, application server, proxy server, gateway server, or combination thereof. Servers and applications may reside on a same or separate physical machines. For instance, operations may be provided by a single server providing a webserver and database server. When multiple servers are used, the servers may share or separate processing or other system operation responsibilities.

In one embodiment, one or more components of the presentation system 10, e.g., presentation platform 100, presentation controller 110, scoreboard 210, scoreboard controller 210, or one or more operations thereof, may operate or be configured to operate within a browser or browser-like environment. For example, the component may comprise a web application, which may include a progressive web application, hybrid application, or other suitable application from which presentation operations may be served, executed, simulated, rendered, or otherwise provided for user interaction.

In one embodiment, the presentation system 10 employs a client-server architecture. For example, the presentation platform 100 may comprise a webserver and the scoreboard controller 210 or browser 212 comprises a client. The scoreboard controller 210 or browser 212 may initiate presentation operations by requesting the presentation controller 110 play presentation content for the scoreboard in its URL. The presentation controller 210 may then lookup the associated scoreboard 200 to identify the presentation assigned to the scoreboard 200. The browser 212 may be configured to be ready to take in presentation data for display on browser 212. For example, the browser may include iframe elements ready to take in slide content such as HTML and other slide content. The scoreboard controller 210 may determine what slide is to be presented and slide script paired with the slide is executed to obtain any external resources, e.g., from a data source 30 specified by the slide script. The presentation controller 110 may then update the slide based on the returned resources and updates the slide accordingly before rendering HTML with respect to the slide and transmitting the same to browser 212. This slide data package may include additional slide data such as CSS styling and resource data files required for the browser to render the slide. Upon receipt of the slide data package, browser 212 may update the iframe element's HTML to match the slide data package and renders it. When the browser is ready to receive a next slide data package to hold in its buffer, the browser sends a request to the server to receive the new content. The presentation controller responds by repeating the process performed with respect to the previous slide and sending the requested next slide data package to browser 212. The next slide data package will then be used to update the iframe when the previous slide being shown is determined to be finished, e.g., based on a duration setting.

In various embodiments, the system may be configured for low end-to-end slide transition latency and timely trigger response across a range of network conditions. To support such responsiveness, the presentation controller 110 may, in some implementations, enforce a per-scoreboard 200 single-flight rule for slide updates, evaluate triggers in an isolated processing context, e.g., a worker queue or thread pool, and utilize asynchronous I/O with adaptive retry and backoff for data sources 30. In certain embodiments, protective measures such as temporary suspension thresholds, e.g., circuit breaker, may be applied to misbehaving sources while the scoreboard controller 210 and browser 212 continue rendering using cached or alternate content. These and similar techniques may be used individually or in combination, and specific performance objectives may be selected based on deployment requirements.

The presentation platform 100 may comprise or be configured to provide or cause to be provided a user interface that interfaces users with certain operations of the presentation platform 100. The interface may include visualizations, displays, graphics, buttons, sliders, dropdowns, toggles, or other interactive features for interfacing with the operations of the presentation platform 100. In some embodiments, the presentation platform 100 may comprise a frontend backend architecture as understood by those skilled in the art. For instance, a user device, user interface provided to a user on the user device, or one or more operations thereof may comprise the frontend, e.g., a presentation layer. The backend may comprise a data access layer, data storage, business logic, server, or operations thereof, or the like. In various embodiments, the presentation platform 100 comprises a user authentication feature wherein users, using a user device, are required to securely sign into the operations of the presentation platform 100, e.g., using a username and password.

Various components or operations of the presentation system 10 may be accessed by a user device. The user device may include an electronic communication device, such as a computing device including a processor configured to execute program instructions in a software environment. Example electronic communication devices may include a computer, e.g., a personal computer, laptop, desktop, tablet, smart device, or dedicated device. In one embodiment, a user device comprises a virtual machine. User devices may include a processor configured to perform program instructions that when executed directly or indirectly cause performance of one or more operations of the system. For example, a user device may be configured to perform one or more client-side operations, which may include providing a user interface or operations thereof, receiving user interactions, transmitting data requests, receiving requested and other system data, or the like. In various embodiments, the scoreboard controller 210 comprises a web application configured for execution via the browser 212 to provide ease of access and scalability across multiple users and devices. The user device may include or be configured to access operations of a client-side application for interfacing with the operations of the presentation platform 100, which may be provided by a server-side application, which may include a server-side web application. In various configurations, the client-side application may be executed or simulated, in-whole or in-part, on the user device. In one embodiment, a user device may transmit a request to the web application. The web application may be executed at the server and a web application user interface may be sent to the user device for presentation via a browser. In one embodiment, the presentation platform 100 comprises an application including a web-based application and a user device may access the application via a network, which may include remotely. The user device may interface with a webserver to request and obtain data, which may include interfaces described herein. In one embodiment, a user device may connect to the server using a web browser or client-side software, e.g., via a website hosted by the webserver. In one example, the presentation platform 100 or one or more aspects thereof may be web-based.

The systems, e.g., modules, units, tools, and components thereof, and methods described herein may find use in applications beyond golf. For example, the systems and methods may be used to enable management of other events such as sporting events and concerts. The systems and methods disclosed herein may include still further functionalities and features. For example, the operative functions of the systems and methods may be configured to execute on a special-purpose processor specifically configured to carry out the operations provided by the systems and methods. Notably, the operative features and functionality provided by the systems, e.g., presentation system 10, and methods may increase the efficiency of computing devices that are being utilized to facilitate the functionality provided by the systems and the various methods disclosed herein. For example, a reduced amount of computer operations may need to be performed by the devices and components of the systems using the processors and memories of the systems than compared to traditional methodologies. In such a context, less processing power needs to be utilized because the processors and memories do not need to be dedicated for processing. As a result, there are substantial savings in the usage of computer resources by utilizing the software, techniques, protocols, and algorithms provided in the present disclosure. In certain embodiments, various operative functionality of the systems may be configured to execute on one or more graphics processors and/or application specific integrated processors. In some embodiments, various functions and features of the systems and methods may operate without any human intervention and may be conducted entirely by computing devices. In certain embodiments, for example, numerous computing devices may interact with devices of the systems to provide the functionality supported by the systems. Additionally, in certain embodiments, the computing devices of the systems may operate continuously and without human intervention to reduce the possibility of errors being introduced into the systems.

The present disclosure is intended to be read to encompass one or more systems or components thereof comprising one or more processors and one or more tangible, non-transitory computer-readable media comprising program instructions stored therein, wherein the program instructions are executable by the one or more processors such that the system is configured to perform the operations described herein with respect to any of the various embodiments, examples, configurations, or implementations of the presentation system 10 or components thereof. Such a system may comprise one or more computing devices, apparatuses, machines, or the like. For example, the presentation platform 100 may be employed to improve presentation operations by automating one or more of slide sequencing, content selection, or data integration using, for example, server-side execution of slide scripts and trigger scripts, a version-aware data model, and a defined selection policy for slide and group injection. By generating finalized HTML and CSS and resolved assets at the presentation controller 110, and by caching slide packages with manifests at the scoreboard controller 210 and browser 212, the system may reduce per-device computation and network chatter during live events. Continuous background evaluation of triggers, which may be combined with group-level rules (including interrupt settings 350 and run-to-completion), enables unattended, real-time adjustments without operator intervention. The administration module 127 may be used to further reduce setup effort by allowing endpoints (e.g., APIs, bucket paths, WebSocket subscriptions), handler scripts, and group packaging to be configured once and reused across events. Collectively, these features decrease the number and complexity of manual actions and client-side processing typically required to assemble and update live presentations, resulting in improved responsiveness and more consistent compliance with frequency and exposure requirement.

While the present disclosure may reference particular applications executed on one or more electronic devices, it is to be understood that such applications, including any application services, may be provided within a single application, program, or platform, or may be divided, virtualized, distributed, or combined into or among any number of executable platforms and resources. Applications may refer to program instructions organized in any manner suitable to perform the operations described herein and that need not be limited to discrete units of code or other software package or program.

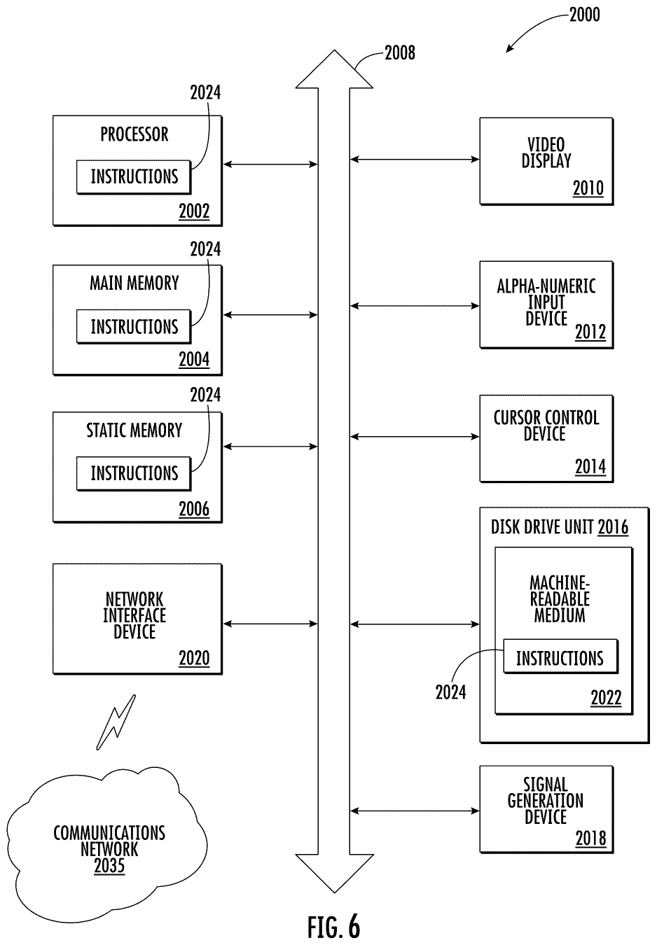

Referring now also to FIG. 6, at least a portion of the methodologies and techniques described with respect to the exemplary embodiments of the system (e.g., presentation system 10) can incorporate a machine, such as, but not limited to, computer system 2000, or other computing device within which a set of program instructions, when executed, may cause the machine to perform any one or more of the methodologies or functions discussed above. The machine may be configured to facilitate various operations conducted by the system. For example, the machine may be configured to, but is not limited to, assist the system by providing processing power to assist with processing loads experienced in the system, by providing storage capacity for storing program instructions or data traversing the system, or by assisting with any other operations conducted by or within the system. As another example, the computer system 2000 may assist with obtaining event data, data transmission, modification of event data, data importation, data storage, data processing, data translation, data mapping, updates to any thereof, or a combination thereof, present in an environment the computer system 2000 operates. As another example, the computer system 2000 may assist with output, distribution, or both of updates or assembling or compiling processed or modified data or other data for delivery or distribution to modules, data sources, other systems, or applications, for viewing, manipulating, formatting, or combination thereof of the same.

In some embodiments, the machine may operate as a standalone device. In some embodiments, the machine may be connected to and assist with operations performed by other machines and systems, such as, but not limited to, any functionality, generator, simulator, database, engine, of other functionality described herein, any of which may be provided by such other machines or systems to the machine for use by system in performance of the operations described herein. The machine may be connected with any component in the system. In a networked deployment, the machine may operate in the capacity of a server or a client user machine in a server-client user network environment, or as a peer machine in a peer-to-peer (or distributed) network environment. The machine may operate in a cloud environment in which resources are distributed. The machine may comprise a server computer, a client user computer, a personal computer (PC), a tablet PC, a laptop computer, a desktop computer, a control system, a network router, switch or bridge, or any machine capable of executing a set of program instructions (sequential or otherwise) that specify actions to be taken by that machine. Further, while a single machine is illustrated, the term “machine” shall also be taken to include any collection of machines that individually or jointly execute a set (or multiple sets) of program instructions to perform any one or more of the methodologies discussed herein.

The computer system 2000 may include a processor 2002, e.g., a central processing unit (CPU), a graphics processing unit (GPU, or both), a main memory 2004 and a static memory 2006, which communicate with each other via a bus 2008. The computer system 2000 may further include a video display unit 2010, which may be, but is not limited to, a liquid crystal display (LCD), a flat panel, a solid-state display, or a cathode ray tube (CRT). The computer system 2000 may include an input device 2012, such as, but not limited to, a keyboard, a cursor control device 2014, such as, but not limited to, a mouse, a disk drive unit 2016, a signal generation device 2018, such as, but not limited to, a speaker or remote control, and a network interface device 2020. The network interface device 2035 may handle data communications for other devices, modules, units, or components of the system or another system or machine.

The disk drive unit 2016 may include a machine-readable medium 2022 on which is stored one or more sets of program instructions 2024, such as, but not limited to, software embodying any one or more of the methodologies or functions described herein, including those methods illustrated above. The program instructions 2024 may also reside, completely or at least partially, within the main memory 2004, the static memory 2006, or within the processor 2002, or a combination thereof, during execution thereof by the computer system 2000. The main memory 2004 and the processor 2002 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine-readable medium 2022 containing program instructions 2024 so that a device connected to the communications network 2035, another network, or a combination thereof, can send or receive voice, video, or data, and communicate over the communications network 2035, another network, or a combination thereof, using the program instructions. The program instructions 2024 may further be transmitted or received over the communications network 2035, another network, or a combination thereof, via the network interface device 2020.

While the machine-readable medium 2022 is shown in an example embodiment to be a single medium, the term “machine-readable medium” should be taken to include a single medium or multiple media (e.g., a centralized or distributed database, and/or associated caches and servers) that store the one or more sets of program instructions. The term “machine-readable medium” shall also be taken to include any medium that is capable of storing, encoding, or carrying a set of program instructions for execution by the machine and that causes the machine to perform any one or more of the methodologies of the present disclosure.

The terms “machine-readable medium,” “machine-readable device,” or “computer-readable device” shall accordingly be taken to include, but not be limited to: memory devices, solid-state memories such as a memory card or other package that houses one or more read-only (non-volatile) memories, random access memories, or other re-writable (volatile) memories; magneto-optical or optical medium such as a disk or tape; or other self-contained information archive or set of archives is considered a distribution medium equivalent to a tangible storage medium. The “machine-readable medium,” “machine-readable device,” or “computer-readable device” may be non-transitory, and, in certain embodiments, may not include a wave or signal per se. Accordingly, the disclosure is considered to include any one or more of a machine-readable medium or a distribution medium, as listed herein and including art-recognized equivalents and successor media, in which the software implementations herein are stored.

Further aspects of the present disclosure are presented in the following number clauses.
Clause 1. A presentation system comprising a presentation platform. The presentation platform may comprise a presentation controller configured to generate presentation instructions for slides of a presentation, and a data storage device configured to store a data model, the data model structured to maintain presentation data obtained from one or more data sources. The system may also comprise a scoreboard controller configured to control presentation operations with respect to one or more displays. The scoreboard controller may include a rendering application configured to receive the presentation instructions from the presentation controller and process the presentation instructions to render the slides for display. The slides may include slide frameworks configured for injection of content.
Clause 2. The system of clause 1, wherein the presentation controller is configured to execute scripts to control the presentation. The scripts may include slide scripts configured to obtain content for injection into the slide frameworks and trigger scripts configured to cause injection of slides into the presentation.
Clause 3. The system of clause 1 or 2, wherein the presentation data includes presentation control data that defines slide groups. The slide groups may include one or more of ordered groups, unordered groups, or trigger groups.
Clause 4. The system of any one of clauses 1-3, wherein the presentation controller is configured to execute a presentation algorithm that analyzes presentation control data to determine slide order within the presentation.
Clause 5. The system of any one of clauses 1-4, wherein the presentation controller is configured to access one or both of event information or scoreboard information in connection with generation of the presentation instructions. The event information may include one or more of event identifier, event name, event date, or event round. The scoreboard information may include one or more of scoreboard identifier, scoreboard location, or scoreboard name.
Clause 6. The system of any one of clauses 1-5, wherein the data model is structured to enable access to the presentation data across multiple events.
Clause 7. The system of any one of clauses 3-6, wherein an ordered group of the slide groups includes slides configured for presentation in a defined sequence. An unordered group of the slide groups may include slides associated with frequency settings specifying a number of times the slides are to be presented within a time period. A trigger group of the slide groups may include slides configured for presentation in a defined sequence upon satisfaction of a trigger condition associated with the trigger group.
Clause 8. The system of any one of clauses 3-7, wherein the presentation control data includes interrupt settings associated with the slide groups. The interrupt settings may specify one or more of: whether slides of an unordered group may interrupt presentation of slides of an ordered group, or whether a trigger group may interrupt an ordered group.
Clause 9. The system of clause 8, wherein the interrupt settings associated with an ordered group specify whether the ordered group may be interrupted by an unordered group or by particular categories of unordered groups.
Clause 10. The system of clause 8 or 9, wherein the interrupt settings associated with a trigger group specify one or more of whether the trigger group may be interrupted by an unordered group, whether the trigger group may be interrupted by another trigger group, or whether the trigger group can interrupt an ordered group.
Clause 11. The system of any one of clauses 8-10, wherein an interruption of a first slide group by a second slide group occurs when the interrupt settings of the first slide group permit interruption by the second slide group and the interrupt settings of the second slide group permit the second slide group to interrupt the first slide group.
Clause 12. The system of any one of clauses 4-11, wherein the presentation algorithm analyzes the presentation control data including one or more of duration settings, frequency settings, or interrupt settings to determine slide order that satisfies requirements specified by the presentation control data.
Clause 13. The system of clause 12, wherein the presentation algorithm injects a slide of an unordered group between slides of an ordered group to satisfy the frequency settings associated with the slide of the unordered group.
Clause 14. The system of clause 12 or 13, wherein the presentation algorithm further analyzes event data obtained from the one or more data sources to determine slide injection timing.
Clause 15. The system of any one of clauses 2-14, wherein the trigger scripts are configured to: monitor the one or more data sources for event data, evaluate the event data with respect to parameters of a trigger condition, and upon the event data satisfying the trigger condition, cause injection of a trigger group into the presentation.
Clause 16. The system of clause 15, wherein the trigger scripts monitor the one or more data sources via one or more of API calls, bucket queries, or data feed subscriptions.
Clause 17. The system of clause 16, wherein the data feed subscriptions include WebSocket subscriptions.
Clause 18. The system of any one of clauses 15-17, wherein the trigger scripts execute continuously during the presentation such that the monitoring of the one or more data sources executes continuously during the presentation.
Clause 19. The system of clause 18, wherein the presentation control data includes interval settings that specify a frequency at which the trigger scripts query the one or more data sources.
Clause 20. The system of any one of clauses 15-19, wherein a trigger group includes a plurality of slides configured for presentation in a defined sequence once the trigger condition associated with the trigger group is satisfied.
Clause 21. The system of clause 20, wherein the presentation control data includes trigger group settings associated with the trigger group, the trigger group settings specifying one or more of whether the trigger group may be interrupted by an unordered group; whether the trigger group continues after presentation of the slides of the trigger group or returns to presentation content displayed prior to satisfaction of the trigger condition; or whether the trigger group may be interrupted by another trigger group.
Clause 22. The system of clause 21, wherein the trigger group settings include a run-to-completion setting. When the run-to-completion setting is enabled, the trigger group is configured to complete presentation of all slides of the trigger group before any other slide group may be presented.
Clause 23. The system of clause 22, wherein when the run-to-completion setting is enabled, the trigger group cannot be interrupted regardless of interrupt settings associated with other slide groups.
Clause 24. The system of clause 22 or 23, wherein the presentation controller is configured to determine that a trigger condition associated with a second trigger group is satisfied during presentation of a first trigger group, evaluate whether the run-to-completion setting of the first trigger group is enabled, and when the run-to-completion setting of the first trigger group is enabled, defer injection of the second trigger group until completion of presentation of all slides of the first trigger group.
Clause 25. The system of any one of clauses 22-24, wherein when the run-to-completion setting of the first trigger group is disabled, the presentation controller is further configured to evaluate the interrupt settings of the first trigger group to determine whether the first trigger group permits interruption by another trigger group, evaluate the interrupt settings of the second trigger group to determine whether the second trigger group permits the second trigger group to interrupt the first trigger group, and permit injection of the second trigger group when both the interrupt settings of the first trigger group and the interrupt settings of the second trigger group permit the interruption.
Clause 26. The system of any one of clauses 15-25, wherein when trigger conditions associated with a plurality of trigger groups are satisfied simultaneously, the presentation controller evaluates the interrupt settings and run-to-completion settings of the plurality of trigger groups to determine an order of injection.
Clause 27. The system of any one of clauses 15-26, wherein when both a trigger condition is satisfied for a trigger group and a frequency requirement is due for a slide of an unordered group, the presentation controller is configured to evaluate the run-to-completion setting of the trigger group and the interrupt settings of both the trigger group and the unordered group to determine whether to inject the trigger group or present the slide of the unordered group.
Clause 28. The system of any one of clauses 15-27, wherein when a trigger group interrupts an ordered group, the presentation controller is configured to reschedule remaining slides of the ordered group for presentation following completion of the trigger group.
Clause 29. The system of any one of clauses 4-28, wherein the presentation algorithm determines a baseline slide order based on the presentation control data, and the trigger scripts cause modification of the baseline slide order by injection of a trigger group upon satisfaction of the trigger condition.
Clause 30. The system of clause 29, wherein the presentation algorithm adjusts the baseline slide order based on presentation metrics received from the scoreboard controller, the presentation metrics including one or more of actual display duration or actual display frequency of slides.
Clause 31. The system of any one of clauses 5-30, wherein the slide scripts are configured to evaluate the event information or the scoreboard information to determine content to inject into the slide frameworks.
Clause 32. The system of clause 31, wherein the presentation controller is configured to assign a same presentation to a plurality of scoreboard controllers, and wherein the slide scripts customize content of the slides based on the scoreboard information associated with each respective scoreboard controller such that respective scoreboard controllers display slides with different content.
Clause 33. The system of any one of clauses 5-32, wherein the slide scripts are configured to evaluate the event information or the scoreboard information to determine whether a slide is to be presented or skipped.
Clause 34. The system of clause 33, wherein the slide scripts cause a slide to be skipped or presented based on one or more of time, day, event, or scoreboard location.
Clause 35. The system of any one of clauses 6-34, wherein the presentation platform is configured to execute scripting operations to update the data model with event data during an event.
Clause 36. The system of clause 35, wherein the data model defines fields for records including one or more of event records, scoreboard records, slide records, group records, or metrics records.
Clause 37. The system of clause 36, wherein the group records include fields specifying one or more of interruptibility settings, run-to-completion settings, exit settings, or replacement settings.
Clause 38. The system of any one of clauses 1-37, wherein the presentation controller is configured to execute slide scripts paired with respective slides to obtain content from the data model or the one or more data sources, generate the presentation instructions including document markup language incorporating the content, and transmit the presentation instructions to the rendering application.
Clause 39. The system of clause 38, wherein the presentation instructions further include presentation styling language and data files for rendering the slides.
Clause 40. The system of any one of clauses 1-39, wherein the scoreboard controller is local or remote with respect to the one or more displays.
Clause 41. The system of any one of clauses 1-40, wherein the scoreboard controller is configured to control presentation operations with respect to a plurality of displays.
Clause 42. The system of any one of clauses 1-41, wherein the slide frameworks include one or more of data fields, media windows, tables, graphics, or images.
Clause 43. The system of any one of clauses 1-42, wherein the slides are configured to be responsive with document markup language and presentation styling language such that a single slide renders on displays of different sizes.
Clause 44. The system of any one of clauses 1-43, wherein the rendering application comprises a browser.
Clause 45. The system of any one of clauses 1-44, wherein the presentation controller and the scoreboard controller operate in a client-server relationship.
Clause 46. The system of any one of clauses 1-45, wherein the presentation platform comprises one or more processors and one or more memories storing program instructions that when executed by the one or more processor cause the presentation platform to perform the operations of the presentation platform.
Clause 47. A method for controlling a presentation on one or more displays, the method comprising: executing, by a presentation controller, slide scripts associated with slides of a presentation, wherein the slide scripts query a data model for content to inject into slide frameworks of the slides, the data model maintaining presentation data obtained from one or more data sources; generating, by the presentation controller, presentation instructions for the slides incorporating content obtained from execution of the slide scripts; transmitting the presentation instructions to a scoreboard controller; and processing, by a rendering application of the scoreboard controller, the presentation instructions to render the slides for display.
Clause 48. The method of clause 47, further comprising executing, by the presentation controller, and trigger scripts that monitor the one or more data sources and cause injection of slides into the presentation upon satisfaction of a trigger condition.
Clause 49. The method of clause 47 or 48, wherein the presentation data includes presentation control data that defines slide groups, and wherein the slide groups include one or more of ordered groups, unordered groups, or trigger groups.
Clause 50. The method of clause 49, wherein an ordered group of the slide groups includes slides configured for presentation in a defined sequence, an unordered group of the slide groups includes slides associated with frequency settings specifying a number of times the slides are to be presented within a time period, and a trigger group of the slide groups includes slides configured for presentation in a defined sequence upon satisfaction of a trigger condition associated with the trigger group.
Clause 51. The method of any one of clauses 49-50, further comprising executing, by the presentation controller, a presentation algorithm that analyzes the presentation control data including one or more of duration settings, frequency settings, or interrupt settings to determine slide order that satisfies requirements specified by the presentation control data.
Clause 52. The method of clause 51, further comprising injecting, by the presentation algorithm, a slide of an unordered group between slides of an ordered group to satisfy the frequency settings associated with the slide of the unordered group.
Clause 53. The method of any one of clauses 48-52, further comprising executing, by the presentation controller, the trigger scripts continuously during the presentation, wherein the trigger scripts monitor the one or more data sources for event data, evaluating, by the trigger scripts, the event data with respect to parameters of a trigger condition, and upon the event data satisfying the trigger condition, causing injection of a trigger group into the presentation.
Clause 54. The method of clause 53, wherein the presentation control data includes trigger group settings associated with the trigger group, the trigger group settings specifying one or more of whether the trigger group may be interrupted by an unordered group; whether the trigger group continues after presentation of the slides of the trigger group or returns to presentation content displayed prior to satisfaction of the trigger condition; or whether the trigger group may be interrupted by another trigger group.
Clause 55. The method of clause 54, wherein the trigger group settings include a setting specifying whether the trigger group must complete presentation of all slides before another slide group may be presented, and when the setting is enabled, the method further comprises completing presentation of all slides of the trigger group before presenting any other slide group.
Clause 56. The method of any one of clauses 53-55, further comprising determining, by the presentation controller, that a trigger condition associated with a second trigger group is satisfied during presentation of a first trigger group, evaluating interrupt settings of the first trigger group and the second trigger group, and permitting injection of the second trigger group when the interrupt settings of both the first trigger group and the second trigger group permit the interruption.
Clause 57. The method of any one of clauses 48-56, further comprising accessing, by the presentation controller, event information or scoreboard information in connection with execution of the scripts, wherein the event information includes one or more of event identifier, event name, event date, or event round, and wherein the scoreboard information includes one or more of scoreboard identifier, scoreboard location, or scoreboard name.
Clause 58. The method of clause 57, further comprising evaluating, by the slide scripts, the event information or the scoreboard information to determine content to inject into the slide frameworks.
Clause 59. The method of clause 58, further comprising assigning a same presentation to a plurality of scoreboard controllers, and customizing, by the slide scripts, content of the slides based on the scoreboard information associated with each respective scoreboard controller such that respective scoreboard controllers display slides with different content.
Clause 60. The method of any one of clauses 57-59, further comprising evaluating, by the slide scripts, the event information or the scoreboard information to determine whether a slide is to be presented or skipped.
Clause 61. The method of any one of clauses 51-60, further comprising determining, by the presentation algorithm, a baseline slide order based on the presentation control data, and modifying, by the trigger scripts, the baseline slide order by injection of a trigger group upon satisfaction of a trigger condition.
Clause 62. A non-transitory computer-readable medium storing program instructions that, when executed by one or more processors, cause the one or more processors to perform the operations of anyone of clauses 47-61.
Clause 63. A method for dynamically controlling a presentation on one or more displays during a live event, the method comprising: executing, by a presentation controller, trigger scripts continuously during the presentation, wherein the trigger scripts monitor one or more data sources for event data; evaluating, by the trigger scripts, the event data with respect to parameters of a trigger condition; and upon the event data satisfying the trigger condition, injecting a trigger group into the presentation, wherein the trigger group includes a plurality of slides configured for presentation in a defined sequence.
Clause 64. The method of clause 63, wherein monitoring the one or more data sources comprises one or more of invoking API calls, executing bucket queries, or listening to data feed subscriptions.
Clause 65. The method of clause 64, wherein the data feed subscriptions include WebSocket subscriptions that push data to the presentation controller when event data changes at the one or more data sources.
Clause 66. The method of clause 63, further comprising determining that a second trigger condition is satisfied during presentation of the trigger group, evaluating interrupt settings associated with the trigger group to determine whether the trigger group permits interruption by a second trigger group; and when the interrupt settings permit, injecting the second trigger group and rescheduling remaining slides of the trigger group for presentation following completion of the second trigger group.
Clause 67. The method of clause 63, wherein the event data includes one or more of player locations, shot tracking data, scoring data, or player group status indicating a player is ready to hit a ball.
Clause 68. A method for automated presentation control, the method comprising: accessing presentation control data that defines slide groups including ordered groups and unordered groups, wherein slides of an unordered group are associated with frequency settings specifying a number of times each slide is to be presented within a time period; executing, by a presentation controller, a presentation algorithm that analyzes the presentation control data to determine a slide order within a presentation; and injecting, by the presentation algorithm, a slide of an unordered group between slides of an ordered group to satisfy the frequency settings associated with the slide of the unordered group.
Clause 69. The method of clause 68, wherein the presentation algorithm further analyzes interrupt settings to determine whether the ordered group permits interruption by the unordered group prior to injecting the slide of the unordered group.
Clause 70. The method of clause 68, further comprising receiving, from a scoreboard controller, presentation metrics including one or more of actual display duration or actual display frequency of slides, and adjusting, by the presentation algorithm, the slide order based on the presentation metrics to satisfy the frequency settings.
Clause 71. The method of clause 68, further comprising analyzing, by the presentation algorithm, event data obtained from one or more data sources to determine slide injection timing based on activity occurring at the live event.
Clause 72. A method for controlling presentations on a plurality of scoreboard controllers, the method comprising: assigning a same presentation to the plurality of scoreboard controllers, wherein each scoreboard controller is associated with scoreboard information including one or more of scoreboard identifier, scoreboard location, or scoreboard name; executing, by a presentation controller, slide scripts associated with slides of the presentation, wherein the slide scripts evaluate the scoreboard information associated with each respective scoreboard controller; and customizing, by the slide scripts, content of the slides based on the scoreboard information such that respective scoreboard controllers display slides with different content.
Clause 73. The method of clause 72, wherein the scoreboard information includes a hole location, and wherein the slide scripts customize the content to include information specific to the hole location.
Clause 74. The method of clause 72, further comprising evaluating, by the slide scripts, the scoreboard information to determine whether a slide is to be presented or skipped for each respective scoreboard controller.
Clause 75. The method of clause 74, wherein the slide scripts cause a slide to be skipped based on one or more of time, day, event, or scoreboard location.
Clause 76. The method of clause 72, further comprising accessing, by the slide scripts, event information including one or more of event identifier, event name, event date, or event round, and customizing, by the slide scripts, the content of the slides based on both the scoreboard information and the event information.
Clause 77. A method for resolving conflicts between slide groups in a presentation, the method comprising: during presentation of a first slide group, wherein the first slide group and a second slide group are associated with interrupt settings defined in presentation control data, determining that the second slide group is a candidate for injection into the presentation; evaluating the interrupt settings of the first slide group to determine whether the first slide group permits interruption by the second slide group; evaluating the interrupt settings of the second slide group to determine whether the second slide group permits the second slide group to interrupt the first slide group; and permitting injection of the second slide group when the interrupt settings of both the first slide group and the second slide group permit the interruption.
Clause 78. The method of clause 77, wherein the first slide group comprises a trigger group, and wherein the interrupt settings of the trigger group include a setting specifying whether the trigger group must complete presentation of all slides before any other slide group may be presented, the method further comprising, when the setting is enabled, completing presentation of all slides of the trigger group before permitting injection of the second slide group regardless of other interrupt settings.
Clause 79. The method of clause 78, further comprising, when the setting specifying whether the trigger group must complete presentation of all slides is disabled, permitting injection of the second slide group during presentation of the trigger group when the interrupt settings of both the trigger group and the second slide group permit the interruption.
Clause 80. The method of clause 77, wherein the second slide group comprises a slide of an unordered group associated with frequency settings, the method further comprising evaluating whether deferral of the slide of the unordered group would cause the frequency settings to be unsatisfied, and when deferral would cause the frequency settings to be unsatisfied, presenting the slide of the unordered group before continuing presentation of the first slide group.
Clause 81. The method of clause 77, further comprising, upon completion of the second slide group, resuming presentation of the first slide group at a slide following the slide that was presenting when the second slide group was injected.
Clause 82. A method for enabling repeatable scripting across multiple events, the method comprising: accessing, by a presentation controller, a data model structured to maintain presentation data in a format accessible by scripts across multiple events; updating the data model with event data obtained from one or more data sources, wherein the updating is performed by scripting operations including one or more of API calls, bucket queries, or data feed subscriptions; executing slide scripts that query the data model to obtain content for injection into slide frameworks; and generating presentation instructions incorporating the content for transmission to a rendering application.
Clause 83. The method of clause 82, wherein the data model defines fields for records including one or more of event records, scoreboard records, slide records, group records, or metrics records.
Clause 84. The method of clause 83, wherein group records include fields specifying one or more of interruptibility settings, settings specifying whether a group must complete presentation of all slides before another group may be presented, exit settings, or replacement settings.
Clause 85. The method of clause 82, further comprising executing data handler scripts to transform data obtained from the one or more data sources into a format for integration into the data model.
Clause 86. The method of clause 85, wherein the data handler scripts write versioned records to the data model, and wherein the slide scripts are configured to be version-aware and map schema differences at read time.
Clause 87. A method for integrating live video into a presentation on one or more displays during a live event, the method comprising: executing, by a presentation controller, trigger scripts that monitor one or more data sources for event data indicating a trigger condition associated with a player or player group; upon the event data indicating the trigger condition is satisfied, querying a data source for availability of live video associated with the trigger condition; when the live video is available, integrating the live video into a slide of the presentation; and transmitting presentation instructions to a rendering application for rendering the slide including the live video for display.
Clause 88. The method of clause 87, wherein the trigger condition comprises one or more of a player group entering a tee box, a player standing over a ball, or a player group approaching a hole location.
Clause 89. The method of clause 87, wherein querying the data source comprises executing a bucket query for video files stored in an object storage environment.
Clause 90. The method of clause 87, wherein when the live video is not available, the method further comprises one of skipping the slide or injecting alternative content into the slide.
Clause 91. The method of clause 87, wherein the slide includes a video frame component, and wherein integrating the live video comprises streaming the live video to the rendering application for presentation within the video frame component.
Clause 92. A method for generating presentation content for display on one or more electronic displays, the method comprising: executing, by a presentation controller, slide scripts paired with respective slides of a presentation, wherein the slide scripts obtain content from one or more data sources for injection into slide frameworks; generating, by the presentation controller, presentation instructions comprising document markup language and presentation styling language incorporating the content obtained from execution of the slide scripts; transmitting the presentation instructions to a rendering application; and processing, by the rendering application, the presentation instructions to render the slides for display without the rendering application executing the slide scripts.
Clause 93. The method of clause 92, wherein the presentation instructions further include data files referenced by the document markup language, and wherein the rendering application injects the data files into the slides during rendering.
Clause 94. The method of clause 92, wherein the presentation controller and the rendering application operate in a client-server relationship, and wherein the presentation controller comprises a webserver addressable by the rendering application via a URL.
Clause 95. The method of clause 92, wherein the rendering application comprises a browser configured to process HTML and CSS.
Clause 96. The method of clause 92, wherein the slides are configured to be responsive such that a single slide renders on displays of different sizes without requiring generation of different slides for different display sizes.
Clause 97. A method for satisfying frequency requirements in a presentation, the method comprising: accessing presentation control data including frequency settings associated with slides of an unordered group, wherein the frequency settings specify a number of times each slide is to be presented within a time period; executing, by a presentation controller, a presentation algorithm that monitors elapsed time and tracks actual presentation frequency of each slide of the unordered group; determining, by the presentation algorithm, that a slide of the unordered group is due for presentation to satisfy the frequency settings; and injecting the slide of the unordered group into the presentation between slides of an ordered group to satisfy the frequency settings.
Clause 98. The method of clause 97, further comprising receiving, from a scoreboard controller, presentation metrics including actual display duration or actual display frequency of slides, and adjusting, by the presentation algorithm, slide injection timing based on the presentation metrics.
Clause 99. The method of clause 97, wherein injecting the slide comprises evaluating interrupt settings associated with the ordered group to determine whether the ordered group permits interruption by the unordered group.
Clause 100. The method of clause 97, wherein the frequency settings specify a number of times per hour or per day the slide is to be presented.
Clause 101. The method of clause 97, wherein the slides of the unordered group include one or more of sponsor logos, advertisements, or sponsored content.
Clause 102. A method for transforming data for use in a presentation system, the method comprising: receiving, from a data source, incoming data via one or more of an API call, a bucket query, or a data feed subscription; executing, by a presentation controller, a data handler script assigned to the data source, wherein the data handler script transforms the incoming data into a format for integration into a data model; integrating the transformed data in the data model; and accessing, by slide scripts or trigger scripts, the transformed data in the data model for use in presentation operations.
Clause 103. The method of clause 102, wherein the data handler script writes versioned records to the data model, and wherein the slide scripts or trigger scripts are configured to be version-aware and map schema differences at read time.
Clause 104. The method of clause 102, wherein the data handler script is assigned to a WebSocket subscription, and wherein the incoming data is pushed to the presentation controller through an open connection.
Clause 105. The method of clause 102, wherein the data handler script is configured to one or more of validate the incoming data, trigger retrieval of additional data from a different data source based on the incoming data, or modify data source settings.
Clause 106. The method of clause 102, wherein the incoming data comprises player location states, and wherein the data handler script transforms the incoming data into normalized records including fields for event identifier, group identifier, hole number, and player state.
Clause 107. A method for reusing a presentation across multiple events, the method comprising: defining a presentation including slides paired with slide scripts, wherein the slide scripts include parameters for evaluating event information or scoreboard information; assigning the presentation to scoreboards associated with a first event; executing, by a presentation controller, the slide scripts to customize content of the slides based on event information associated with the first event; subsequently assigning the presentation to scoreboards associated with a second event; and executing, by the presentation controller, the slide scripts to customize content of the slides based on event information associated with the second event without modifying the presentation or the slide scripts.
Clause 108. The method of clause 107, wherein the event information includes one or more of event identifier, event name, event date, event round, event sponsors, or course venue.
Clause 109. The method of clause 107, wherein the slide scripts query a data model for event data specific to each respective event, and wherein the data model is updated with event data prior to each event.
Clause 110. The method of clause 107, wherein the slide scripts are configured to skip slides based on the event information, such that different slides are presented at the first event and the second event.
Clause 111. The method of clause 107, wherein the slide scripts inject sponsor graphics into the slides based on sponsor designations associated with each respective event.
Clause 112. A system comprising one or more processors and one or more memories storing instructions that when executed by the one or more processors performs a method of any one of clauses 63-111.
Clause 113. A non-transitory computer-readable medium storing program instructions that, when executed by one or more processors, cause the one or more processors to perform the operations of any one of clauses 63-111.

In any of the above systems or methods, the presentation may comprise a scoreboard presentation at a sporting event, such as a golf tournament. In one example, the scoreboard comprises an LED scoreboard wall or other electronic display positioned at a venue location, such as adjacent to a tee box, green, or spectator area at a golf course. In various embodiments, a plurality of scoreboards are positioned at different locations throughout a golf course, with each scoreboard associated with scoreboard information indicating its respective location (e.g., hole number). The event data monitored by the trigger scripts or analyzed by the presentation algorithm may comprise one or more of: player location data indicating locations of players on the golf course, shot tracking data indicating ball flight or ball position, scoring data indicating player scores or standings, player group status indicating that a player group is approaching or has entered a tee box or green area, player group status indicating that a player is standing over a ball or preparing to hit a shot, weather data, messaging alerts, or other event data, such as that described herein. The event data may be automatically detected by sensors positioned on the course, such as object tracking cameras, entered into devices by staff, or otherwise and fed to the system. In one example, a trigger condition is satisfied when event data indicates that a player group has entered a tee box location corresponding to the scoreboard location, causing injection of a trigger group comprising slides displaying information about the players in the player group. As another example, a trigger condition is satisfied when event data indicates that a player is standing over a ball, causing injection of a slide comprising live video of the player. The various trigger conditions applied may be defined as described herein. Slides of an unordered group may comprise sponsor content, advertisements, or promotional graphics configured for presentation at specified frequencies (e.g., a certain number of times per hour) between slides of ordered groups displaying leaderboard information, player statistics, or course information. The systems and methods described herein enable automated, unattended operation of scoreboard presentations that dynamically respond to live event activity without requiring manual intervention by an operator.

The illustrations of arrangements described herein are intended to provide a general understanding of the structure of various embodiments, and they are not intended to serve as a complete description of all the elements and features of apparatus and systems that might make use of the structures described herein. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Thus, although specific arrangements have been illustrated and described herein, it should be appreciated that any arrangement calculated to achieve the same purpose may be substituted for the specific arrangement shown. This disclosure is intended to cover any and all adaptations or variations of various embodiments and arrangements of the invention. Combinations of the above arrangements, and other arrangements not specifically described herein, will be apparent to those of skill in the art upon reviewing the above description. Therefore, it is intended that the disclosure is not limited to the particular arrangement(s) disclosed as the best mode contemplated for carrying out this invention, but that the invention will include all embodiments and arrangements falling within the scope of the appended claims.

The foregoing is provided for purposes of illustrating, explaining, and describing embodiments of this invention. Modifications and adaptations to these embodiments will be apparent to those skilled in the art and may be made without departing from the scope or spirit of this invention. Upon reviewing the aforementioned embodiments, it would be evident to an artisan with ordinary skill in the art that said embodiments can be modified, reduced, or enhanced without departing from the scope and spirit of the claims described below.

What is claimed is:

1. A presentation system comprising:
a presentation platform including a presentation controller and a data storage device, the data storage device configured to store a data model structured to maintain presentation data obtained from one or more data sources, wherein the presentation data includes presentation control data that defines slide groups, and wherein the slide groups include one or more of ordered groups, unordered groups, or trigger groups; and
a scoreboard controller configured to control presentation operations with respect to one or more displays, the scoreboard controller including a rendering application configured to receive presentation instructions from the presentation controller and process the presentation instructions to render slides for display,
wherein the presentation controller is configured to generate the presentation instructions for the slides and to execute a presentation algorithm that analyzes the presentation control data to determine slide order within a presentation.

2. The presentation system of claim 1, wherein an ordered group of the slide groups includes slides configured for presentation in a defined sequence, wherein an unordered group of the slide groups includes slides associated with frequency settings specifying a number of times the slides are to be presented within a time period, and wherein a trigger group of the slide groups includes slides configured for presentation in a defined sequence upon satisfaction of a trigger condition associated with the trigger group.

3. The presentation system of claim 2, wherein the presentation control data includes interrupt settings associated with the slide groups, and wherein the interrupt settings specify one or more of: whether slides of an unordered group may interrupt presentation of slides of an ordered group, or whether a trigger group may interrupt an ordered group.

4. The presentation system of claim 3, wherein the presentation algorithm is configured to analyze the presentation control data including one or more of duration settings, frequency settings, or interrupt settings to determine slide order that satisfies requirements specified by the presentation control data.

5. The presentation system of claim 4, wherein the presentation algorithm injects a slide of an unordered group between slides of an ordered group to satisfy the frequency settings associated with the slide of the unordered group.

6. The presentation system of claim 3, wherein an interruption of a first slide group by a second slide group occurs when the interrupt settings of the first slide group permit interruption by the second slide group and the interrupt settings of the second slide group permit the second slide group to interrupt the first slide group.

7. The presentation system of claim 2, wherein the presentation control data includes trigger group settings associated with a trigger group, the trigger group settings specifying one or more of:
whether the trigger group may be interrupted by an unordered group; whether the trigger group continues after presentation of the slides of the trigger group or returns to presentation content displayed prior to satisfaction of the trigger condition; or whether the trigger group may be interrupted by another trigger group.

8. The presentation system of claim 7, wherein the trigger group settings include a run-to-completion setting, and wherein when the run-to-completion setting is enabled, the trigger group is configured to complete presentation of all slides of the trigger group before any other slide group may be presented.

9. The presentation system of claim 8, wherein when the run-to-completion setting is enabled, the trigger group cannot be interrupted regardless of interrupt settings associated with other slide groups.

10. The presentation system of claim 8, wherein the presentation controller is configured to determine that a trigger condition associated with a second trigger group is satisfied during presentation of a first trigger group, evaluate whether the run-to-completion setting of the first trigger group is enabled, and when the run-to-completion setting of the first trigger group is enabled, defer injection of the second trigger group until completion of presentation of all slides of the first trigger group.

11. The presentation system of claim 3, wherein when both a trigger condition is satisfied for a trigger group and a frequency requirement is due for a slide of an unordered group, the presentation controller is configured to evaluate a run-to-completion setting of the trigger group and the interrupt settings of both the trigger group and the unordered group to determine whether to inject the trigger group or present the slide of the unordered group.

12. The presentation system of claim 3, wherein, when a trigger group interrupts an ordered group, the presentation controller is configured to reschedule remaining slides of the ordered group for presentation following completion of the trigger group.

13. A method for controlling a presentation comprising slides organized into slide groups, the method comprising:
accessing presentation control data that defines slide groups including one or more of ordered groups, unordered groups, or trigger groups;
executing, by a presentation controller, a presentation algorithm that analyzes the presentation control data to determine slide order within the presentation;
generating, by the presentation controller, presentation instructions for slides of the presentation based on the slide order; and
transmitting the presentation instructions to a rendering application for processing and rendering of the slides for display.

14. The method of claim 13, wherein an ordered group of the slide groups includes slides configured for presentation in a defined sequence, wherein an unordered group of the slide groups includes slides associated with frequency settings specifying a number of times the slides are to be presented within a time period, and wherein a trigger group of the slide groups includes slides configured for presentation in a defined sequence upon satisfaction of a trigger condition associated with the trigger group.

15. The method of claim 14, wherein the presentation control data includes interrupt settings associated with the slide groups, and wherein the presentation algorithm analyzes the interrupt settings to determine whether a first slide group may be interrupted by a second slide group.

16. The method of claim 15, further comprising injecting, by the presentation algorithm, a slide of an unordered group between slides of an ordered group to satisfy the frequency settings associated with the slide of the unordered group.

17. The method of claim 15, wherein permitting an interruption of a first slide group by a second slide group comprises:
evaluating the interrupt settings of the first slide group to determine whether the first slide group permits interruption by the second slide group;
evaluating the interrupt settings of the second slide group to determine whether the second slide group permits the second slide group to interrupt the first slide group; and
permitting the interruption when the interrupt settings of both the first slide group and the second slide group permit the interruption.

18. The method of claim 14, wherein the presentation control data includes trigger group settings associated with a trigger group, the trigger group settings including a run-to-completion setting, and wherein when the run-to-completion setting is enabled, the method further comprises completing presentation of all slides of the trigger group before presenting slides of another slide group.

19. The method of claim 15, further comprising, when a trigger group interrupts an ordered group, rescheduling remaining slides of the ordered group for presentation following completion of the trigger group.

20. A non-transitory computer-readable medium storing program instructions that, when executed by one or more processors, cause the one or more processors to:
access presentation control data that defines slide groups including one or more of ordered groups, unordered groups, or trigger groups, wherein an ordered group includes slides configured for presentation in a defined sequence, wherein an unordered group includes slides associated with frequency settings specifying a number of times the slides are to be presented within a time period, and wherein a trigger group includes slides configured for presentation in a defined sequence upon satisfaction of a trigger condition;
execute a presentation algorithm that analyzes the presentation control data including interrupt settings associated with the slide groups to determine slide order within a presentation;
generate presentation instructions for slides of the presentation based on the slide order; and
transmit the presentation instructions to a rendering application for processing and rendering of the slides for display.
